(19) United States
(12) Patent Application Publication
(10) Pub. No.: US 2025/0346473 A1
(43) Pub. Date: Nov. 13, 2025

(54) DETECTION SYSTEM FOR A LIFT DEVICE

(71) Applicant: Oshkosh Corporation, Oshkosh, WI (US)

(72) Inventors: Jesse Sollers, Oshkosh, WI (US); Ronald Moschorak, II, Oshkosh, WI (US); Gregory Shafer, Oshkosh, WI (US)

(73) Assignee: Oshkosh Corporation, Oshkosh, WI (US)

(21) Appl. No.: 19/201,738

(22) Filed: May 7, 2025

Related U.S. Application Data
(60) Provisional application No. 63/644,460, filed on May 8, 2024.
(60) Provisional application No. 63/644,462, filed on May 8, 2024.
(60) Provisional application No. 63/644,455, filed on May 8, 2024.

(51) Int. Cl. B66F 17/00; B66F 11/04

(52) U.S. Cl. CPC B66F 17/006; B66F 11/042

(57) ABSTRACT

One aspect relates to a lift device. The lift device may include a frame assembly, a platform to support an operator, a lift assembly coupling the platform to the frame assembly and to raise or lower the platform. The platform may include a deck coupled to the lift assembly, an extendable deck movable relative to the deck in a longitudinal direction, and a sensor to detect an obstacle below the platform. The lift device may include a controller operatively coupled to the sensor. The controller may limit operation of the lift device to lower the platform in response to the sensor detecting the obstacle within a stop zone, the stop zone extending a predetermined distance beneath the platform, and permit operation of the lift device to lower the platform towards the obstacle in response to the sensor detecting the obstacle beneath the stop zone.

### CROSS-REFERENCE TO RELATED PATENT APPLICATIONS

This application claims the benefit of and priority to U.S. Provisional Application No. 63/644,455, filed May 8, 2024, U.S. Provisional Application No. 63/644,460, filed May 8, 2024, and U.S. Provisional Application No. 63/644,462, filed May 8, 2024, the entire disclosures each of which are incorporated by reference herein.

### BACKGROUND

Certain aerial work platforms, known as scissor lifts, incorporate a frame assembly that supports a platform. The platform is coupled to the frame assembly using a system of linked supports arranged in a crossed pattern, forming a scissor assembly. As the supports rotate relative to one another, the scissor assembly extends or retracts, raising or lowering the platform relative to the frame. Accordingly, the platform moves primarily or entirely vertically relative to the frame assembly. Scissor lifts are commonly used where scaffolding or a ladder might be used, as they provide a relatively large platform from which to work that can be quickly and easily adjusted to a broad range of heights. Scissor lifts are commonly used for painting, construction projects, accessing high shelves, changing lights, and maintaining equipment located above the ground.

### SUMMARY

One embodiment relates to lift device. The lift device may include a frame assembly, a platform to support an operator, a lift assembly coupling the platform to the frame assembly and to raise or lower the platform. The platform may include a deck coupled to the lift assembly, an extendable deck movable relative to the deck in a longitudinal direction, and a sensor to detect an obstacle below the platform. The lift device may include a controller operatively coupled to the sensor. The controller may limit operation of the lift device to lower the platform in response to the sensor detecting the obstacle within a stop zone, the stop zone extending a predetermined distance beneath the platform, and permit operation of the lift device to lower the platform towards the obstacle in response to the sensor detecting the obstacle beneath the stop zone.

Another embodiment relates to a scissor lift. The scissor lift may include a frame assembly, a platform to support an operator, and a lift assembly coupling the platform to the frame assembly and to raise or lower the platform. The platform may include a deck coupled to the lift assembly, an extendable deck movable relative to the deck in a longitudinal direction, and a sensor to detect an obstacle below the platform. The scissor lift may include controller operatively coupled to the sensor. The controller may limit operation of the scissor lift in response to the sensor detecting the obstacle within a stop zone, the stop zone extending a predetermined distance beneath the platform, and permit operation of the scissor lift to lower the platform towards the obstacle in response to the sensor detecting the obstacle beneath the stop zone.

Another aspect relates to a control system for a lift device. The control system may include a sensor to detect an obstacle below a platform of the lift device, and a controller operatively coupled to the sensor. The controller may limit operation of the lift device to lower the platform in response to the sensor detecting the obstacle within a stop zone, the stop zone extending a predetermined distance beneath the platform, and permit operation of the lift device to lower the platform in response to the sensor detecting the obstacle beneath the stop zone.

This summary is illustrative only and is not intended to be in any way limiting. Other aspects, inventive features, and advantages of the devices or processes described herein will become apparent in the detailed description set forth herein, taken in conjunction with the accompanying figures, wherein like reference numerals refer to like elements.

### BRIEF DESCRIPTION OF THE DRAWINGS

The disclosure will become more fully understood from the following detailed description, taken in conjunction with the accompanying figures, wherein like reference numerals refer to like elements, in which:

FIG. 1 is a perspective view of a lift device, according to an exemplary embodiment;

FIG. 2 is a perspective view of the lift device of FIG. 1, including various proximity sensors, according to an exemplary embodiment;

FIG. 3 is a side view of the lift device of FIG. 1, showing scan areas of one or more of the proximity sensors of FIG. 2, according to an exemplary embodiment;

FIG. 4 is a front view of the lift device of FIG. 1, showing scan areas of one or more of the proximity sensors of FIG. 2, according to an exemplary embodiment;

FIG. 5 is a perspective view of a platform of the lift device of FIG. 1, including various proximity sensors, according to an exemplary embodiment;

FIG. 6 is a side view of the platform of the lift device of FIG. 5, including various proximity sensors, according to an exemplary embodiment;

FIG. 7 is a front view of the lift device of FIG. 1, according to an exemplary embodiment;

FIG. 8 is a side view of the platform of the lift device of FIG. 5, showing an extendable deck in an extended position, according to an exemplary embodiment;

FIG. 9 is a perspective view of a platform of the lift device of FIG. 1, according to another exemplary embodiment;

FIG. 10 is a perspective view of a platform of the lift device of FIG. 1, according to another exemplary embodiment;

FIGS. 11-12 are perspective views of one of the proximity sensors of the lift device of FIG. 2, according to an exemplary embodiment;

FIG. 13 is a side view of ultrasonic waves emitted by the proximity sensor of FIGS. 11-12, according to an exemplary embodiment;

FIG. 14 is a front view of the ultrasonic waves emitted by the proximity sensor of FIGS. 11-12, according to an exemplary embodiment;

FIG. 15 is a block diagram of a controller of the lift device of FIG. 1, according to an exemplary embodiment;

FIG. 16 is a block diagram of a process performed by the controller of FIG. 15 to detect objects and provide an alert to a user, according to an exemplary embodiment;

FIG. 17 is a front view of a scissors lift with a lidar obstacle detection system for facilitating service or maintenance of an aircraft, according to an exemplary embodiment;

FIG. 18 is a side view of the scissors lift and the lidar obstacle detection system of FIG. 17, according to an exemplary embodiment;

FIG. 19 is a top view of a platform of the scissors lift of FIG. 17, illustrating the positioning of different lidar sensors, according to an exemplary embodiment;

FIG. 20 is a side view of the scissors lift of FIG. 17 illustrating different detection or warning zones of the lidar obstacle detection system, according to an exemplary embodiment;

FIG. 21 is a perspective view of the scissors lift of FIG. 17 illustrating different detection zones of the lidar obstacle detection system on multiple sides of the scissors lift, according to an exemplary embodiment;

FIG. 22 is another perspective view of the scissors lift of FIG. 17 illustrating different detection zones of the lidar obstacle detection system on multiple sides of the scissors lift, according to an exemplary embodiment;

FIG. 23 is another perspective view of the scissors lift of FIG. 17 illustrating different detection zones of the lidar obstacle detection system on multiple sides of the scissors lift, according to an exemplary embodiment;

FIG. 24 is a perspective view of a boom lift equipped with a lidar obstacle detection system, according to an exemplary embodiment;

FIG. 25 is a side view of the boom lift of FIG. 24 including the lidar obstacle detection system, according to an exemplary embodiment;

FIG. 26 is a perspective view of a lift device, according to another exemplary embodiment;

FIG. 27 is a perspective view of the lift device of FIG. 26, according to an exemplary embodiment;

FIG. 28 is a side view of the lift device of FIG. 26, according to an exemplary embodiment;

FIG. 29 is a rear view of the lift device of FIG. 26, according to an exemplary embodiment;

FIG. 30 is a rear view of the lift device of FIG. 26, according to an exemplary embodiment;

FIG. 31 is a front view of the lift device of FIG. 26, according to an exemplary embodiment;

FIG. 32 is a front view of the lift device of FIG. 26, according to an exemplary embodiment;

FIG. 33 is a perspective view of a senor of the lift device of FIG. 26, according to an exemplary embodiment;

FIG. 34 is a perspective view of a user interface of the lift device of FIG. 26, according to an exemplary embodiment;

FIG. 35 is a perspective view of an air access of the lift device of FIG. 26, according to an exemplary embodiment;

FIG. 36 is a perspective view of a user interface of the lift device of FIG. 26, according to an exemplary embodiment;

FIG. 37 is a perspective view of the lift device of FIG. 26, according to an exemplary embodiment;

FIG. 38 is a perspective view of the lift device of FIG. 26, according to an exemplary embodiment;

FIG. 39 is a perspective view of the lift device of FIG. 26, according to an exemplary embodiment;

FIG. 40 is a side view of the lift device of FIG. 26 including an obstacle detection system, according to an exemplary embodiment;

FIG. 41 is a perspective view of the lift device of FIG. 26 including the obstacle detection system, according to an exemplary embodiment;

FIG. 42 is a perspective view of the lift device of FIG. 26 including the obstacle detection system, according to an exemplary embodiment;

FIG. 43 is a perspective view of the lift device of FIG. 26 including the obstacle detection system, according to an exemplary embodiment;

FIG. 44 is a perspective view of the lift device of FIG. 26 including the obstacle detection system, according to an exemplary embodiment;

FIG. 45 is a perspective view of the lift device of FIG. 26 including the obstacle detection system, according to an exemplary embodiment;

FIG. 46 is a perspective view of the lift device of FIG. 26 including the obstacle detection system, according to an exemplary embodiment;

FIG. 47 is a perspective view of the lift device of FIG. 26 including the obstacle detection system, according to an exemplary embodiment;

FIG. 48 is a perspective view of the lift device of FIG. 26 including the obstacle detection system, according to an exemplary embodiment;

FIG. 49 is a perspective view of the lift device of FIG. 26 including the obstacle detection system, according to an exemplary embodiment;

FIG. 50 is a perspective view of the lift device of FIG. 26 including the obstacle detection system, according to an exemplary embodiment; and

FIG. 51 is a perspective view of the lift device of FIG. 26 including the obstacle detection system, according to an exemplary embodiment.

### DETAILED DESCRIPTION

Before turning to the FIGURES, which illustrate the exemplary embodiments in detail, it should be understood that the present application is not limited to the details or methodology set forth in the description or illustrated in the FIGURES. It should also be understood that the terminology is for the purpose of description only and should not be regarded as limiting.

### Overview

Referring generally to the FIGURES, a lift device is shown, according to various exemplary embodiment. The lift device includes a frame assembly, a lifting assembly, and a platform. The platform includes various proximity sensors disposed about the platform and configured to detect obstacles, objects, obstructions, etc., in areas around the platform (e.g., above the platform, to the sides of the platform, in front of the platform, behind the platform, below the platform, etc.). The proximity sensors may be any sensors configured to measure a relative distance to an object or a proximity sensor configured to determine a relative location of the object. The proximity sensors provide object detection data to a controller. The controller uses the object detection data to determine if an alarm/alert should be provided to the operator of the lift device. The alert may be any of a visual alert and an aural alert. The controller can be configured to differentiate between objects in a warning zone and a stop zone. If objects are detected in the stop zone, or near the stop zone, the controller can restrict one or more operations of the lift device (e.g., extension of the platform). The controller can adjust the areas of the warning zones and/or the stop zones based on a distance between the platform and a ground surface. Advantageously, the controller prevents objects or obstacles from coming too close to the lift device, the platform, and the lift assembly.

### Lift Device

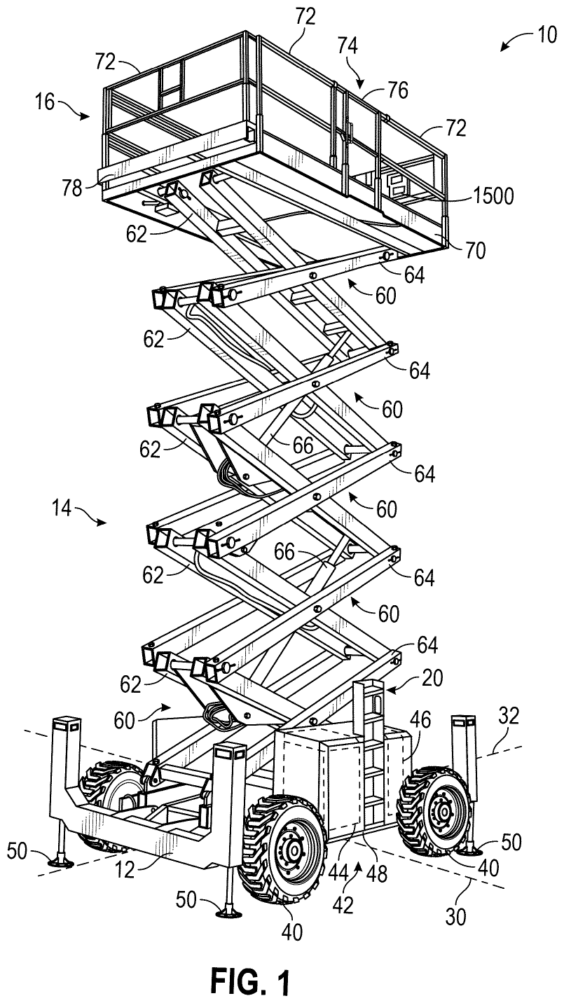

According to the exemplary embodiment shown in FIG. 1, a lift device (e.g., a scissor lift, an aerial work platform, a boom lift, a telehandler, ground service equipment including cargo loaders, food and beverage vehicles, deicers, etc.), shown as lift device 10, includes a chassis, shown as frame assembly 12. A lift device (e.g., a scissor assembly, a boom assembly, etc.), shown as lift assembly 14, couples the frame assembly 12 to a platform, shown as platform 16. The frame assembly 12 supports the lift assembly 14 and the platform 16, both of which are disposed directly above the frame assembly 12. In use, the lift assembly 14 extends and retracts to raise and lower the platform 16 relative to the frame assembly 12 between a lowered position and a raised position. The lift device 10 includes an access assembly, shown as an access assembly 20, that is coupled to the frame assembly 12 and configured to facilitate access to the platform 16 from the ground by an operator when the platform 16 is in the lowered position.

Referring again to FIG. 1, the frame assembly 12 defines a horizontal plane having a lateral axis 30 and a longitudinal axis 32. In some embodiments, the frame assembly 12 is rectangular, defining lateral sides extending parallel to the lateral axis 30 and longitudinal sides extending parallel to the longitudinal axis 32. In some embodiments, the frame assembly 12 is longer in a longitudinal direction than in a lateral direction. In some embodiments, the lift device 10 is configured to be stationary or semi-permanent (e.g., a system that is installed in one location at a work site for the duration of a construction project). In such embodiments, the frame assembly 12 may be configured to rest directly on the ground and/or the lift device 10 may not provide powered movement across the ground. In other embodiments, the lift device 10 is configured to be moved frequently (e.g., to work on different tasks, to continue the same task in multiple locations, to travel across a job site, etc.). Such embodiments may include systems that provide powered movement across the ground.

Referring to FIG. 1, the lift device 10 is supported by a plurality of tractive assemblies 40, each including a tractive element (e.g., a tire, a track, etc.), that are rotatably coupled to the frame assembly 12. The tractive assemblies 40 may be powered or unpowered. As shown in FIG. 1, the tractive assemblies 40 are configured to provide powered motion in the direction of the longitudinal axis 32. One or more of the tractive assemblies 40 may be turnable to steer the lift device 10. In some embodiments, the lift device 10 includes a powertrain system 42. In some embodiments, the powertrain system 42 includes a primary driver 44 (e.g., an engine). A transmission may receive the mechanical energy and provide an output to one or more of the tractive assemblies 40. In some embodiments, the powertrain system 42 includes a pump 46 configured to receive mechanical energy from the primary driver 44 and output a pressurized flow of hydraulic fluid. The pump 46 may supply mechanical energy (e.g., through a pressurized flow of hydraulic fluid) to individual motive drivers (e.g., hydraulic motors) configured to facilitate independently driving each of the tractive assemblies 40. In other embodiments, the powertrain system 42 includes an energy storage device (e.g., a battery, capacitors, ultra-capacitors, etc.) and/or is electrically coupled to an outside source of electrical energy (e.g., a standard power outlet). In some such embodiments, one or more of the tractive assemblies 40 include an individual motive driver (e.g., a motor that is electrically coupled to the energy storage device, etc.) configured to facilitate independently driving each of the tractive assemblies 40. The outside source of electrical energy may charge the energy storage device or power the motive drivers directly. The powertrain system 42 may additionally or alternatively provide mechanical energy (e.g., using the pump 46, by supplying electrical energy, etc.) to one or more actuators of the lift device 10 (e.g., the leveling actuators 50, the lift actuators 66, the stair actuator 230, etc.). One or more components of the powertrain system 42 may be housed in an enclosure, shown as housing 48. The housing 48 is coupled to the frame assembly 12 and extends from a side of the lift device 10 (e.g., a left or right side). The housing 48 may include one or more doors to facilitate access to components of the powertrain system 42.

In some embodiments, the frame assembly 12 is coupled to one or more actuators, shown in FIG. 1 as leveling actuators 50. The lift device 10 includes four leveling actuators 50, one in each corner of the frame assembly 12. The leveling actuators 50 extend and retract vertically between a stored position and a deployed position. In the stored position, the leveling actuators 50 are raised and do not contact the ground. In the deployed position, the leveling actuators 50 contact the ground, lifting the frame assembly 12. The length of each of the leveling actuators 50 in their respective deployed positions may be varied to adjust the pitch (i.e., rotational position about the lateral axis 30) and the roll (i.e., rotational position about the longitudinal axis 32) of the frame assembly 12. Accordingly, the lengths of the leveling actuators 50 in their respective deployed positions may be adjusted such that the frame assembly 12 is leveled with respect to the direction of gravity, even on uneven or sloped terrains. The leveling actuators 50 may additionally lift the tractive elements of the tractive assemblies 40 off the ground, preventing inadvertent driving of the lift device 10.

Referring to FIG. 1, the lift assembly 14 includes a number of subassemblies, shown as scissor layers 60, each including a first member, shown as inner member 62, and a second member, shown as outer member 64. In each scissor layer 60, the outer member 64 receives the inner member 62. The inner member 62 is pivotally coupled to the outer member 64 near the centers of both the inner member 62 and the outer member 64. Accordingly, inner member 62 pivots relative to the outer member 64 about a lateral axis. The scissor layers 60 are stacked atop one another to form the lift assembly 14. Each inner member 62 and each outer member 64 has a top end and a bottom end. The bottom end of each inner member 62 is pivotally coupled to the top end of the outer member 64 immediately below it, and the bottom end of each outer member 64 is pivotally coupled to the top end of the inner member 62 immediately below it. Accordingly, each of the scissor layers 60 are coupled to one another such that movement of one scissor layer 60 causes a similar movement in all of the other scissor layers 60. The bottom ends of the inner member 62 and the outer member 64 belonging to the lowermost of the scissor layers 60 are coupled to the frame assembly 12. The top ends of the inner member 62 and the outer member 64 belonging to the uppermost of the scissor layers 60 are coupled to the platform 16. The inner members 62 and/or the outer members 64 are slidably coupled to the frame assembly 12 and the platform 16 to facilitate the movement of the lift assembly 14. Scissor layers 60 may be added to or removed from the lift assembly 14 to increase or decrease, respectively, the maximum height that the platform 16 is configured to reach.

One or more actuators (e.g., hydraulic cylinders, pneumatic cylinders, motor-driven leadscrews, etc.), shown as lift actuators 66, are configured to extend and retract the lift assembly 14. As shown in FIG. 1, the lift assembly 14 includes a pair of lift actuators 66. Lift actuators 66 are pivotally coupled to an inner member 62 at one end and pivotally coupled to another inner member 62 at the opposite end. These inner members 62 belong to a first scissor layer 60 and a second scissor layer 60 that are separated by a third scissor layer 60. In other embodiments, the lift assembly 14 includes more or fewer lift actuators 66 and/or the lift actuators 66 are otherwise arranged. The lift actuators 66 are configured to actuate the lift assembly 14 to selectively reposition the platform 16 between the lowered position, where the platform 16 is proximate the frame assembly 12, and the raised position, where the platform 16 is at an elevated height. In some embodiments, extension of the lift actuators 66 moves the platform 16 vertically upward (extending the lift assembly 14), and retraction of the linear actuators moves the platform 16 vertically downward (retracting the lift assembly 14). In other embodiments, extension of the lift actuators 66 retracts the lift assembly 14, and retraction of the lift actuators 66 extends the lift assembly 14. In some embodiments, the outer members 64 are approximately parallel and/or contacting one another when with the lift assembly 14 in a stored position. The lift device 10 may include various components to drive the lift actuators 66 (e.g., pumps, valves, compressors, motors, batteries, voltage regulators, etc.).

Referring again to FIG. 1, the platform 16 includes a support surface, shown as deck 70, defining a top surface configured to support operators and/or equipment and a bottom surface opposite the top surface. The bottom surface and/or the top surface extend in a substantially horizontal plane. A thickness of the deck 70 is defined between the top surface and the bottom surface. The bottom surface is coupled to a top end of the lift assembly 14. In some embodiments, the deck 70 is rectangular. In some embodiments, the deck 70 has a footprint that is substantially similar to that of the frame assembly 12.

Referring again to FIG. 1, a number of guards or railings, shown as guard rails 72, extend upwards from the deck 70. The guard rails 72 extend around an outer perimeter of the deck 70, partially or fully enclosing a supported area on the top surface of the deck 70 that is configured to support operators and/or equipment. The guard rails 72 provide a stable support for the operators to hold and facilitate containing the operators and equipment within the supported area. The guard rails 72 define one or more openings 74 through which the operators can access the deck 70. The opening 74 may be a space between two guard rails 72 along the perimeter of the deck 70, such that the guard rails 72 do not extend over the opening 74. Alternatively, the opening 74 may be defined in a guard rail 72 such that the guard rail 72 extends across the top of the opening 74. In some embodiments, the platform 16 includes a door 76 that selectively extends across the opening 74 to prevent movement through the opening 74. The door 76 may rotate (e.g., about a vertical axis, about a horizontal axis, etc.) or translate between a closed position, shown in FIG. 1, and an open position. In the closed position, the door 76 prevents movement through the opening 74. In the open position, the door 76 facilitates movement through the opening 74.

Referring again to the embodiments of FIG. 1, the platform 16 further includes one or more platforms, shown as extendable decks 78, that are received by the deck 70 and that each define a top surface. The extendable decks 78 are selectively slidable relative to the deck 70 between an extended position and a retracted position. In the retracted position, shown in FIG. 1, the extendable decks 78 are completely or almost completely received by the deck 70. In the extended position, the extendable decks 78 project outward (e.g., longitudinally, laterally, etc.) relative to the deck 70 such that their top surfaces are exposed. With the extendable decks 78 projected, the top surfaces of the extendable decks 78 and the top surface of the deck 70 are all configured to support operators and/or equipment, expanding the supported area. In some embodiments, the extendable decks 78 include guard rails partially or fully enclose the supported area. The extendable decks 78 facilitate accessing areas that are spaced outward from the frame assembly 12.

Referring to FIG. 1, the access assembly 20 is coupled to a longitudinal side of the frame assembly 12. As shown in FIG. 1, the access assembly 20 is a ladder assembly extending along a longitudinal side of the frame assembly 12. The access assembly 20 is aligned with the door 76 such that, when the platform 16 is in the lowered position, the access assembly 20 facilitates access to the upper surface of the platform 16 through the opening 74.

### Object/Obstacle Detection System

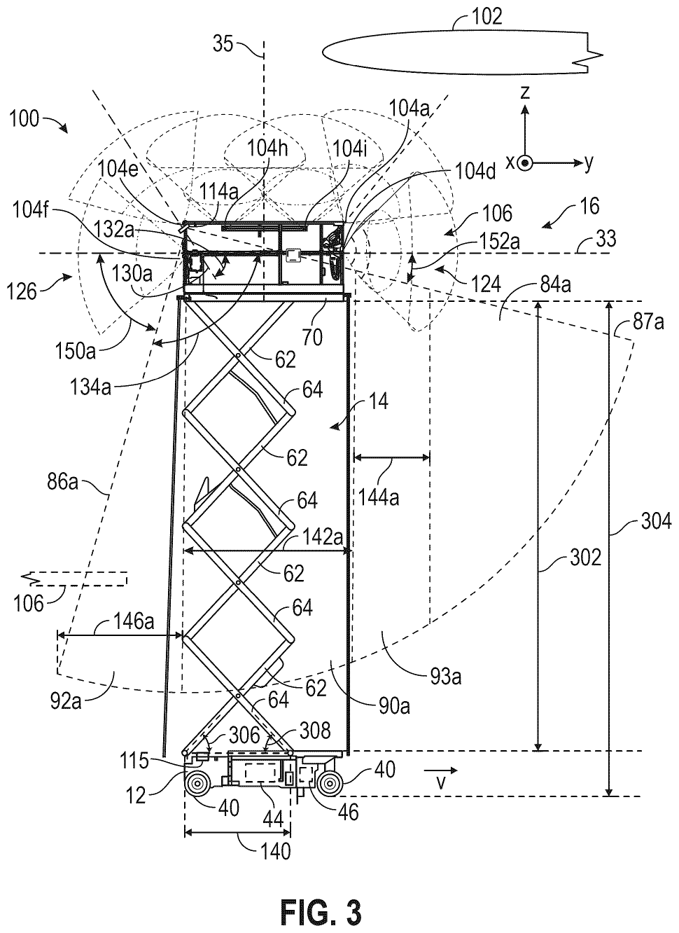

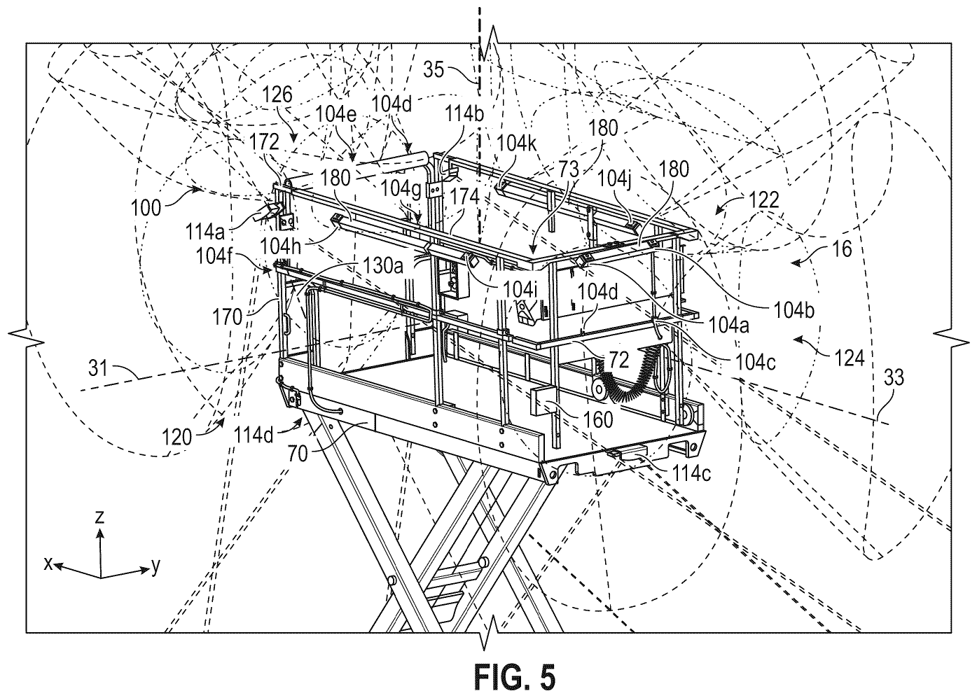

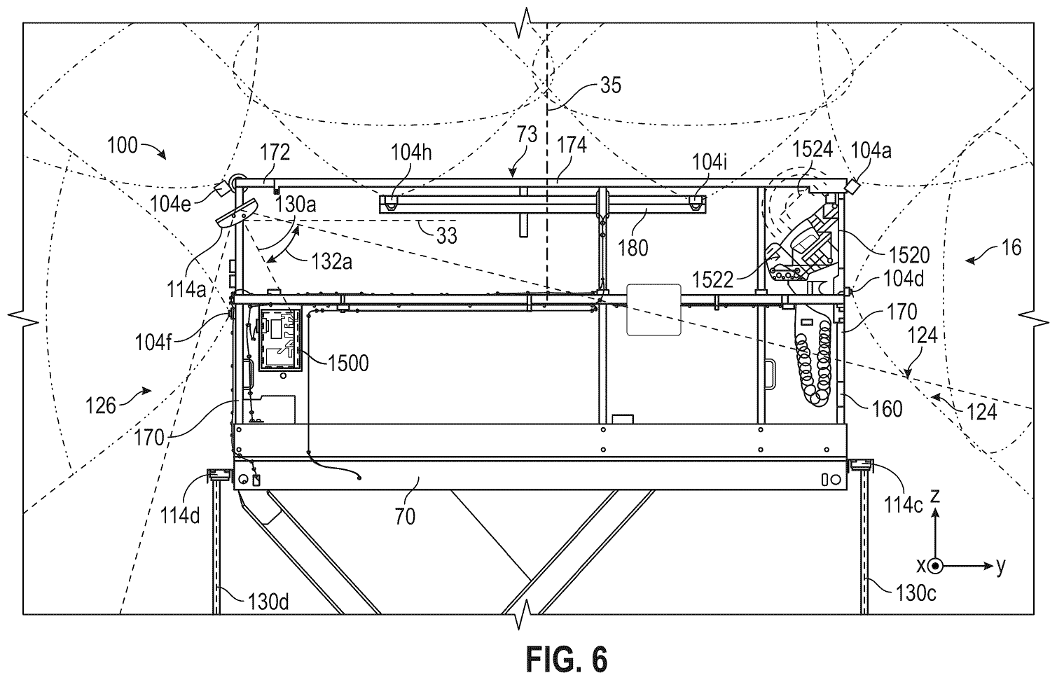

Referring now to FIGS. 5-6, the platform 16 further includes a detection system, an obstacle detection system, etc., shown as object detection system 100, according to an exemplary embodiment. The platform 16 defines a longitudinal axis 33, a lateral axis 31 that is perpendicular to the longitudinal axis 33, and a vertical axis 35 that is perpendicular to both the longitudinal axis 33 and the lateral axis 31. An x-y-z coordinate system is also defined, with the x-direction extending along the lateral axis 31, the y-direction extending along the longitudinal axis 33, and the z-direction extending along the vertical axis 35. The positive z direction indicates an upwards direction of the lift device 10. The negative z direction indicates a downwards direction of the lift device 10. The positive y direction indicates a frontwards direction of the lift device 10. The negative y direction indicates a backwards direction of the lift device 10. The positive x direction indicates a right direction of the lift device 10. The negative x direction indicates a left direction of the lift device 10. The object detection system 100 includes a first set of proximity sensors, shown as ultrasonic sensors 104, and a second set of proximity sensors, shown as lidar sensors 114, according to an exemplary embodiment. The object detection system 100 also includes a controller 1500. The controller 1500 is configured to receive object detection information from any of the ultrasonic sensors 104 and the lidar sensors 114. The controller 1500 is also configured to receive sensor information from a lift assembly sensor 115 (see FIG. 3). The controller 1500 may be positioned in any of the locations shown in FIG. 6, anywhere else on the platform 16, or may be positioned at the frame assembly 12. The ultrasonic sensors 104 may be any sensor configured to emit an ultrasonic wave and receive a reflected ultrasonic wave to determine a relative distance between the ultrasonic sensors 104 and an object (e.g., object 102 such as the wing of an aircraft as shown in FIG. 3). One or more of the ultrasonic sensors 104 may be pointed at least partially in an upwards direction (e.g., at least partially in the positive z direction or at least partially along vertical axis 35) to detect objects, obstacles, obstructions, overhangings, etc., above platform 16 (e.g., objects above platform 16 in the z direction). The ultrasonic sensors 104 may be positioned about an outer perimeter of platform 16. One or more of the ultrasonic sensors 104 may point at least partially outwards from platform 16 in the x-y plane (e.g., one or more of the ultrasonic sensors 104 may point at least partially along longitudinal axis 33 and/or at least partially along lateral axis 31) to detect objects, obstacles, obstructions, etc., in the surroundings of the platform 16. In an exemplary embodiment, the ultrasonic sensors 104 are configured to determine a relative distance (e.g., a scalar quantity) between platform 16 and an object (e.g., the object 102).

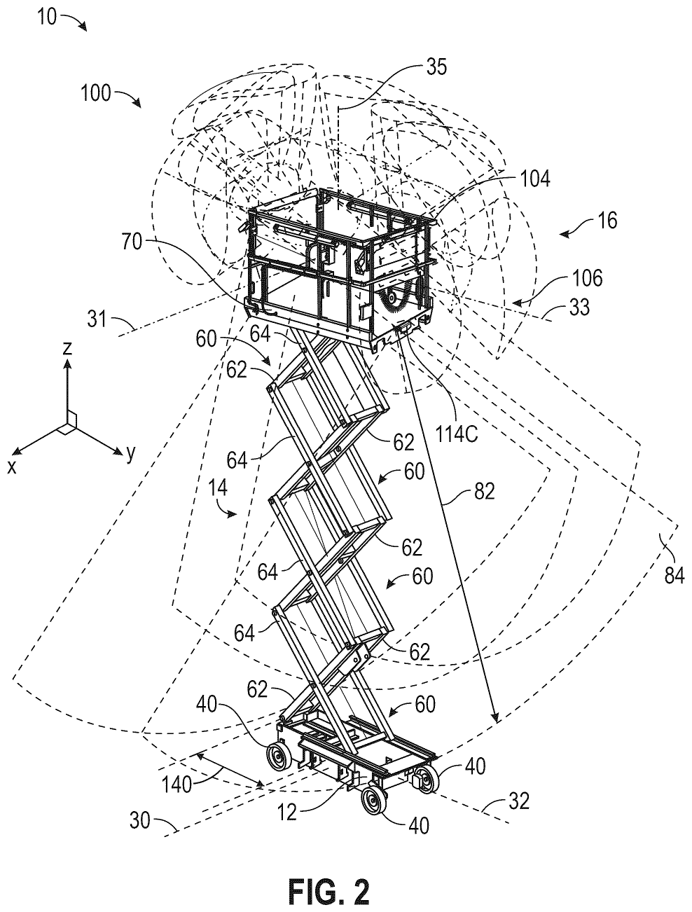

The lidar sensors 114 may be any proximity sensor configured to emit light (e.g., a laser) and determine proximity as well as relative location of an object (e.g., object 106) within a scan area 84 (see FIGS. 2-4) of the lidar sensors 114. One or more of the lidar sensors 114 is/are configured to point at least partially in a downwards direction (e.g., at least partially in a negative z-direction, at least partially along vertical axis 35 in a direction below the platform 16, etc.) to detect objects within the scan area 84 that are below/beneath the platform 16. The lidar sensors 114 emit multiple lasers (e.g., eleven) to detect the presence of objects in the scan area 84. The multiple lasers may be spaced apart over the entire sweep of angle 134 at equiangular positions (e.g., the angular displacement between adjacent lasers is equal) to detect the presence of objects over the scan area 84. The lidar sensors 114 may be configured to monitor an amount of time between when the laser is emitted and when the lidar sensor 114 measures a return of the light to the lidar sensor 114. The time between when the laser/light is emitted and when the lidar sensor 114 measures the return of the light may be referred to as the time of flight, Δt_{flight}. The lidar sensors 114 determine a relative location of the object that reflects the light. The distance of the relative location between the object (e.g., the object 106) and the lidar sensor 114 may be determined as:

$$d = \frac{c Δ {t}_{flight}}{2}$$

where c is the speed of light. The angle θ of the object and the lidar sensor 114 may be the angle at which the laser is emitted. From the relative distance d and the angle θ at which the laser/light is emitted, the relative location of the object can be determined. If the lidar sensor 114 does not measure a return of light, this indicates that there is no object present at the current angular position of the lidar sensor 114. The lidar sensors 114 may emit lasers having a wavelength between 600 and 1000 nanometers. In other embodiments, the lidar sensors 114 emit lasers having a wavelength greater than 1000 nanometers (e.g., 1550 nanometers) or shorter than 600 nanometers (e.g., 532 nanometers). The scan area 84 of each of the lidar sensors 114 may be a two dimensional plane such that each of the lidar sensors 114 determines one or more relative locations (e.g., polar coordinates, Cartesian coordinates, etc.) of various points on the object relative to the respective lidar sensor 114.

The ultrasonic sensors 104 are generally oriented outwards and/or upwards, while the lidar sensors 114 are generally oriented downwards. Orienting the lidar sensors 114 downwards facilitates an object detection system 100 that is less prone to obstructions and direct sunlight which could potentially cause inaccurate measurements from the lidar sensors 114. Additionally, the lidar sensors 114 are positioned (and the ultrasonic sensors 104 are oriented) such that the lidar sensors 114 do not interfere with the ultrasonic sensors 104. While the present disclosure refers to lidar sensors and ultrasonic sensors, it is contemplated that other types of sensors could be used. For example, in some embodiments, all of the sensors 104 and 114 are lidar sensors. Any proximity sensor configured to measure the relative location of an object may be used in place of the lidar sensors 114. Likewise, any proximity sensor configured to measure relative distance of an object may be used in place of the ultrasonic sensors 104.

Referring still to FIGS. 5-6, the object detection system 100 includes lidar sensors 114a-114d, according to an exemplary embodiment. The platform 16 may include one or more of the lidar sensors 114 on each side of the platform 16. In an exemplary embodiment, the platform 16 includes four lidar sensors 114, shown as lidar sensor 114a positioned on a first lateral side 120 of the platform 16, lidar sensor 114b positioned on a first lateral side 122 of the platform 16, lidar sensor 114c positioned on a first longitudinal end 124 of the platform 16, and lidar sensor 114d positioned on a second longitudinal end 126 of the platform 16. In other embodiments, the platform 16 includes only two lidar sensors 114 (e.g., only two of the lidar sensors 114a-114d). For example, the platform 16 may include only the lidar sensor 114a positioned on the first lateral side 120 of the platform and the lidar sensor 114b positioned on the first lateral side 122 of the platform 16. In other embodiments, the platform 16 includes more than four of the lidar sensors 114. For example, the platform 16 may include multiple lidar sensors 114 positioned on the first lateral side 120 and/or multiple lidar sensors 114 positioned on the first lateral side 122 of the platform 16.

In an exemplary embodiment, lidar sensor 114b is positioned and/or oriented symmetrically/similarly to lidar sensor 114a. Likewise, lidar sensor 114d may be positioned and/or oriented symmetrically/similarly to lidar sensor 114c.

Each of lidar sensors 114 include a central axis 130, according to an exemplary embodiment. Central axis 130 extends radially outwards from a corresponding lidar sensor 114. Central axis 130 may define the orientation of the corresponding lidar sensor 114. For example, as shown in FIGS. 3 and 6, the lidar sensor 114a include central axis 130a. Central axis 130a extends radially outwards from lidar sensor 114a and defines an orientation of the lidar sensor 114a. Lidar sensors 114 each have an angular scan range, shown as angle 134. Angle 134 may be defined between centerline 86 and centerline 87 which indicate initial/first and final/second angular positions of the corresponding lidar sensor 114 (or the outermost angular orientations of the outermost emitted lasers), respectively. In an exemplary embodiment, angle 134 is 90 degrees. In other embodiments, angle 134 is greater than 90 degrees (e.g., 120 degrees) or less than 90 degrees (e.g., 45 degrees). Central axis 130 of the corresponding lidar sensor 114 extends through the scan area 84 of the lidar sensor 114 and bisects angle 134. For example, as shown in FIG. 3, the central axis 130a of the lidar sensor 114a bisects the angle 134a of the lidar sensor 114a and is oriented at angle 132a relative to longitudinal axis 33 (e.g., angle 132 relative to an axis extending in the y-direction).

Referring now to FIG. 2, each of the lidar sensors 114 may have a maximum sensing range, shown as distance 82, according to an exemplary embodiment. The distance 82 indicates a maximum distance relative to the corresponding lidar sensor 114 over which objects can be detected. The distance 82 and the angle 134 define the scan area 84. The scan area 84 can have the shape of a sector of a circle having a radius equal to the distance 82. The scan area 84 may have be an area

$$A = π {r}^{2} ( \frac{θ}{360} )$$

where r is the distance 82 and θ is the angle 134. The scan area 84 defines a total planar area throughout which objects can be detected by the corresponding lidar sensor 114.

### Scan Area and Sensor Orientation

Referring now to FIG. 3, the scan area 84 includes a first area, portion, zone, etc., shown as stop zone 90, a second area, portion, zone, etc., shown as warning zone 92, and a third area, portion, zone, etc., shown as warning zone 93 according to an exemplary embodiment. The stop zone 90 may be a portion of the scan area 84 that is below/beneath the platform 16. The warning zones 92 and 93 are portions of the scan area 84 that is nearby and/or beneath the platform 16. In an exemplary embodiment, the warning zones 92 are adjacent the stop zone 90. FIG. 2 shows the scan area 84a of lidar sensor 114a, according to an exemplary embodiment. It should be noted that the scan area 84 of any of the lidar sensors 114 may defined similarly to the scan area 84a of the lidar sensor 114a as shown in FIG. 3. For example, each of the lidar sensors 114 may include stop zone 90, warning zone 92, and warning zone 93 defined similarly to stop zone 90a, warning zone 92a, and warning zone 93a of the scan area 84a, respectively. The stop zone 90a of the lidar sensor 114a may be defined as any portion of the scan area 84a that is below platform 16. Alternatively, the stop zone 90a may be defined as any portion of the scan area 84a that covers a current longitudinal width 140 of the lift assembly 14. The stop zone 90a may have longitudinal width 142a, according to an exemplary embodiment. The longitudinal width 142a may be substantially equal to the current longitudinal width 140 of the lift assembly 14, greater than the current longitudinal width 140 of the lift assembly 14 (by some predetermined amount), substantially equal to a longitudinal length of the platform 16, or greater than the longitudinal length of the platform 16 (by some predetermined amount). If the longitudinal width 142a of the stop zone 90a is related to the current longitudinal width 140 of the lift assembly 14 (e.g., substantially equal to the current longitudinal width 140 or greater than the current longitudinal width 140 by some predetermined amount), the stop zone 90a changes as the lift assembly 14 extends. As the lift assembly 14 extends (thereby moving the platform 16 in the positive z direction, or upwards along the vertical axis 35), the current longitudinal width 140 of the lift assembly 14 decreases. Likewise, as the lift assembly 14 retracts (thereby moving the platform 16 in the negative z direction), the current longitudinal width 140 of the lift assembly 14 decreases. In some embodiments, the current longitudinal width 140 of the lift assembly 14 is a maximum current longitudinal width of the lift assembly 14 measured along the longitudinal axis 33 between outermost points of the lift assembly 14. In this way, the stop zone 90a can vary based on a current degree of extension of the lift assembly 14.

The warning zone 92a and the warning zone 93a may be defined as portions of the scan area 84a directly adjacent the stop zone 90a, according to an exemplary embodiment. The warning zone 92a may have a maximum longitudinal width 146a. Likewise, the warning zone 93a may have a maximum longitudinal width 144a. The warning zone 92a may be defined as any portion of the scan area 84a that lies within the maximum longitudinal width 146a from a first end of the stop zone 90a. Likewise, the warning zone 93a may be defined as any portion of the scan area 84a that lies within the maximum longitudinal width 144a from a second opposite end of the stop zone 90a. In some embodiments, the maximum longitudinal width 144a is substantially equal to the maximum longitudinal width 146a. In other embodiments, the maximum longitudinal width 144a is less than or greater than the maximum longitudinal width 146a. The warning zone 93a of lidar sensor 114a may define an area adjacent the stop zone 90a at the first longitudinal end 124 of the platform 16. The warning zone 92a may define an area adjacent the stop zone 90a at the second longitudinal end 126 of the platform 16. The lidar sensor 114a is configured to monitor/detect the presence and relative location of any objects within the scan area 84a. The lidar sensor 114a also detects whether objects within the scan area 84a are within the warning zone 92a, the stop zone 90a, and the warning zone 93a.

As shown in FIG. 3, the scan area 84a of the lidar sensor 114a is defined in the z-y plane, according to an exemplary embodiment. The orientation of the lidar sensor 114a defines the plane of the scan area 84a. In an exemplary embodiment, the central axis 130a is in the z-y plane such that the scan area 84a lies completely within the z-y plane. In other embodiments, the lidar sensor 114a points in a direction such that the scan area 84a is not defined in the z-y plane. For example, the lidar sensor 114a may be angled outwards (about the longitudinal axis 33) such that the scan area 84 is not coplanar with the z-y plane.

The lidar sensor 114a is angled about the lateral axis 31 (i.e., the x-direction) such that an angle 132a is defined between the central axis 130a and the longitudinal axis 33. In some embodiments, the angle 132a is substantially equal to 0 degrees such that the lidar sensor 114a points in the y-direction (e.g., points along the longitudinal axis 33). In an exemplary embodiment, the angle 132a is 60 degrees. The angular scan range (e.g., angle 134a) and the orientation of the lidar sensor 114a (e.g., angle 132a) may be adjusted to achieve a desired scan area 84a in some embodiments. The centerline 86a and the longitudinal axis 33 define an angle 150a. Likewise, the centerline 87a and the longitudinal axis 33 define an angle 152a. The angular orientation of the centerline 86a (e.g., angle 150a, the angular position of the first outermost laser or the initial angular position of the lidar sensor 114a) and the angular orientation of the centerline 87a (e.g., angle 152a, the angular position of the other outermost laser or the final angular position of the lidar sensor 114a) can be adjusted to achieve a desired scan area 84a. For example, the angle 150a may be substantially equal to 90 degrees such that the lidar sensor 114a initially (or the first outermost laser of the lidar sensor 114a) points substantially in the negative z-direction (i.e., along the vertical axis 35). Likewise, the angle 152a may be a value (e.g., 0 degrees) such that a portion (e.g., protrusion 160 as shown in FIGS. 5-8) of the platform 16 lies within the scan area 84a of the lidar sensor 114a.

Lidar sensor 114b may be positioned and oriented similarly/symmetrically to lidar sensor 114a. In other embodiments, lidar sensor 114b is positioned similarly/symmetrically to lidar sensor 114a and is mirrored about the x-z plane. Lidar sensor 114b is similarly configured to monitor/detect objects within a scan area 84b. Lidar sensor 114b can be similarly configured to monitor/detect objects within a stop zone 90b, a warning zone 92b, and a warning area 93b. The stop zone 90b of the lidar sensor 114b may be defined similarly to the stop zone 90a of the lidar sensor 114a (e.g., a portion of the scan area 84 below the platform 16 or a portion of the scan area 84 that covers the lift assembly 14). Likewise, the warning area 92b and the warning area 93b of the lidar sensor 114b may be defined similarly to the warning area 92a and the warning zone 93a of the lidar sensor 114a, respectively. However, the lidar sensor 114b is positioned on a lateral side (i.e., lateral side 122) of the platform 16 opposite the lateral side (i.e., lateral side 120) of the lidar sensor 114a.

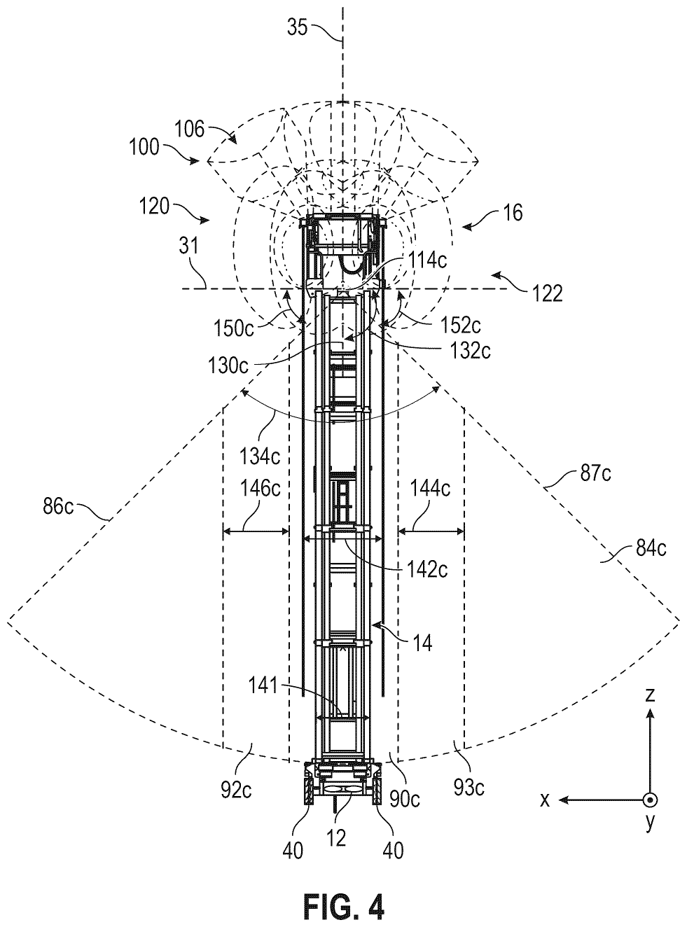

Referring now to FIG. 4, scan area 84c of the lidar sensor 114c is shown, according to an exemplary embodiment. The lidar sensor 114c may be configured similarly to the lidar sensor 114a. The lidar sensor 114c may be oriented such that it points downwards (i.e., in the negative z-direction, along vertical axis 35). Similar to the lidar sensor 114a, the lidar sensor 114c monitors/detects objects within the scan area 84c. The scan area 84c may be defined similarly to the scan area 84a of the lidar sensor 114a. In some embodiments, the scan area 84c is in a plane that is normal to the plane of the scan area 84a. For example, the scan area 84c includes stop zone 90c, warning zone 92c, and warning zone 93c. However, the scan area 84c of lidar sensor 114c is coplanar with the x-z plane rather than the z-y plane, as is the scan area 84a. Width 144c of the warning zone 93c is a lateral width (e.g., a distance measured along the lateral axis 31) as opposed to a longitudinal width as is the longitudinal width 144a that defines warning zone 93a. Likewise, width 142c of the stop zone 90c and width 146c of the warning zone 92c are lateral widths (e.g., measured along the lateral axis 31) as opposed to longitudinal widths. The stop zone 90c may similarly be a portion of scan area 84c below the platform 16 or a portion of scan area 84c that covers lateral width 141 of the lift assembly 14. Likewise, the warning zone 92c and the warning zone 93c are portions of the scan area 84c adjacent the stop zone 90c on either side of the stop zone 90c.

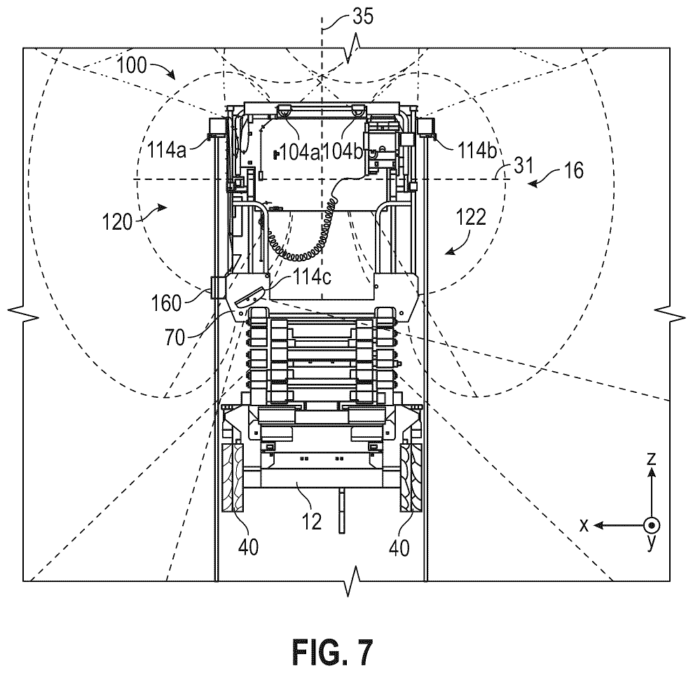

As shown in FIG. 4, the lidar sensor 114c may be oriented such that it points directly downwards (e.g., in the negative z-direction, along the vertical axis 35 in a direction that points below the platform 16, etc.). An angle 132c is defined between the central axis 130c of the lidar sensor 114c and the lateral axis 31 (or between the central axis 130c of the lidar sensor 114c and an axis along the x-direction). If the lidar sensor 114c points directly downwards, the angle 132c is 90 degrees. In other embodiments, the lidar sensor 114 is oriented such that it points in a direction other than straight down. For example, the lidar sensor 114 may be oriented such that angle 132c is 60 degrees (e.g., central axis 130c is 60 degrees below the lateral axis 31 as oriented in FIG. 7). Scan area 84c includes centerline 87c and centerline 86c. Centerline 87c and centerline 86c define the angular outermost edges of the scan area 84c. Angle 152c is defined between the centerline 87c and the lateral axis 31. Angle 150c is defined between the centerline 86c and the lateral axis 31. As shown in FIG. 4, the angle 150c and the angle 152c are substantially both equal to 45 degrees. In other embodiments, the angle 150c and the angle 152c are non-equal to each other. For example, the angle 150c may be 75 degrees (as shown in FIG. 7). Likewise, the angle 152c may be a value other than 45 degrees. For example, the angle 152c may have a value of 15 degrees (as shown in FIG. 7). In an exemplary embodiment, angle 134c (measured between centerline 86c and centerline 87c) is 90 degrees. In other embodiments, angle 134c (the scan angle of the lidar sensor 114c) is greater than 90 degrees (e.g., 120 degrees) or less than 90 degrees (e.g., 60 degrees as oriented in FIG. 7).

The lidar sensor 114d can be configured and oriented similarly to the lidar sensor 114c. For example, the lidar sensor 114d may be configured to monitor/detect objects within a scan area 84d that is similar to the scan area 84c. The lidar sensor 114d may be configured and oriented similar to the lidar sensor 114c, but is positioned at an opposite lateral end (i.e., second longitudinal end 126 as opposed to first longitudinal end 124). In other embodiments, one of the lidar sensor 114c and the lidar sensor 114d is oriented such that it points directly downwards (i.e., in the negative z-direction, downwards along the vertical axis 35), while the other one of the lidar sensor 114c and the lidar sensor 114d is oriented at an angle (i.e., angle 132c is greater than or less than 90 degrees). For example, the lidar sensor 114c may be positioned at the first longitudinal end 124 and oriented as shown in FIG. 4, while the lidar sensor 114 is positioned at the second longitudinal end 126 and is oriented as shown in FIG. 7 (i.e., the angle 132c is 60 degrees). The lidar sensor 114d may be oriented such that the lidar sensor 114d does not detect the lift assembly 14 (e.g., the lidar sensor 114d may be angled slightly outwards, forming an angle between the longitudinal axis 33 and the centerline 130d slightly greater than 90 degrees). The lidar sensor 114d may also be offset along the longitudinal axis 33 in the negative y direction such that it does not detect the lift assembly 14 (e.g., an outer corner of the lift assembly 14). Likewise, the lidar sensor 114c may be offset in the positive y direction along the longitudinal axis 33 or angled slightly outwards such that the lidar sensor 114c does not detect the lift assembly 14 therebelow.

Referring again to FIGS. 5 and 6, the lidar sensor 114a is positioned (e.g., mounted, attached, connected, coupled, fixedly coupled, removably coupled etc.) at the second longitudinal end 126 to a vertical member, an elongated member, a support member, a structural component, a tube, a rail, a bar, etc., shown as vertical rail 170. The lidar sensor 114a protrudes outwards from the first lateral side 120 of the vertical rail 170 at least partially along lateral axis 31. The vertical rail 170 is configured to provide structural support to guard rails 72. In other embodiments, the lidar sensor 114a is positioned to a vertical rail 170 at the first lateral end 126 of the platform 16. In other embodiments, the lidar sensor 114a is coupled to the deck 70 of the platform 16 at the second longitudinal end 126 or the first longitudinal end 124, or at some position on the deck 70 between the second longitudinal end 126 and the first longitudinal end 124 (e.g., half way between the first longitudinal end 124 and the second longitudinal end 126). In other embodiments, the lidar sensor 114a is coupled to an upper most guard rail 73 of the guard rails 72. The lidar sensor 114a may be coupled to the upper most guard rail 73 at any of the second longitudinal end 126 of the platform 16, the first longitudinal end 124 of the platform, or at some position between the second longitudinal end 126 of the platform 16 and the first longitudinal end 124 of the platform (e.g., coupled to the upper most guard rail 73 at a midpoint of the upper most guard rail 73 along the longitudinal axis 33).

In some embodiments, if the platform 16 includes extendable decks 78, the upper most guard rail 73 is a telescoping rail. The upper most guard rail 73 includes an outer member 174 and an inner member 172. The outer member 174 is configured to receive the inner member 172 therewithin. When the extendable deck 78 is extended, the outer member 174 moves relative to the inner member 172. If the platform 16 includes the extendable deck 78, the lidar sensor 114a is coupled to a portion that remains stationary relative to the outer member 174 (e.g., to the inner member 172).

The guard rails 72 may include a protrusion 160. The protrusion 160 may be coupled (e.g., coupled directly or coupled indirectly) to outer member 174 such that the protrusion 160 moves relative to the inner member 172 as the extendable deck 78 is extended. The lidar sensor 114a is configured to track a position (e.g., a relative distance) of the protrusion 160 to determine a degree of extension of the extendable deck 78. The lidar sensor 114a may be coupled to a component of the platform 16 that remains stationary relative to the extendable deck 78. In this way, the lidar sensor 114a can monitor a degree of extension of the extendable deck 78.

The lidar sensor 114b that is positioned on the side of the platform 16 opposite the lidar sensor 114a (e.g., on the first lateral side 122) may be configured and/or oriented similarly to the lidar sensor 114a. For example, the lidar sensor 114b may be coupled (e.g., mounted) to the platform 16 on the first lateral side 122) at any of the positions as described hereinabove with reference to the lidar sensor 114a.

Referring now to FIGS. 5 and 7, the lidar sensor 114c is positioned (e.g., mounted, coupled, attached, fixed, removably coupled, welded, etc.) on the deck 70 at the first longitudinal end 124 of the platform 16. The lidar sensor 114c may be positioned at a lateral centerpoint of the deck 70 (as shown in FIG. 5). In other embodiments, the lidar sensor 114c is positioned at one of the corners of the deck 70 (e.g., at the corner of the deck 70 near the first lateral side 120 as shown in FIG. 7, at the corner of the deck 70 near the first lateral side 122, etc.).

The lidar sensor 114d may be positioned and/or oriented on the opposite end of the platform 16 according to any of the positions and/or orientations of the lidar sensor 114c as described in greater detail hereinabove. For example, the lidar sensor 114d may be coupled to the deck 70 at a lateral midpoint of the deck 70, at a corner of the deck 70, etc., and may be oriented pointing directly downwards, partially downwards, at an angle, etc.

Referring again to FIG. 5, the platform 16 is shown to include four of the ultrasonic sensors 104 coupled to the first longitudinal end 124. Ultrasonic sensor 104c and ultrasonic sensor 104d are coupled to the guard rails 72 and point outwards from the first longitudinal end 124. Ultrasonic sensor 104c and ultrasonic sensor 104d may point in a direction completely in the x-y plane. The ultrasonic sensor 104c and the ultrasonic sensor 104d are configured to monitor/detect the presence of objects in front of (e.g., in areas beyond the first longitudinal end 124 in the y direction) the platform 16 (e.g., while an operator is driving the lift device 10 in the forward direction). The ultrasonic sensor 104c and the ultrasonic sensor 104d are shown angled outwards relative to the longitudinal axis 33. In some embodiments, the ultrasonic sensor 104c and the ultrasonic sensor 104d are oriented at equal angles outwards from the longitudinal axis 33. In other embodiments, the ultrasonic sensor 104c and/or the ultrasonic sensor 104d point in a direction other than completely in the x-y plane. Ultrasonic sensor 104f and ultrasonic sensor 104g may be similarly configured and oriented at the second longitudinal end 126 of the platform 16. The ultrasonic sensor 104f and the ultrasonic sensor 104g may be coupled to the vertical rails 170 at the second longitudinal end 126 of the platform 16. The ultrasonic sensor 104f and the ultrasonic sensor 104g are configured to detect/monitor the presence of objects/obstacles behind (e.g., in areas beyond the second longitudinal end 126 in the negative y direction) the platform 16.

The platform 16 also includes ultrasonic sensor 104a and ultrasonic sensor 104b at the first longitudinal end 124 of the platform 16. The ultrasonic sensor 104a and the ultrasonic sensor 104b are coupled to a support member 180. The support member 180 may be coupled to the upper most guard rail 73 at the first longitudinal end 124 of the platform 16. In other embodiments, the ultrasonic sensor 104a and the ultrasonic sensor 104b are coupled directly to the upper most guard rail 73 (e.g., to the outer member 174). The support member 180 may have an overall length substantially equal to or less than an overall lateral length of the platform 16. The ultrasonic sensor 104a and the ultrasonic sensor 104b are positioned a distance apart along the length of the support member 180. The ultrasonic sensor 104a and the ultrasonic sensor 104b may be positioned at opposite ends of the support member 180.

The ultrasonic sensor 104a and the ultrasonic sensor 104b point in a direction at least partially upwards. The ultrasonic sensor 104a and the ultrasonic sensor 104b are configured to detect objects above the platform 16 at the first longitudinal end 124 of the platform 16 (e.g., beyond the first longitudinal end 124 of the platform 16 in the positive y direction and above the platform 16 in the positive z direction). In some embodiments, the ultrasonic sensor 104a and the ultrasonic sensor 104b are coupled (either directly, or indirectly by being coupled to the support member 180) to outer member 174 and move relative to inner member 172 as the extendable deck 78 is extended.

The platform 16 also includes ultrasonic sensor 104e and ultrasonic sensor 104d at the second longitudinal end 126 of the platform 16. The ultrasonic sensor 104e and the ultrasonic sensor 104d may be coupled to a support member 180 at the second longitudinal end 126 of the platform 16 similar to the support member 180 at the first longitudinal end 124 of the platform 16. The support member 180 at the second longitudinal end 126 of the platform 16 may be similar to the support member 180 at the first longitudinal end 124 of the platform 16 (e.g., coupled to the upper most guard rail 73). The ultrasonic sensor 104e and the ultrasonic sensor 104d may be coupled to the platform 16 and oriented similar to the ultrasonic sensor 104a and the ultrasonic sensor 104b, respectively. For example, the ultrasonic sensor 104e and the ultrasonic sensor 104d may be configured to detect/monitor the presence of objects/obstacles above the platform 16 at the second longitudinal end 126 of the platform 16 (e.g., to detect/monitor the presence of objects beyond the second longitudinal end 126 in the negative y direction and above the platform 16 in the positive z direction).

Referring still to FIG. 5, the platform 16 includes ultrasonic sensor 104i and ultrasonic sensor 104h. Ultrasonic sensor 104i and ultrasonic sensor 104h are coupled at the first lateral side 120 of the platform 16. Ultrasonic sensor 104i and ultrasonic sensor 104h may be coupled to the upper most guard rail 73. In some embodiments, ultrasonic sensor 104i and ultrasonic sensor 104h are coupled to a support member 180. The support member 180 extends at least partially along the first lateral side 120 of the platform 16. The support member 180 is coupled to the upper most guard rail 73. Ultrasonic sensor 104h and ultrasonic sensor 104i are positioned at opposite ends of the support member 180. Ultrasonic sensor 104h and ultrasonic sensor 104i are oriented in a direction to monitor/detect the presence of objects to the right of the platform 16 (e.g., to monitor/detect the presence of objects beyond the first lateral side 120 of the platform 16 in the positive x direction and above the platform 16 in the positive z direction). Ultrasonic sensor 104h and ultrasonic sensor 104i can be similarly oriented and positioned at opposite ends of the support member 180. The ultrasonic sensor 104h and the ultrasonic sensor 104i can be coupled to the outer member 174 such that the ultrasonic sensor 104h and the ultrasonic sensor 104i translate with the outer member 174 relative to the inner member 172. In other embodiments, the ultrasonic sensor 104h and the ultrasonic sensor 104i are coupled with the inner member 172 such that the ultrasonic sensor 104h and the ultrasonic sensor 104i remain stationary relative to the inner member 172 as the outer member 174 translates to extend the extendable deck 78.

Referring still to FIG. 5, the platform 16 includes ultrasonic sensor 104j and ultrasonic sensor 104k at the first lateral side 122 of the platform 16. The ultrasonic sensor 104j and the ultrasonic sensor 104k point outwards and upwards from the first lateral side 122 of the platform 16. The ultrasonic sensor 104j and the ultrasonic sensor 104k may be configured and oriented similarly to the ultrasonic sensor 104i and the ultrasonic sensor 104k, respectively. For example, the ultrasonic sensor 104j and the ultrasonic sensor 104k may be coupled to a support member 180, directly to the outer member 174 of the upper most guard rail 73, etc. The ultrasonic sensor 104j and the ultrasonic sensor 104k are configured to monitor/detect the presence of objects to the left of and above (e.g., beyond the first lateral side 122 in the negative x direction and above the platform 16 in the positive z direction) the platform 16.

### Ultrasonic Sensors

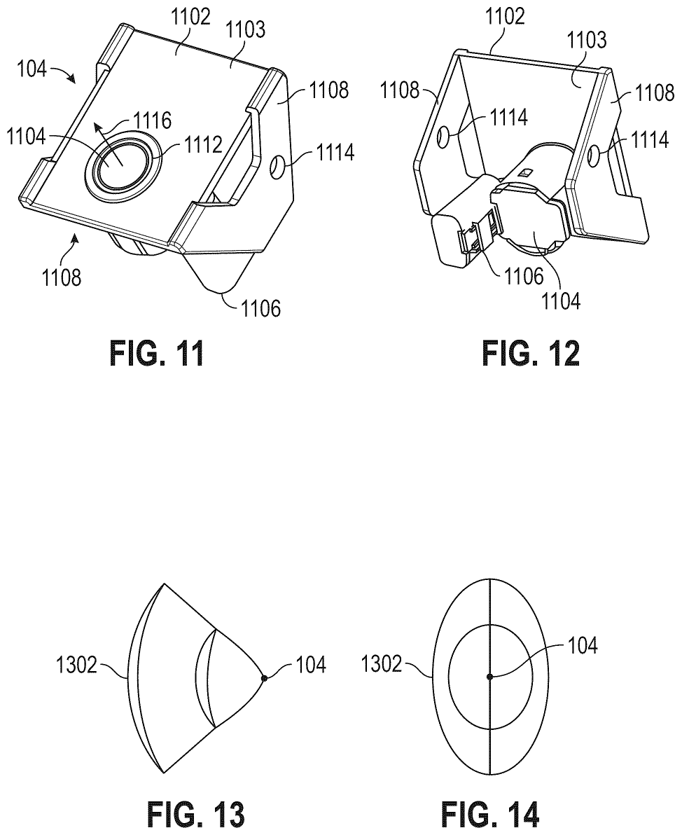

Referring now to FIGS. 11-12, one of the ultrasonic sensors 104 is shown in greater detail, according to an exemplary embodiment. The ultrasonic sensor 104 includes a housing 1102 having a center portion 1103 and side portions 1108. The side portions 1108 extend in a same direction perpendicularly from outer edges of the center portion 1103. The center portion 1103 includes a window, an opening, a hole, etc., shown as aperture 1112 configured to receive an ultrasonic emitter/receiver 1104 therewithin. The side portions 1108 include one or more fastener interfaces 1114 (e.g., through holes, bores, apertures, etc.) configured to facilitate attachment of the ultrasonic sensor 104 to a supporting member (e.g., to any of the guard rails 72 of the platform 16, to the support member 180, etc.). The ultrasonic emitter/receiver 1104 extends through the aperture 1112 and includes an electrical connector 1106. The electrical connector 1106 facilitates electrical and communicable connection between a controller (e.g., controller 1500) and the ultrasonic emitter/receiver 1104.

Referring still to FIGS. 11-12, a unit vector 1116 is shown extending normally outwards from a surface of the ultrasonic emitter/receiver 1104, according to an exemplary embodiment. The unit vector 1116 points in a direction which the ultrasonic waves are emitted by the ultrasonic emitter/receiver 1104. The unit vector 1116 may define an orientation of the ultrasonic sensor 104. It should be understood that any references to “orientation” “angulation” “angle” “direction,” etc. throughout the present disclosure with reference to any of the ultrasonic sensors 104 may refer to the orientation of the unit vector 1116 in a coordinate system (e.g., in an x-y-z coordinate system, relative to lateral axis 31, relative to longitudinal axis 33, relative to vertical axis 35, etc.).

Referring now to FIGS. 13-14, the ultrasonic sensor 104 can emit ultrasonic waves 1302. The ultrasonic waves 1302 emitted by the ultrasonic sensor 104 may have an overall conical shape. As the ultrasonic waves 1302 travel further distances from the ultrasonic sensor 104, the diameter of the conical shape increases. The conical shape of the ultrasonic waves 1302 may be a smooth conical shape. The conical shape of the ultrasonic waves 1302 may have an overall circular cross-sectional shape. In some embodiments, the conical shape of the ultrasonic waves 1302 has an elliptical cross-sectional shape.

### Platform

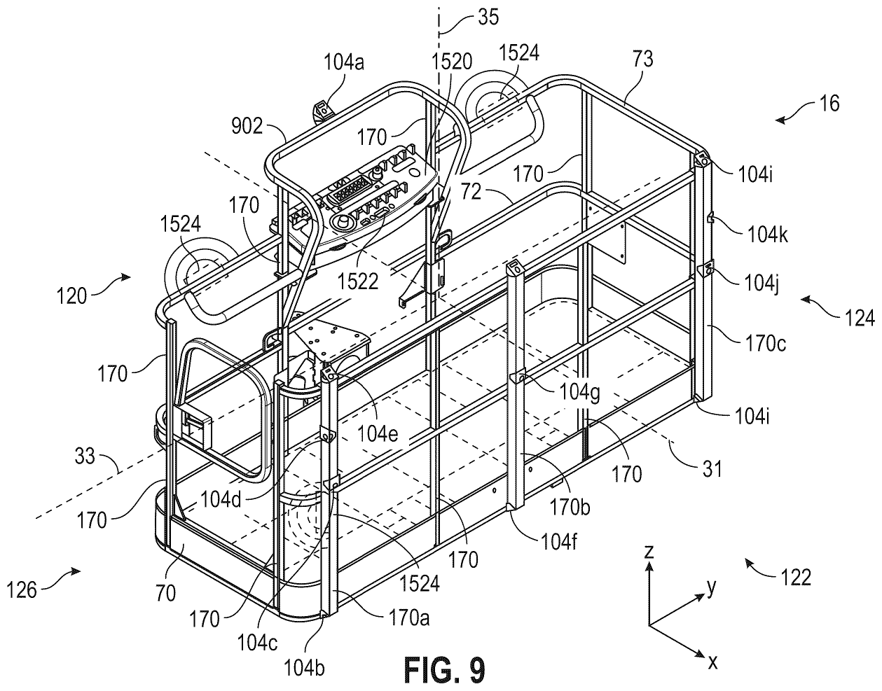

Referring now to FIG. 9, the platform 16 is shown according to another embodiment. The platform 16 as shown in FIG. 9 may share any of the features of the platform 16 as shown in FIGS. 1-8 and described in greater detail above. However, the platform 16 as shown in FIG. 9 includes ultrasonic sensors 104 in different positions and orientations.

The platform 16 includes twelve ultrasonic sensors positioned about various members of the platform 16. The platform 16 includes a rail, tubular member, pipe, handle, etc., shown as guard rail 902. The guard rail 902 extends along a portion of a perimeter of a human machine interface (HMI) (e.g., a user interface, a control panel, an operator station, etc.), shown as HMI 1520. The guard rail 902 is extends above the HMI 1520 and can be grasped by a user when the lift assembly 14 is extending or retracting. The guard rail 902 includes an ultrasonic sensor 104a mounted to an upper portion of the guard rail 902 and directed inwards towards an area where a user stands to operate the HMI 1520. The ultrasonic sensor 104a can be configured to detect if a user is leaning over the guard rail 902. Advantageously, the object detection system 100 can use the detection of the user to restrict operation of the lift device 10. For example, if the ultrasonic sensor 104a detects that the user (e.g., the operator) is leaning over the guard rail 902, the object detection system 100 can prevent operation of the lift device 10.

Referring still to FIG. 9, the platform 16 includes vertical rails 170 disposed along substantially an entire perimeter of the platform 16. The platform 16 includes vertical rail 170a, vertical rail 170b, and vertical rail 170c spaced apart along the first lateral side 122 of the perimeter of the platform 16. The vertical rail 170a and the vertical rail 170c may be symmetric about the x-z plane (e.g., a plane defined by the vertical axis 35 and the lateral axis 31) such that whatever is said of the vertical rail 170a may be said of the vertical rail 170c.

The vertical rail 170a is positioned on the first lateral side 122 at the second longitudinal end 126. Likewise, the vertical rail 170c is positioned on the first lateral side 122 at the first longitudinal end 124. The vertical rail 170 includes ultrasonic sensor 104b, ultrasonic sensor 104c, ultrasonic sensor 104d, and ultrasonic sensor 104e. The ultrasonic sensor 105b and the ultrasonic sensor 104e are positioned at opposite ends of the vertical rail 170a. The ultrasonic sensor 104e points outwards from the platform 16 and at least partially upwards. The ultrasonic sensor 104e points in a direction at least partially along the lateral axis 31 (e.g., the negative x direction) and at least partially along the vertical axis 35. Specifically, the ultrasonic sensor 104e points in a direction parallel with a plane defined by the vertical axis 35 and the lateral axis 31 (e.g., the x-z plane).

The ultrasonic sensor 104b may be oriented similarly to the ultrasonic sensor 104e, but rather than pointing upwards from the platform 16, the ultrasonic sensor 104b points downwards (e.g., at least partially in the negative z-direction). The ultrasonic sensor 104b points in a direction that is co-planar with the direction that the ultrasonic sensor 104e points. An angle defined between the lateral axis 31 and a centerline extending outwards from the ultrasonic sensor 104b may be substantially equal to (although having an opposite sign) an angle defined between the lateral axis 31 and a centerline extending outwards from the ultrasonic sensor 104e.

The vertical rail 170a includes ultrasonic sensor 104c and ultrasonic sensor 104d, according to an exemplary embodiment. The ultrasonic sensor 104c is positioned substantially at a midpoint along the length of the vertical rail 170a. The ultrasonic sensor 104c points in a direction outwards from the platform 16 and substantially along the lateral axis 31. The ultrasonic sensor 104c is configured to monitor/detect the presence of objects to the right of the platform (e.g., to monitor/detect the presence and relative distance of objects beyond the first lateral side 122 of the platform 16 along the lateral axis 31 or in the negative x-direction).

The ultrasonic sensor 104d is positioned along the vertical rail 170a substantially at a midpoint between the ultrasonic sensor 104e and the ultrasonic sensor 104c. The ultrasonic sensor 104d points outwards from the platform 16 along the longitudinal axis 33 (e.g., the ultrasonic sensor points in the positive y-direction). The ultrasonic sensor 104d is configured to monitor/detect the presence and relative distance of objects behind the platform 16 (e.g., to monitor/detect the presence and relative distance of objects beyond the second longitudinal end 126 of the platform 16 along the longitudinal axis 33 or in the positive y-direction).

Referring still to FIG. 9, the platform 16 is shown to include the vertical rail 170b, according to an exemplary embodiment. The vertical rail 170b is positioned along the first longitudinal end 122 of the platform 16 at substantially a longitudinal midpoint of the platform 16. The vertical rail 170b is spaced apart equal longitudinal distances from the vertical rail 170a and the vertical rail 170c.

The vertical rail 170b includes ultrasonic sensor 104h, ultrasonic sensor 104g, and ultrasonic sensor 104f, according to an exemplary embodiment. The ultrasonic sensor 104h may be oriented similarly to the ultrasonic sensor 104e. The ultrasonic sensor 104g is oriented similarly to the ultrasonic sensor 104c. The ultrasonic sensor 104f is oriented similarly to the ultrasonic sensor 104b.

Referring still to FIG. 9, the platform 16 includes vertical rail 170c. The vertical rail 170c may be symmetric to the vertical rail 170a but is positioned along the first lateral side 122 at the first longitudinal end 124 of the platform 16, such that whatever is said of the vertical rail 170a can be said of the vertical rail 170c. The vertical rail 170c includes ultrasonic sensor 104l, ultrasonic sensor 104k, ultrasonic sensor 104j, and ultrasonic sensor 104i. The ultrasonic sensor 104l may be oriented similarly to the ultrasonic sensor 104e. The ultrasonic sensor 104k may be oriented similarly to the ultrasonic sensor 104d but pointing in an opposite direction (e.g., in the negative y-direction). The ultrasonic sensor 104j may be oriented similarly to the ultrasonic sensor 104c. The ultrasonic sensor 104i may be oriented similarly to the ultrasonic sensor 104b. The ultrasonic sensor 104l is positioned at a top end of the vertical rail 170c. the ultrasonic sensor 104i is positioned at a bottom end of the vertical rail 170c (e.g., an end of the vertical rail 170c opposite to the end at which the ultrasonic sensor 104l is positioned). The ultrasonic sensor 104j is positioned at a midpoint along the length of the vertical rail 170c. The ultrasonic sensor 104k is positioned at equal distances between the ultrasonic sensor 104l and the ultrasonic sensor 104j along the vertical axis 35.

Referring still to FIG. 9, the platform 16 includes one or more visual alert devices 1522 and one or more aural alert devices 1524, according to an exemplary embodiment. The visual alert devices 1522 may be any light emitting device, screen, LEDs, etc., configured to provide a visual alert to a user. The aural alert devices 1524 can be any speaker, buzzer, alarm, etc., or any other device configured to provide an aural/auditory alert to a user. The visual alert devices 1522 may be positioned at the HMI 1520. The aural alert devices 1524 may be positioned anywhere about the platform 16. For example, the aural alert devices 1524 may be positioned at any of the vertical rails 170, the upper most guard rail 73, any of the guard rails 72, at the deck 70, etc. In other embodiments, one or more of the aural alert devices 1524 are positioned at the HMI 1520. The visual alert devices 1522 and the aural alert devices 1524 may be referred to as alert system 1516.

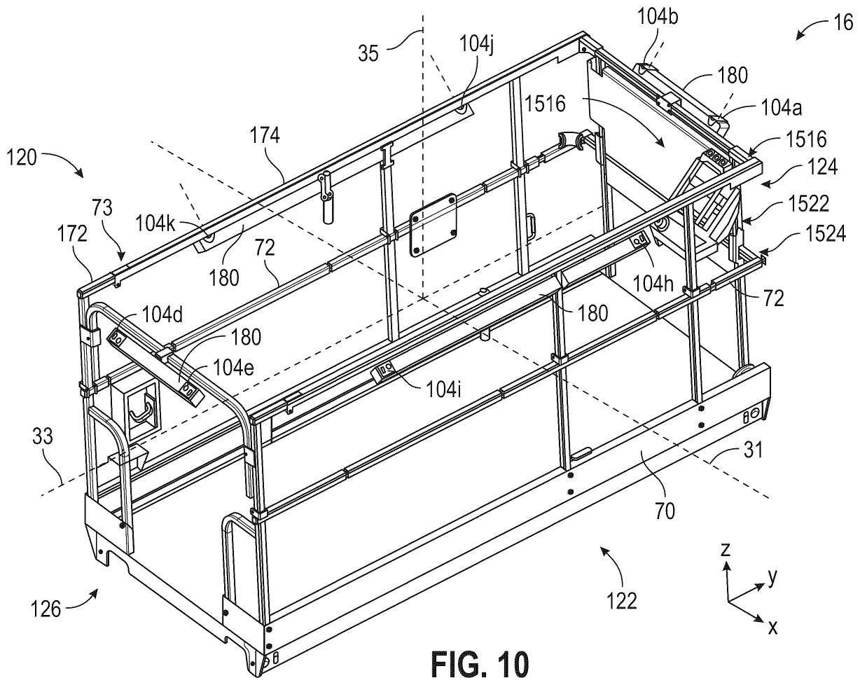

Referring now to FIG. 10, the platform 16 is shown according to another embodiment. The platform 16 as shown in FIG. 10 may be the same as or similar to the platform 16 as shown in FIGS. 2-8. For example, the platform 16 includes ultrasonic sensor 104a and ultrasonic sensor 104b positioned at the first longitudinal end 124 and mounted to the support member 180. The ultrasonic sensor 104a and the ultrasonic sensor 104b as shown in FIG. 10 may be the same as or similar to the ultrasonic sensor 104a and the ultrasonic sensor 104b as shown and described in greater detail above with reference to FIGS. 2-8.

The ultrasonic sensor 104a and the ultrasonic sensor 104b are mounted (e.g., coupled) to the support member 180 at the first longitudinal end 124. The support member 180 at the first longitudinal end 124 is coupled (e.g., connected, coupled, fastened, etc.) to the upper most guard rail 73 of the platform 16. The ultrasonic sensor 104a and the ultrasonic sensor 104b are positioned at opposite ends of the support member 180. The ultrasonic sensor 104a points outwards from the platform 16 in a direction at least partially upwards (e.g., at least partially along the vertical axis 35 or at least partially along the positive z direction) and at least partially along the longitudinal axis 33 (e.g., at least partially in the negative y direction). The ultrasonic sensor 104a points in a direction that is substantially parallel to a plane defined by the vertical axis 35 and the longitudinal axis 33 (e.g., the z-y plane). The ultrasonic sensor 104b is oriented similarly to the ultrasonic sensor 104a but is positioned at the opposite end of the support member 180. The ultrasonic sensor 104a and the ultrasonic sensor 104b are configured to monitor/detect the presence and relative distance of objects in front of and above the platform 16 (e.g., to monitor/detect the presence and relative distance of objects beyond the first longitudinal end 124 of the platform along the longitudinal axis 33 and at least partially above the platform 16 along the vertical axis 35).

The platform 16 includes ultrasonic sensor 104d and ultrasonic sensor 104e coupled to support member 180 at the opposite end of the platform 16 (e.g., at the second longitudinal end 126 of the platform). The ultrasonic sensor 104d and the ultrasonic sensor 104e are coupled at opposite ends of the support member 180. The ultrasonic sensor 104d and the ultrasonic sensor 104e may be symmetric to the ultrasonic sensor 104b and the ultrasonic sensor 104a about a plane defined by the lateral axis 31 and the vertical axis 35 (e.g., symmetric about the x-y plane). The ultrasonic sensor 104d and the ultrasonic sensor 104e are configured to monitor/detect the presence and relative distance of objects behind and at least partially above the platform 16 (e.g., to monitor/detect the presence and relative distance of objects beyond the second longitudinal end 126 along the longitudinal axis 33 and at least partially above the platform 16 along the vertical axis 35).

The platform 16 includes ultrasonic sensor 104k and ultrasonic sensor 104j coupled to support member 180 at the first lateral side 120 of the platform 16. The ultrasonic sensor 104k and the ultrasonic sensor 104j point in a direction outwards from the platform 16, at least partially along the lateral axis 31 (e.g., at least partially in the positive x direction), and at least partially along the vertical axis 35 (e.g., at least partially in the positive z direction). The ultrasonic sensor 104k and the ultrasonic sensor 104j may both point in directions that are substantially parallel to a plane defined by the vertical axis 35 and the lateral axis 31 (e.g., the x-z plane). The ultrasonic senor 104k and the ultrasonic sensor 104j are positioned at opposite ends of the support member 180. The ultrasonic sensor 104k and the ultrasonic sensor 104j are configured to monitor/detect the presence and relative distance of objects to the right of and at least partially above the platform 16 (e.g., to monitor/detect the presence and relative distance of objects beyond the first lateral side 120 of the platform 16 in a direction at least partially along the lateral axis 31 (e.g., the positive x-direction) and at least partially above the platform 16 along the vertical axis 35 (e.g., the positive z-direction)).

The platform 16 includes ultrasonic sensor 104i and ultrasonic sensor 104h coupled to support member 180 at the first lateral side 122 of the platform 16. The ultrasonic sensor 104i and the ultrasonic sensor 104h may be symmetric and similar to the ultrasonic sensor 104k and the ultrasonic sensor 104j about a plane defined by the vertical axis 35 and the longitudinal axis 33 (e.g., symmetric about the z-y plane). The ultrasonic sensor 104i and the ultrasonic sensor 104h are configured to monitor/detect the presence and relative distance of objects beyond the first lateral side 122 along the lateral axis 31 (e.g., objects beyond the platform 16 in the negative x direction) and at least partially above the platform 16 along the vertical axis 35 (e.g., objects above the platform 16 in the positive z direction).

Referring still to FIG. 10, the platform 16 includes HMI 1520, according to an exemplary embodiment. The HMI 1520 is configured to receive a user input to extend or retract the lift assembly 14 and/or the drive and steer the lift device 10. The HMI 1520 may include any buttons, levers, user input devices, switches, etc., configured to receive a user input. The HMI 1520 may include the alert system 1516. The HMI 1520 may include one or more of the aural alert devices 1524 and/or one or more of the visual alert devices 1522 configured to provide at least one of a visual alert and an aural alert to the user (e.g., the operator).

### Extendable Deck

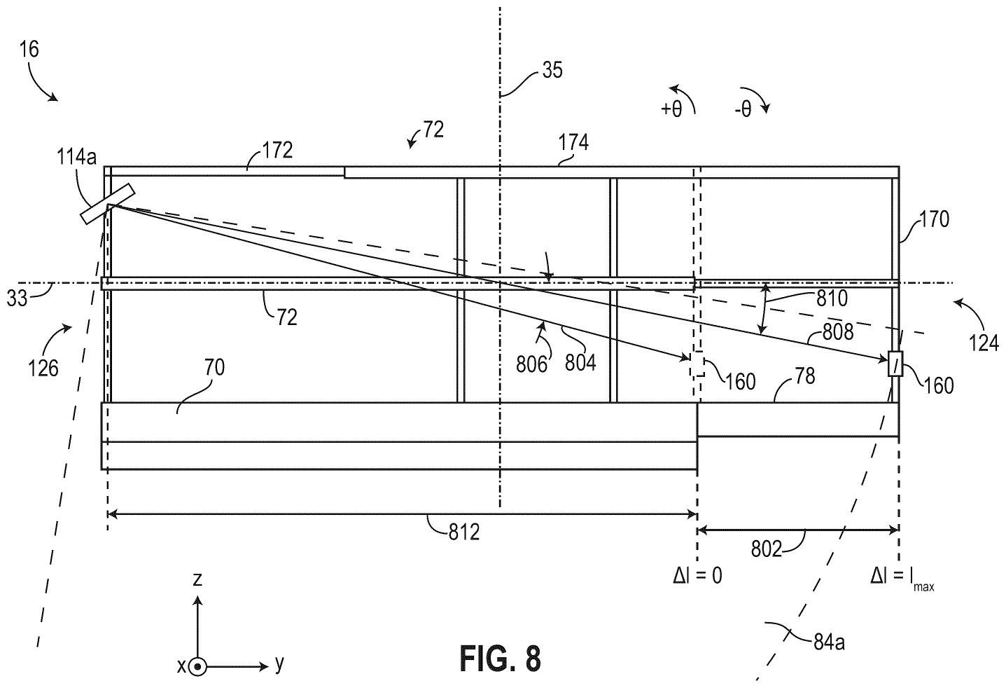

Referring to FIG. 8, the lidar sensor 114a (and/or the lidar sensor 114b) can be configured to monitor a degree of extension of the extendable deck 78, according to an exemplary embodiment. If the protrusion 160 is within the scan area 84a of the lidar sensor 114a when the extendable deck 78 is in the fully retracted position (as represented by the dashed lines) and when the extendable deck 78 is in the fully extended position (as represented by the solid lines), the lidar sensor 114a can monitor a position of the protrusion 160 that can be used to determine a degree of extension (i.e., distance 802) of the extendable deck 78. The distance 802 is an amount of extension of the extendable deck 78 and may be referred to as variable Δl. If Δl=0, the extendable deck 78 is fully retracted. If Δl=lₘₐₓ, the extendable deck 78 is fully extended. The lidar sensor 114a can monitor a current position (e.g., z-y coordinates or polar coordinates) of the protrusion 160. For example, when the extendable deck 78 is fully retracted (i.e., Δl=0), the protrusion 160 is a distance 804 from the lidar sensor 114a at an angle 806 (relative to the longitudinal axis 33). The distance 804 may be referred to as variable r_{retracted} and the angle 806 may be referred to as θ_{retracted}. In some embodiments, the controller 1500 stores the values of r_{retracted} and θ_{retracted} (i.e., the polar coordinates of the protrusion 160 when the extendable deck 78 is fully retracted) and/or values of y_{retracted} and z_{retracted} (i.e., the Cartesian coordinates of the protrusion 160 when the extendable deck 78 is fully retracted), where y_{retracted}=r_{retracted} COS (θ_{retracted}) and z_{retracted}=r_{retracted} sin (θ_{retracted}). The controller 1500 can compare a currently determined position (e.g., y-z Cartesian coordinates and/or r 20 polar coordinates) of the protrusion 160 to known positions of the protrusion 160 that correspond to the extendable deck 78 being fully extended or fully retracted. The controller 1500 can receive current values of r and 0 of the protrusion 160 relative to the lidar sensor 114a to determine current y and z coordinates of the protrusion 160. In other embodiments, the controller 1500 receives the current y and z coordinates of the protrusion 160 from the lidar sensor 114a.

The controller 1500 can determine a current value of Δl based on a current y coordinate of the protrusion 160 relative to the lidar sensor 114a and a known longitudinal distance 812 between the lidar sensor 114a and the protrusion 160 when the extendable deck 78 is in the fully retracted position. The controller 1500 can determine the displacement Δl of the extendable deck 78 using the equation Δl=y-y_{distance} where Δl is the distance 802, y is a current longitudinal distance between the lidar sensor 114a and the protrusion 160, and y_{distance} is the known longitudinal distance 812 of the protrusion 160 from the lidar sensor 114a when the extendable deck 78 is fully retracted, and 0≤Δl≤lₘₐₓ. The controller 1500 can also determine the value of Δl periodically over a time interval Δt to determine a rate of change of extension or retraction of the extendable deck 78. The protrusion 160 may be an additional component (e.g., a bar, a beam, a pipe, an extension, etc.) coupled to any of the extendable deck 78, a vertical rail 170 that moves with the extendable deck 78, the outer member 174 of the upper most guard rail 73, etc., or any other component of the platform 16 that moves with the extendable deck relative to the lidar sensor 114a. In other embodiments, the protrusion 160 is a component of the extendable deck 78 such as one of the vertical rails 170, a portion of one of the vertical rails 170, a portion of the extendable deck 78, a portion of the outer member 174 of the upper most guard rail 73, etc. In some embodiments, the “top beam” of the lidar sensor 114a monitors the extension of the extendable deck 78.

Advantageously, using the lidar sensor 114a to monitor the extension of the extendable deck 78 removes the need to use an extension sensor. The lidar sensor 114a can be used for object detection around the platform 16 (e.g., below the platform 16) and also to determine if the extendable deck 78 is fully extended, fully retracted, or at some position between fully extended and fully retracted (e.g., 50% extended, 75% extended, etc.).

Referring again to FIG. 3, the width 142 of any of the stop zones 90, the width 144 of any of the warning zones 93, and/or the width 146 of any of the stop zones 90 can change based on a degree of extension of the lift assembly 14. The degree of extension of the lift assembly 14 may be distance 302 between the bottom of the platform 16 and the top of the frame assembly 12 (e.g., an overall height of the lift assembly 14) or distance 304 between the bottom of the platform 16 and the ground (e.g., an overall height of the lift assembly 14 and the frame assembly 12). As the lift assembly 14 extends (e.g., the platform 16 moves in the positive z direction or moves upwards along the vertical axis 35), the longitudinal width 140 of the lift assembly 14 may decrease (due to a bottom end of the bottom outer member 64 moving along the longitudinal axis 33 in the negative y direction) and an angle 306 defined between the bottom most inner member 62 and the longitudinal axis 33 increases (and an angle 308 defined between the bottom most outer member 64 and the longitudinal axis 33 increases). A lift assembly sensor 115 can be used to measure/monitor/detect/sense any of the longitudinal width 140 of the lift assembly 14 and/or angle 306 (or angle 308). The lift assembly sensor 115 may be a single sensor or a collection of sensors. The lift assembly sensor 115 may be any of or a collection of an angle sensor configured to measure angle 306 and/or angle 308, a proximity sensor configured to measure the longitudinal width 140 of the lift assembly 14, a linear potentiometer configured to measure the longitudinal width 140 of the lift assembly 14, an ultrasonic sensor configured to measure the longitudinal width 140 of the lift assembly 14, an IR sensor configured to measure the longitudinal width 140 of the lift assembly 14, etc., or any other sensor configured to measure the longitudinal width 140 of the lift assembly 14 or the angle 306 or angle 308.

In some embodiments, the controller 1500 uses the measured values of the longitudinal width 140 of the lift assembly 14 and/or the angle 306 (or angle 308) to adjust the stop zone 90 and/or the warning zones 93 and 92. For example, the controller 1500 may use the measured value of the longitudinal width 140 to adjust the longitudinal width 142a of the stop zone 90a or to adjust the longitudinal width 142b of the stop zone 90b. For example, as the platform 16 is raised due to the extension of the lift assembly 14 and the longitudinal width 140 of the lift assembly 14 decreases, the longitudinal width 142a of the stop zone 90a may also decrease. Likewise, the longitudinal width 144a of the warning zone 93a and the longitudinal width 146a of the warning zone 92a may decrease as the platform 16 is raised and the longitudinal width 140 of the lift assembly 14 decreases. In other embodiments, as the platform 16 is raised and the longitudinal width 140 of the lift assembly 14 decreases, the longitudinal width 142a of the stop zone 90a decreases but the longitudinal width 144a of the warning zone 93a and the longitudinal width 146a of the warning zone 92a increase or remain constant.

### Controller

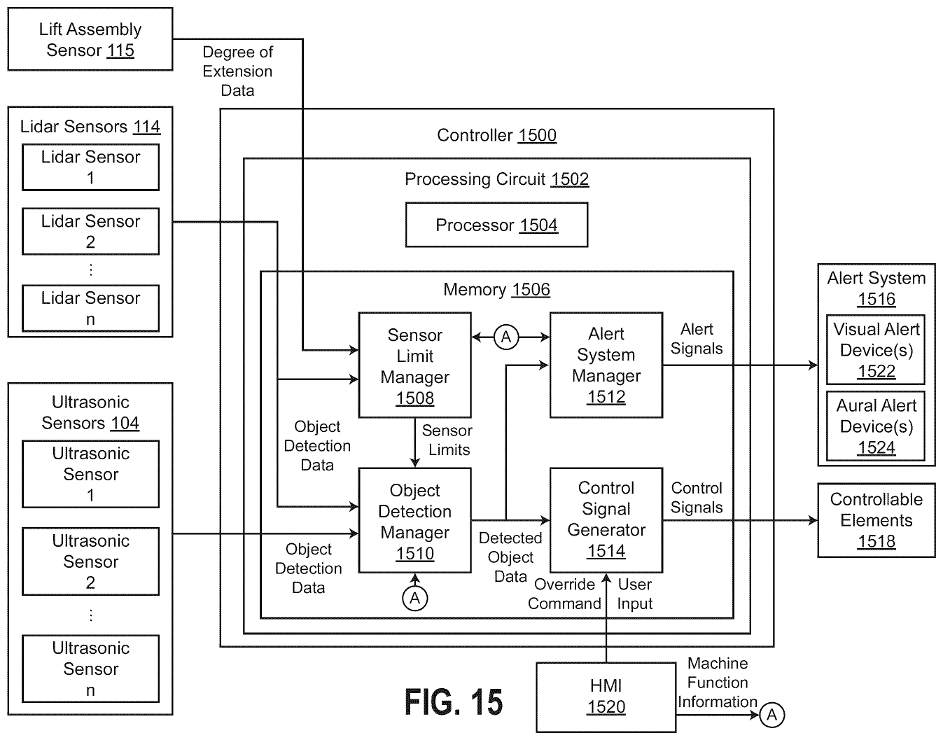

Referring now to FIG. 15, the controller 1500 is shown in greater detail, according to an exemplary embodiment. The controller 1500 is configured to receive object detection data from any of the lidar sensors 114 and/or object detection data from any of the ultrasonic sensors 104 to determine alerts or determine if certain operations of the lift device 10 should be restricted. The controller 1500 also receives data regarding the amount of extension of the lift assembly 14 (e.g., values of the longitudinal width 140 of the lift assembly 14 and/or values of angle 306 and/or values of angle 308) from the lift assembly sensor 115. The controller 1500 can use the data to determine adjustments to any of the stop zones 90, the warning zones 93, and/or the warning zones 92. For example, the controller 1500 may increase or decrease an overall area of any of the stop zones 90, the warning zones 93, and/or the warning zones 92 based on the degree of extension of the lift assembly 14 (e.g., how elevated the platform 16 is above the ground). The controller 1500 may receive user inputs from the HMI 1520. The user inputs from the HMI 1520 may indicate commands from a user to extend or retract the lift assembly 14 or to drive/steer the lift device 10. The controller 1500 determines if any objects, obstacles, obstructions, etc., are present in any of the stop zones 90, the warning zones 93, and the warning zones 92 based on the object detection data from the lidar sensors 114 and/or the ultrasonic sensors 104. The controller may also determine a relative distance between any objects and the lift device 10 or the platform 16 (e.g., objects above the platform 16, below the platform 16, etc.). Based on whether any objects/obstacles are within the stop zones 90, the warning zones 93, the warning zones 92, or within a certain distance of the platform 16 or the lift device 10, the controller 1500 can restrict one or more operations of the lift device 10 that could cause a collision with the obstacle and/or cause the alert system 1516 to provide an alert (e.g., a visual alert and/or an aural alert) to the operator/user.

The controller 1500 includes a processing circuit 1502, a processor 1504, and memory 1506. The processor 1504 can be a general purpose or specific purpose processor, an application specific integrated circuit (ASIC), one or more field programmable gate arrays (FPGAs), a group of processing components, or other suitable processing components. The processor 1504 is configured to execute computer code or instructions stored in the memory 1506 or received from other computer readable media (e.g., CDROM, network storage, a remote server, etc.), according to some embodiments.

The memory 1506 can include one or more devices (e.g., memory units, memory devices, storage devices, etc.) for storing data and/or computer code for completing and/or facilitating the various processes described in the present disclosure. The memory 1506 can include random access memory (RAM), read-only memory (ROM), hard drive storage, temporary storage, non-volatile memory, flash memory, optical memory, or any other suitable memory for storing software objects and/or computer instructions. The memory 1506 can include database components, object code components, script components, or any other type of information structure for supporting the various activities and information structures described in the present disclosure. The memory 1506 can be communicably connected to the processor 1504 via the processing circuit 1502 and can include computer code for executing (e.g., by the processor 1504) one or more processes described herein.

The controller 1500 may a communications interface (not shown), according to some embodiments. The communications interface can include any number of jacks, wire terminals, wire ports, wireless antennas, or other communications interfaces for communicating information (e.g., sensory information) and/or control signals (e.g., control signals for controllable elements 1518, alert signals for alert system 1516, etc.). The communications interface facilitates a communicable connection between the controller 1500 and any of the lidar sensors 114, the ultrasonic sensors 104, the lift assembly sensor 115, the HMI 1520, the alert system 1516, the controllable elements 1518, etc., or any other sensors, systems, controllers and/or controllable elements of the lift device 10). For example, the communications interface can be configured to receive an analog or a digital signal of the sensory information from the lift assembly sensor 115, the lidar sensors 114, the ultrasonic sensors 104, etc. In some embodiments, the communications interface is configured to receive a user input from the HMI 1520. The communications interface can be a digital output (e.g., an optical digital interface) configured to provide a digital control signal to the controllable elements 1518 and/or the alert system 1516. In other embodiments, the communications interface is configured to provide an analog output signal to the alert system 1516 and/or the controllable elements 1518. In some embodiments, the communications interface is configured to provide display signals to HMI 1520 to display an indication of a detected object in any of the warning zones 92, the warning zones 93, and the stop zones 90.

Referring still to FIG. 15, the memory 1506 includes a sensor limit manager 1508, and an object detection manager 1510, according to some embodiments. The sensor limit manager 1508 is configured to receive the object detection data from any of the lidar sensors 114 and/or any of the ultrasonic sensors 104 as well as the data from the lift assembly sensor 115 indicating a degree of extension of the lift assembly 14 (and thereby an elevation of the platform 16 relative to the ground). The sensor limit manager 1508 can use the object detection data and/or the data from the lift assembly sensor 115 indicating the degree of extension of the lift assembly 14 to determine sensor limits. The sensor limit manager 1508 provides the sensor limits to the object detection manager 1510. The sensor limits may include definitions of the stop zones 90, the warning zones 92, the warning zones 93, etc. The sensor limit manager 1508 may determine an increase or a decrease in an overall area of any of the stop zones 90, the warning zones 92, and the warning zones 93 based on the data received from the lift assembly sensor 115 indicating the degree of extension of the lift assembly 14. In some embodiments, the sensor limit manager 1508 decreases the longitudinal width 142a of the stop zone 90a of the lidar sensor 114a and decreases the longitudinal width 142b of the stop zone 90b of the lidar sensor 114b in response to receiving data from the lift assembly sensor 115 indicating that the lift assembly 14 has been extended by some amount. In some embodiments, the sensor limit manager 1508 increases the longitudinal width 142a of the stop zone 90a of the lidar sensor 114a and increases the longitudinal width 142b of the stop zone 90b of the lidar sensor 114b in response to receiving data from the lift assembly sensor 115 indicating that the lift assembly 14 has been retracted by some amount.

The sensor limit manager 1508 can also provide the object detection manager 1510 with sensor limits for the ultrasonic sensors 104. For example, the sensor limit manager 1508 may provide the object detection manager 1510 with various sensor limits of each of the one or more ultrasonic sensors 104 indicating a warning zone and a stop zone. The sensor limits of the ultrasonic sensors 104 provided to the object detection manager 1510 by the sensor limit manager 1508 can define a minimum allowable distance between an object and any of the ultrasonic sensors 104. The minimum allowable distance may be a closest allowable distance between the platform 16 and the obstacle before the platform 16 is restricted from operating in a direction (e.g., extending) that would cause a collision. For example, the sensor limit manager 1508 may provide the object detection manager 1510 with a minimum allowable distance of 6 feet for one or more of the ultrasonic sensors 104, indicating that if any of the one or more ultrasonic sensors 104 detect that an object is 6 feet (or less) away from the platform 16, the platform 16 should not be allowed to be extended. In other embodiments, the sensor limit manager 1508 provides the object detection manager 1510 with a warning range, and the minimum allowable distance for any of the ultrasonic sensors 104. The warning range can indicate that if an object is detected by any of the ultrasonic sensors 104 within the warning range (e.g., between 6 and 10 feet away from the platform 16), an alert/alarm should be provided to the user. It should be understood that the warning range and the minimum allowable distance for the ultrasonic sensors 104 may be the same for each, or may vary based on the orientation and placement of the ultrasonic sensor 104. For example, one or more of the ultrasonic sensors 104 may have a first warning range and a first minimum allowable distance, while another one or more of the ultrasonic sensors may have a second warning range and a second minimum allowable distance. The sensor limit manager 1508 can determine any of the sensor limits based on known orientations and positions of each of the ultrasonic sensors 104 and/or the lidar sensors 114.

The controller 1500 can also be configured to receive machine function information from the HMI 1520. In other embodiments, the controller 1500 is configured to receive sensory information (e.g., from a GPS, a speed sensor, extension sensors, various feedback sensors, etc.) that indicate the machine function information. The machine function information can indicate any currently performed operations of the lift device 10. For example, the machine function information may indicate a direction of travel of the lift device 10, whether the lift assembly 14 is being raised or lowered, a direction of travel of the platform 16, etc. The sensor limit manager 1508 and/or the object detection manager 1510 can use the machine function information to perform their respective functions. For example, the sensor limit manager 1508 may adjust or define the sensor limits based on the machine function information. According to one example, the sensor limit manager 1508 may adjust the warning zone and/or the stop zone based on the machine function information. For example, the sensor limit manager 1508 may increase a size of the warning zone and/or the stop zone that is in front of the lift device 10 if the machine function information indicates that the lift device 10 is driving forwards.

The object detection manager 1510 can be similarly configured to receive and use the machine function information. In some embodiments, the object detection manager 1510 uses the machine function information to determine which of the ultrasonic sensors 104 and the lidar sensors 114 should be monitored/evaluated. For example, if the machine function information indicates that the lift device 10 is travelling forwards, the object detection manager 1510 may monitor and/or evaluate the object detection data received form the ultrasonic sensors 104 and the lidar sensors 114 that are oriented forwards. In this way, the object detection manager 1510 may use the machine function information to identify which of the ultrasonic sensors 104 and/or the lidar sensors 114 are relevant to object detection given the operation of the lift device 10.

In other embodiments, one of the lidar sensors 114 points downwards and is configured to measure a distance between the bottom of the platform 16 and the ground surface or the top of the frame assembly 12. In this case, the sensor limit manager 1508 can use the distance measured by the lidar sensor 114 to determine adjustments to the stop zones 90, the warning zones 92, and/or the warning zones 93.

The object detection manager 1510 is configured to receive the sensor limits from the sensor limit manager 1508 and the object detection data from the lidar sensors 114 and the ultrasonic sensors 104. The object detection manager 1510 uses the sensor limits and the object detection data to determine if any objects are within any of the stop zones 90, the warning zones 92, and/or the warning zones 93. The object detection manager 1510 is configured to output detected object data. The object detection data indicates whether or not an object is present in any of the stop zones 90, the warning zones 93, the warning zones 92, as well as a position, shape, size, etc., of the detected objects. The object detection manager 1510 can also determine if an object is within the warning range of the ultrasonic sensors 104 or if an object is at the minimum allowable distance relative to any of the ultrasonic sensors 104.

The memory 1506 also includes an alert system manager 1512. The alert system manager 1512 is configured to receive the detected object data from the object detection manager 1510 and provide alert signals to alert system 1516. The alert system manager 1512 receives the detected object data, and depending on whether or not the detected object data indicates the presence of an object within the stop zones 90, the warning zones 92, and the warning zones 93, outputs alert signals to the alert system 1516. For example, the alert system manager 1512 may receive the detected object data from the object detection manager 1510 indicating that an object is present within one of the warning zones 92. In response to receiving an indication that an object is within one of the warning zones 92, the alert system manager 1512 outputs alert signals to the alert system 1516 to cause the alert system 1516 to provide an appropriate alert to the operator. For example, in the case when an object is detected within one of the stop zones 90, the alert system manager 1512 may output alert signals to the alert system 1516 to cause the visual alert devices 1522 to provide a visual alert to the operator (e.g., a flashing light, a steady red light, etc.) and to cause the aural alert device(s) 1524 to provide an aural alert to the operator (e.g., a siren, intermittent beeping, a warning voice, etc.).

The alert system manager 1512 can cause the alert system 1516 to provide different alerts based on if an object is detected within one of the warning zones 92 or one of the warning zones 93, or if the object is detected within one of the stop zones 90. For example, if an object is detected within one of the warning zones 93 or one of the warning zones 92 (or a certain warning zone 93 or a certain warning zone 92), the alert system manager 1512 may cause the alert system 1516 to provide only a visual alert to the user via the visual alert devices 1522. However, if an object is detected at one of the stop zones 90, the alert system manager 1512 may cause the alert system 1516 to provide both a visual alert and an aural alert to the user via the visual alert device(s) 1522 and the aural alert device(s) 1524. In other embodiments, the alert system manager 1512 causes the alert system 1516 to provide different alerts based on a proximity between the detected object and any of the stop zones 90 (or between the detected object and the lift device 10). For example, the alert system manager 1512 may cause the alert system 1516 to provide only a visual alert via the visual alert device(s) 1522 is the detected object is at an outer bounds of the warning zones 93 or the warning zones 92, and both a visual and an aural alert if the detected object is near one of the stop zones 90 but within one of the warning zones 93 and/or one of the warning zones 92.

The alert system manager 1512 can also be configured to cause the alert system 1516 to display an approximate location of the detected object. For example, if an object is detected below the platform 16, the alert system manager 1512 may cause the alert system 1516 to display a visual alert (e.g., a message, a notification, a particular pattern of lights, etc.) indicating the that an object is below the platform. The alert system manager 1512 can also be configured to cause the alert system 1516 to display (via the visual alert device(s) and/or the aural alert device(s) 1524) an approximate distance between the detected object and the lift device 10 (e.g., a notification such as “WARNING: OBJECT WITHIN 20 FEET”).

In some embodiments, the alert system 1516 is integrated with the HMI 1520. For example, the HMI 1520 may include any or all of the visual alert device(s) 1522 (e.g., a screen, a display device, a user interface, etc.) or any or all of the aural alert device(s) 1518 (e.g., speakers, alarms, buzzers, etc.).

The alert system 1516 can also operate the visual alert device(s) 1522 and/or the aural alert device(s) 1524 to provide a directional alert. For example, some of the visual alert device(s) 1522 and/or the aural alert device(s) 1524 may be positioned at a front end of the lift device 10 (e.g., at a front end of the platform 16, first longitudinal end 124, etc.) while others of the visual alert device(s) 1522 and/or the aural alert device(s) 1524 are positioned at a rear end (e.g., second longitudinal end 126) of the lift device 10 (e.g., at the rear end of the platform 16). The controller 1500 can operate the visual alert device(s) 1522 and/or the aural alert device(s) 1524 to provide the directional alert. For example, if an object or obstacle is detected in a warning zone in front of the lift device 10, the controller 1500 (e.g., the alert system manager 1512) may operate the visual alert device(s) 1522 and/or the aural alert device(s) 1524 that are at the front end of the lift device 10 to provide a visual alert and/or an aural alert. Likewise, if the controller 1500 detects that an obstacle is rearwards of the lift device 10, the alert system manager 1512 may operate the visual alert device(s) 1522 and/or the aural alert device(s) 1524 at the rear end of the lift device 10 to provide their respective visual and/or aural alerts. The alert system manager 1512 may also use the machine function information to determine which of the visual alert device(s) 1522 and/or the aural alert device(s) 1524 should be operated. For example, if the machine function information indicates that the lift device 10 is travelling forwards and the controller 1500 determines that an object is present in the warning zone and/or the stop zone in front of the lift device 10, the alert system manager 1512 may operate the visual alert device(s) 1522 and/or the aural alert device(s) 1524 that are at the front end of the lift device 10 to provide their respective visual and/or aural alerts.

The memory 1506 includes a control signal generator 1514. The control signal generator 1514 is configured to receive the detected object data from the object detection manager 1510 as well as a user input from the HMI 1520. The control signal generator 1514 can also receive user inputs or information from a sensor or the primary driver 44 indicating a direction and speed of travel of the lift device 10 (e.g., 5 mph in the forward/positive y direction). The user input received from the HMI 1520 may be any of a command from the operator to extend the lift assembly 14 (e.g., raise the platform 16), retract the lift assembly 14 (e.g., lower the platform 16), drive the lift device 10 (e.g., along the longitudinal axis 33 in either direction), steer the lift device 10 (e.g., rotate the tractive assemblies 40), etc. The control signal generator 1514 is configured to receive the user inputs from the HMI 1520 and generate control signals for controllable elements 1518 of the lift device 10. The controllable elements 1518 may be any components of the lift device 10 that cause the lift device 10 to operate (e.g., that cause the lift assembly 14 to extend, retract, etc.). For example, the controllable elements 1518 may include any of the lift actuators 66, the primary driver 44, the pump 46, motors, engines, hydraulic valves, etc., of the lift device 10.

The control signal generator 1514 can restrict the operation of one or more of the controllable elements 1518 based on the detected object data received from the object detection manager 1510. For example, if the detected object data indicates that an object is detected within one of the stop zones 90, the control signal generator 1514 may restrict the lift device 10 from driving in the direction of the object. In another example, if an object is detected below the platform 16, the control signal generator 1514 may restrict the lift assembly 14 from being retracted (e.g., restrict the platform 16 from being lowered). In yet another example, if an object is detected above the platform 16 and is substantially at the minimum allowable distance relative to one of the ultrasonic sensors 104, the control signal generator 1514 may restrict extension of the lift assembly 14 (e.g., restrict the platform 16 from being raised/elevated). In yet another example, if an object is detected adjacent to the platform 16 within one of the stop zones 90, the control signal generator 1514 may restrict or limit the platform extension actuator 2600 from further extending the extendable deck 78 towards the obstacle.

The control signal generator 1514 can also be configured to restrict additional user inputs from being provided to the controllable elements 1518 if the user input would cause the lift device 10 to move or extend in a direction towards a detected obstacle. In some embodiments, the control signal generator 1514 only restricts additional user inputs if the detected object is at the minimum allowable distance relative to one of the ultrasonic sensors 104 or the detected object is at the transition between one of the stop zones 90 and one of the warning zones 92/93 and the user input would cause the detected object to be within one of the stop zones 90 or within the minimum allowable distance relative to one of the ultrasonic sensors 104. However, the control signal generator 1514 may still generate and send control signals to the controllable elements 1518 if the user input would cause the platform 16 and/or the lift device 10 to move away from the detected object.

The control signal generator 1514 can also use the direction of travel of the lift device 10 to determine if an alert should be provided to the user. For example, if an object is detected by ultrasonic sensor 104a in front of the lift device 10 (e.g., in front of the platform 16), but the direction of travel of the lift device 10 is in an opposite direction (e.g., away from the object such that the distance between the object and the lift device 10 is increasing), the control signal generator 1514 may determine that an alert should not be provided to the user. In another example, if the lift device 10 is travelling towards an obstacle (e.g., an obstacle is detected by ultrasonic sensor 104a in front of the lift device 10 and the lift device 10 is travelling in the forwards/positive y direction), the control signal generator 1514 may provide alert system manager 1512 with an indication that an alert should be provided to the user via the alert system 1516.

In some embodiments, the control signal generator 1514 ceases restricting certain user inputs (as described in greater detail above) in response to receiving an override command from the HMI 1520.

The object detection manager 1510 can be configured to monitor the extension of the extendable deck 78 using any of the techniques, methods, and functionality as described in greater detail above with reference to FIG. 8. For example, the object detection manager 1510 can receive the information from the lidar sensor 114a to determine the distance 802 (i.e., Δl). The object detection manager 1510 can provide the value of Δl to the control signal generator 1514.

The control signal generator 1514 receives the value of Δl and determines if the extendable deck 78 is extended (i.e., if Δl=0). If the extendable deck 78 is extended, the control signal generator 1514 may restrict one or more operations of the lift device 10. For example, if Δl>0, the control signal generator 1514 may restrict any of the extension of the lift assembly 14 (e.g., restrict the platform 16 from being elevated), the retraction of the lift assembly 14 (e.g., restrict the platform 16 from moving towards the ground), driving/steering of the lift device 10 (e.g., restrict the primary driver from causing the tractive assemblies 40 to rotate), until the extendable deck 78 is not extended (i.e., Δl is substantially equal to zero).

### Alert Process

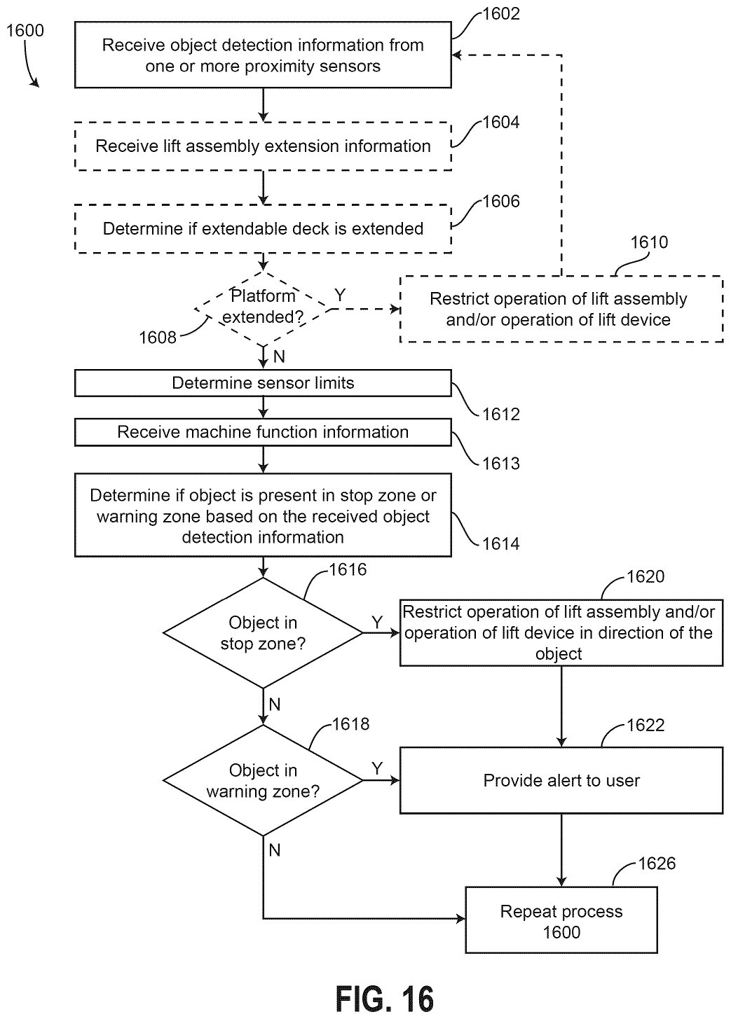

Referring now to FIG. 16, a process 1600 for detecting objects and alerting an operator of the detected object(s) is shown, according to an exemplary embodiment. Process 1600 includes steps 1602-1626. Process 1600 may be repeated throughout operation of the lift device 10.

Process 1600 includes receiving object detection information from one or more proximity sensors (step 1602). The one or more proximity sensors may be any of lidar sensors (e.g., lidar sensors 114), ultrasonic sensors (e.g., ultrasonic sensors 104), radar detection devices, laser rangefinders, sonar detection devices, etc., or any other proximity sensors positioned about the lift device 10. Step 1602 can be performed by the controller 1500 or any other computing device of the lift device 10.

Process 1600 includes receiving lift assembly extension information (step 1604). The lift assembly extension information may be received from one of the lidar sensors 114 (e.g., the lidar sensor 114a) and can indicate a distance between the lidar sensor 114 and a portion of the extendable deck 78 (e.g., protrusion 160) that moves relative to the lidar sensor 114 with extension of the extendable deck 78. Step 1604 may be performed by controller 1500. Specifically, step 1604 may be performed by the object detection manager 1510 of the controller 1500.

Process 1600 includes determining whether or not the extendable deck 78 is extended (steps 1606 and 1608). Determining whether or not the extendable deck 78 is extended can include determining whether or not the extendable deck 78 is fully retracted (i.e., Δl=0), if the extendable deck 78 is fully extended (i.e., Δl=lₘₐₓ) or if the extendable deck 78 is at a position between fully retracted and fully retracted (i.e., 0<Δl<lₘₐₓ). If the extendable deck 78 is fully retracted (i.e., Δl is substantially equal to 0, step 1608 “NO”), process 1600 proceeds to step 1612. If the extendable deck 78 is at least partially extended (i.e., Δl>0, step 1608 “YES”), process 1600 proceeds to step 1610. Steps 1606 and 1608 may be performed by the controller 1500. Specifically, steps 1606 and 1608 may be performed by the object detection manager 1510 and/or the control signal generator 1514 of the controller 1500.

If the extendable deck 78 is at least partially extended (or fully extended), one or more operations of the lift assembly 14 and/or one or more operations of the lift device 10 are restricted (step 1610). Step 1610 can include restricting the extension and the retraction of the lift assembly 14 (such that the platform 16 does not move upwards or downwards while the extendable deck 78 is extended), and/or restricting the lift device 10 from being driven. Step 1610 may be performed by controller 1500. Specifically, step 1610 can be performed by the control signal generator 1514. Step 1610 can include restricting all operations of the lift assembly 14 and/or all operation of the lift device 10 until the extendable deck 78 is fully retracted. Process 1600 returns to step 1602 in response to performing step 1610. Steps 1604-1610 may be optional steps.

If the extendable deck 78 is not extended (step 1608, “NO”), process 1600 proceeds to determining sensor limits (step 1612). Determining the sensor limits (step 1612) may include determining an area of the stop zones 90 for each of the lidar sensors 114, an area of the warning zones 92 for each of the lidar sensors 114, and an area of the warning zones 93 for each of the lidar sensors 114. The sensor limits may be determined based on information received from the lift assembly sensor 115 that indicates a degree of extension of the lift assembly 14. For example, the longitudinal width 142a can be determined based on the distance 304 between the ground and the bottom of the platform 16. Step 1612 can be performed by the controller 1500. Specifically, step 1612 can be performed by the sensor limit manager 1508 of the controller 1500. Step 1612 may include determining (or retrieving) minimum allowable distances for each of the ultrasonic sensors 104 and/or warning ranges for each of the ultrasonic sensors 104.

Process 1600 includes receiving machine function information (step 1613), according to some embodiments. The machine function information can be a currently performed operation (e.g., a current driving operation such as forwards or rearwards motion, a current steering operation indicating a direction of travel of the lift device 10, a current operation of the lift assembly 14 such a raising or lowering the lift assembly 14, etc.). The machine function information can be used to determine which of the object detection information should be evaluated to detect the presence of obstacles surrounding the lift device 10. For example, if the machine function information indicates that the lift device 10 is driving forwards, the controller 1500 can evaluate the object detection information received from proximity sensors that face forwards (e.g., in a direction of travel of the lift device 10).

Process 1600 includes determining if an object is in any of the stop zones 90 or in any of the warning zones 92, or in any of the warning zones 93 (step 1614). Step 1616 can be performed based on the object detection information from any of the proximity sensors (e.g., the lidar sensors 114, the ultrasonic sensors 104) received in step 1602 and the sensor limits determined in step 1612 (e.g., the defined area of each of the stop zones 90, each of the warning zones 92, and each of the warning zones 93). Step 1614 can be performed by controller 1500. Specifically, step 1614 can be performed by object detection manager 1510. In some embodiments, step 1614 includes determining if an object is present in a stop zone or a warning zone based on the received object detection information and/or based on the machine function information. For example, if the lift assembly 14 is being raised, the controller 1500 may evaluate the object detection information received from proximity sensors that are above the lift device 10. Likewise, if the lift assembly 14 is being lowered, the controller 1500 may evaluate the object detection information received from proximity sensors that detect objects/obstacles below the lift device 10 (e.g., below the platform 16).

Process 1600 includes determining if an object is in any of the stop zones 90 (step 1616) or if an object is in any of the warning zones 92/93 (step 1618). Step 1616 can include determining if an object is at a transition between a stop zone 90 and an adjacent warning zone 92 or an adjacent warning zone 93. If an object is within one of the stop zones 90 or is at the transition between one of the stop zones 90 and the adjacent warning zones 93 or is at the transition between one of the stop zones and the adjacent warning zone 92 (step 1616 “YES”), process 1600 proceeds to step 1620. If an object is within one of the warning zones 92 or within one of the warning zones 93 (step 1618 “YES”), process 1600 proceeds to step 1622. Steps 1616 and 1618 may be performed concurrently. Steps 1616 and 1618 may be performed by the object detection manager 1510. Process 1600 proceeds to step 1626 in response to performing step 1618 (i.e., in response to “NO” for step 1618).

Process 1600 includes restricting one or more operations of the lift assembly 14 and/or one or more operations of the lift device 10 (step 1620) in response to determining that an object is in one of the stop zones 90 or at a transition between one of the stop zones 90 and an adjacent warning zone 92/93 (step 1616 “YES”). Step 1620 can include restricting the lift assembly 14 and/or the lift device 10 from moving in the direction of the detected object. However, the lift assembly 14 and/or the lift device 10 can still operate to move away from the detected object, according to some embodiments. Step 1620 can be performed by the control signal generator 1514 and the controllable elements 1518. Process 1600 proceeds to step 1622 in response to performing step 1620. Step 1622 and step 1620 may be performed concurrently with each other.

Process 1600 includes providing an alert to a user (step 1622) in response to determining that an object is present in one of the stop zones 90 (step 1616, “YES”) or in response to determining that an object is present in any of the warning zones 92/93 (step 1618, “YES”). The alert provided to the user may be any of a visual alert, an aural alert, or a combination of both. The alert may be provided to the user via the alert system 1516. More specifically, the visual alert may be provided to the user via visual alert device(s) 1522, and the aural alert can be provided to the user via aural alert device(s) 1524. The type of visual and/or the type of aural alert can be provided based on a distance between the detected object and any of the lift assembly 14, the platform 16, and the frame assembly 12. For example, if an object is detected at the transition between one of the stop zones 90 and an adjacent one of the warning zones 92/93, the alert provided to the user may be both a visual and an aural alert. In another example, if an object is detected within one of the warning zones 92/93 but is not at the transition between the stop zone 90 and the adjacent warning zones 92/93, the alert provided to the user may be only a visual alert or only an aural alert. Process 1600 proceeds to step 1626 in response to performing step 1622.

Process 1600 can be repeated (step 1626) over an entire duration of the operation of the lift device 10. Any of steps 1602-1626 may be performed concurrently with each other. Process 1600 can be performed in real-time to provide real time alerts to the user during operation of the lift device 10.

### Obstacle Detection System for Aviation

### Scissor Lift

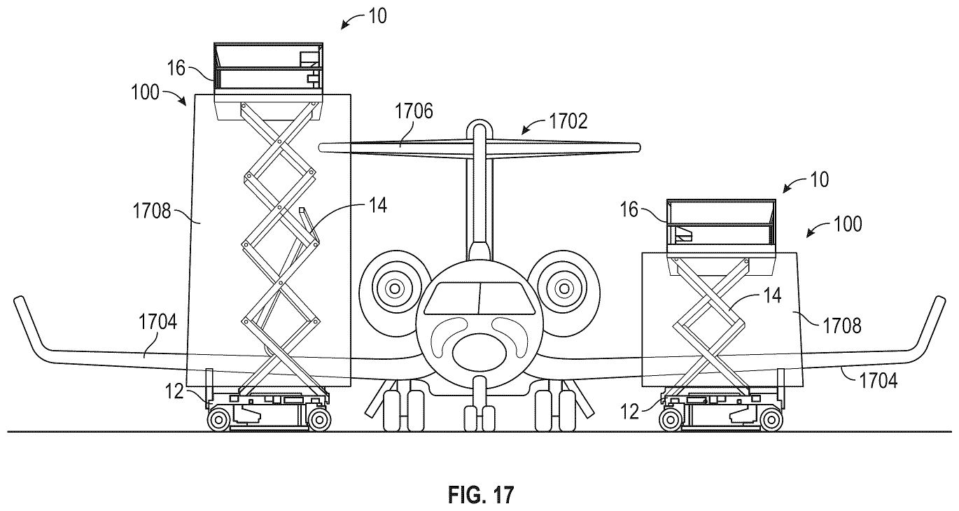

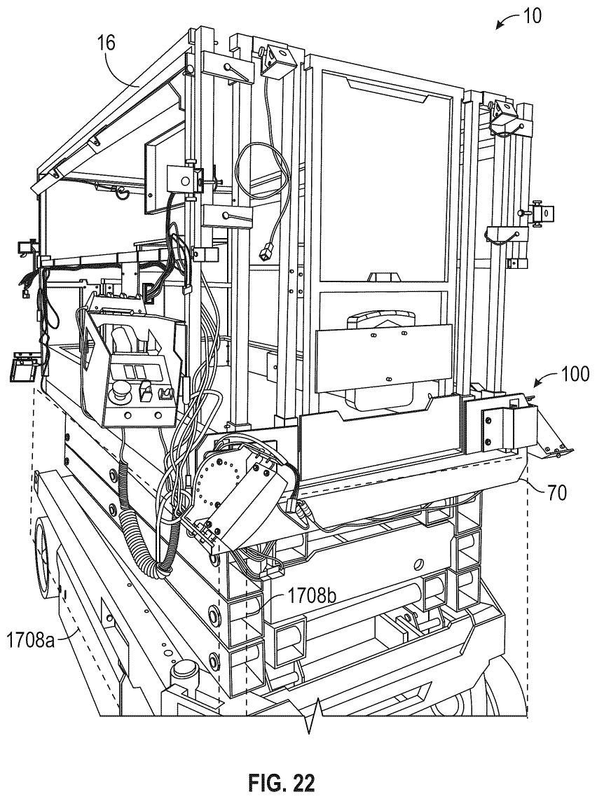

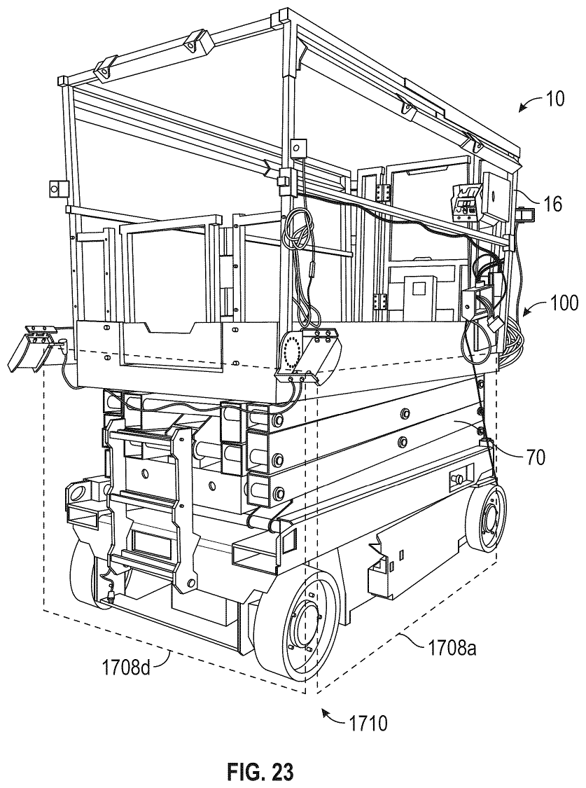

Referring to FIGS. 17-23, the obstacle detection system 100 may be a lidar-system that includes four lidar sensors 114 positioned at corners of the deck 70 in order to define one or more detection zones 1708 (e.g., areas) that are positioned below the deck 70. The lidar sensors 114 are configured to monitor presence and/or proximity of objects in the detection zones 1708 (e.g., below the deck 70). In some embodiments, the zones 1708 have adjustable height and/or width as a function of extension or retraction of the lift assembly 14. The zones 1708 can be similar to the scan areas 84 and may include both warning and alert zones or sections.

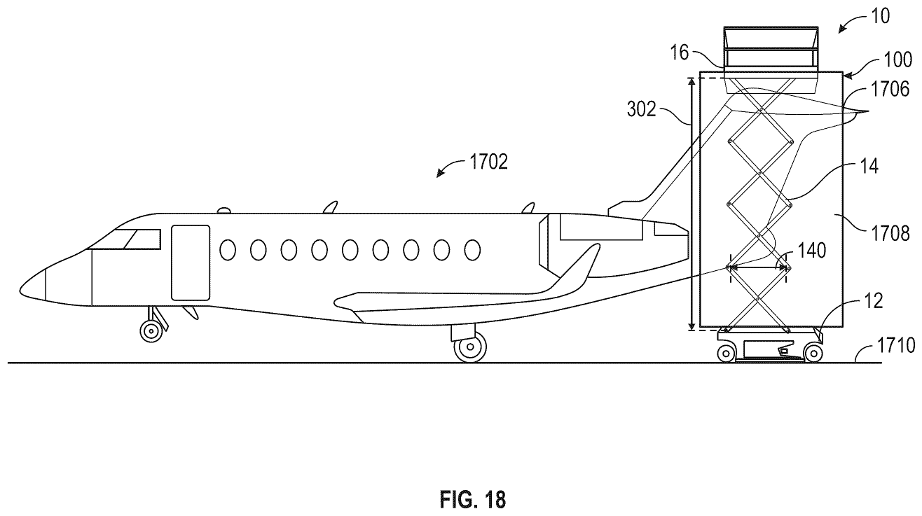

Referring to FIGS. 17-18, the lidar sensors 114 are configured to detect the presence of objects and/or proximity of objects in the detection zones 1708 (e.g., below the deck 70) such as wings 1704 or tail wings 1706 of an aircraft 1702. As the lift device 10 is operated to elevate the platform 16, the current longitudinal width 140 may increase or decrease as the platform 16 is moved upwards or downwards. The detection zones 1708 are configured to cover an area below the platform 16 and the lift assembly 14 so that the obstacle detection system 100 can detect the presence and proximity of the tail wing 1706 and/or the wing 1704. In some embodiments, the lift device 10 may be used to work proximate the tail wings 1706 or the wings 1704 and the obstacle detection system 100 can predict or estimate when operation of the lift assembly 14 and/or transportation of the lift device 10 will cause the lift assembly 14 and/or the platform 16 to contact or hit the tail wings 1706 or the wings 1704. For example, as the platform 16 is lowered, the lift assembly 14 may increase in width and may abut or contact the tail wings 1706 (e.g., if the operator uses the lift device 10 incorrectly and/or if the obstacle detection system 100 is not implemented). Advantageously, the obstacle detection system 100 facilitates reducing or limiting a likelihood of the lift device 10 contacting an obstacle (e.g., the tail wings 1706 and/or the wings 1704 of the aircraft 1702) during maintenance operations.

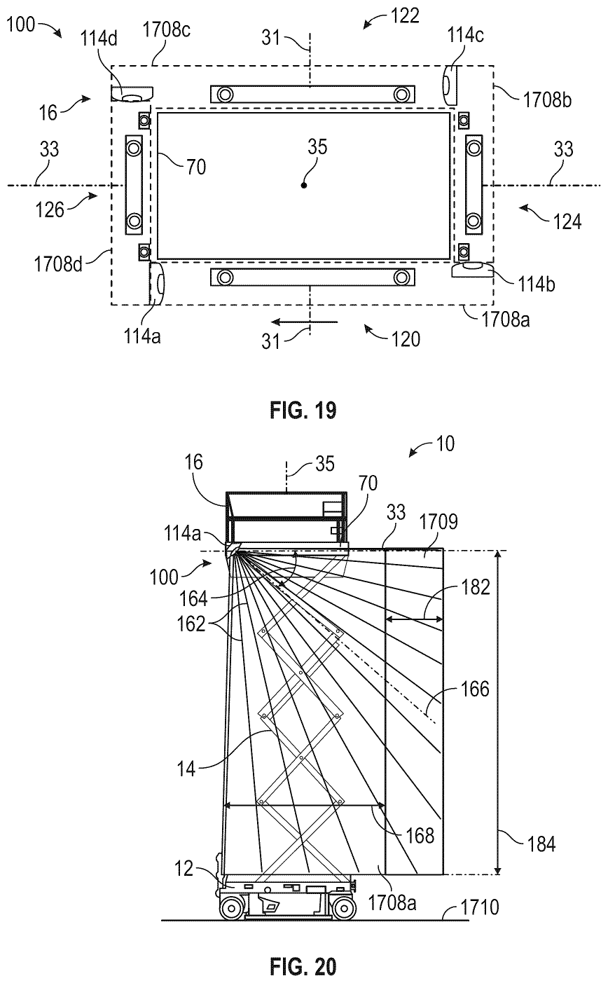

Referring particularly to FIG. 19, the obstacle detection system 100 includes the lidar sensor 114a positioned at a first corner of the deck 70, the lidar sensor 114b positioned at a second corner of the deck 70, the lidar sensor 114c positioned at a third corner of the deck 70, and the lidar sensor 114d positioned at a fourth corner of the deck 70. The lidar sensor 114a is configured to emit multiple sensing segments (e.g., lidar signals along 16 different paths) and is configured to monitor or detect obstacles below the platform 16. In some embodiments, the first lidar sensor 114a is pointed in an at least partially downwards direction and is configured to define or detect obstacles in a first detection zone 1708a on a first side of the deck 70. Similarly, the second lidar sensor 114b is pointed in an at least partially downwards direction and is configured to define or detect obstacles in a second detection zone 1708b on a second side of the deck 70. The third lidar sensor 114c is configured to define or detect obstacles in a third detection zone 1708c. The fourth lidar sensor 114d is configured to define or detect obstacles in a fourth detection zone 1708d. In this way, the lidar sensors 114 are each configured to define a detection zone on one of the four sides of the deck 70.

The first lidar sensor 114a may be positioned on the first lateral side 120 of the deck 70 at the corner between the first lateral side 120 and the second longitudinal end 126. The first lidar sensor 114a emits pulsed lasers (i) in a substantially horizontal or longitudinal direction from the second longitudinal end 126 to the first longitudinal end 124, (ii) in multiple directions that extend at least partially downwards and partially from the second longitudinal end 126 to the first longitudinal end 124, and (iii) in a direction substantially downwards (e.g., in a vertical downwards direction).

The second lidar sensor 114b may be positioned on the first longitudinal end 124 of the deck 70 at the corner between the first lateral side 120 and the first longitudinal end 124. The second lidar sensor 114b emits pulsed lasers (i) in a substantially horizontal or lateral direction from the first lateral side 120 to the second lateral side 122, (ii) in multiple directions that extend at least partially downwards and partially from the first lateral side 120 to the second lateral side 122, and (iii) in a direction substantially downwards (e.g., in a vertical downwards direction).

The third lidar sensor 114c may be positioned on the second lateral side 122 of the deck 70 at the corner between the first longitudinal end 124 and the second lateral side 122. The third lidar sensor 114c emits pulsed lasers (i) in a substantially horizontal or longitudinal direction from the first longitudinal end 124 to the second longitudinal end 126, (ii) in multiple directions that extend at least partially downwards and partially from the first longitudinal end 124 to the second longitudinal end 126, and (iii) in a direction substantially downwards (e.g., in a vertical downwards direction).

The fourth lidar sensor 114d may be positioned on the second longitudinal end 126 of the deck 70 at the corner between the second lateral side 122 and the second longitudinal end 126. The fourth lidar sensor 114d emits pulsed lasers (i) in a substantially horizontal or longitudinal direction from the second longitudinal end 126 to the first longitudinal end 124, (ii) in multiple directions that extend at least partially downwards and partially from the second lateral side 122 to the first lateral side 120, and (iii) in a direction substantially downwards (e.g., in a vertical downwards direction).

Referring to FIG. 20, the first lidar sensor 114a is shown oriented at an angle 164 relative to the longitudinal axis 33 such that the first lidar sensor 114a points partially downwards (e.g., at a downwards angle). The angle 164 is shown measured between an axis 166 that extends normally from the first lidar sensor 114a and the longitudinal axis 33. The first lidar sensor 114a is configured to emit pulsed lasers along 16 different trajectories, shown as sensing segments 162. In some embodiments, the first detection zone 1708a is a subset of a scan area of the first lidar sensor 114a. The lidar sensor 114a may also detect obstacles or objects in a warning zone 1709. The first detection zone 1708a can have a width 168 that is less than an overall width of the scan area. The second lidar sensor 114b may be similarly oriented as the first lidar sensor 114a relative to the lateral axis 31. The third lidar sensor 114c may be oriented and positioned in a mirror or reverse symmetrical manner as the first lidar sensor 114a (e.g., mirrored about a plane defined by the vertical axis 35 and the lateral axis 31 and positioned on the second lateral side 122 at the corner between the second lateral side 122 and the first longitudinal end 124). The fourth lidar sensor 114d may be oriented and positioned in a mirror or reverse symmetrical manner as the second lidar sensor 114b (e.g., mirrored about a plane defined by the vertical axis 35 and the longitudinal axis 33 and positioned on the second longitudinal end 126 at the corner between the second longitudinal end 126 and the second lateral side 122).

Referring still to FIG. 20, the warning zone 1709 may be longitudinally positioned in front of the first detection zone 1708a. In some embodiments, the warning zone 1709 has a width 182 that is less than the width 168 of the first detection zone 1708a. In some embodiments, the warning zone 1709 is configured to detect objects in front of the lift device 10 so that when the lift device 10 performs driving operations, the obstacle detection system 100 can detect the presence of obstacles or objects proximate the lift device 10 before the objects or obstacles enter the first detection zone 1708a. In some embodiments, the third lidar sensor 114c similarly defines the third detection zone 1708c and a warning zone in front of the third detection zone 1708c (e.g., to detect obstacles or objects rearwards of the lift device 10 such as when the lift device 10 performs a reverse driving operation). In some embodiments, the width 182 of the detection zone 1709 is 12 inches. In some embodiments, the width 168 of the first detection zone 1708a is 24 inches. It should be understood that any of the lidar sensors 114 can include or define sensing zones similarly to the lidar sensor 114a (e.g., a detection zone or region, and a warning zone or region).

Referring still to FIG. 20, the detection zone 1709 and the first detection zone 1708a both have a height 184. The height 184 may be adjustable (e.g., by the controller 1500) as a function of the degree of extension or retraction of the lift assembly 14. In some embodiments, the height 184 is adjusted so that the obstacle detection system 100 does not inadvertently detect a floor surface 1710 upon which the lift device 10 rests (e.g., reduces false alarms). In some embodiments, the heights and widths of each of the detection zones 1708 and/or the warning zones 1709 are independently programmable or adjustable by the controller 1500 (e.g., based on control of the lift device 10).

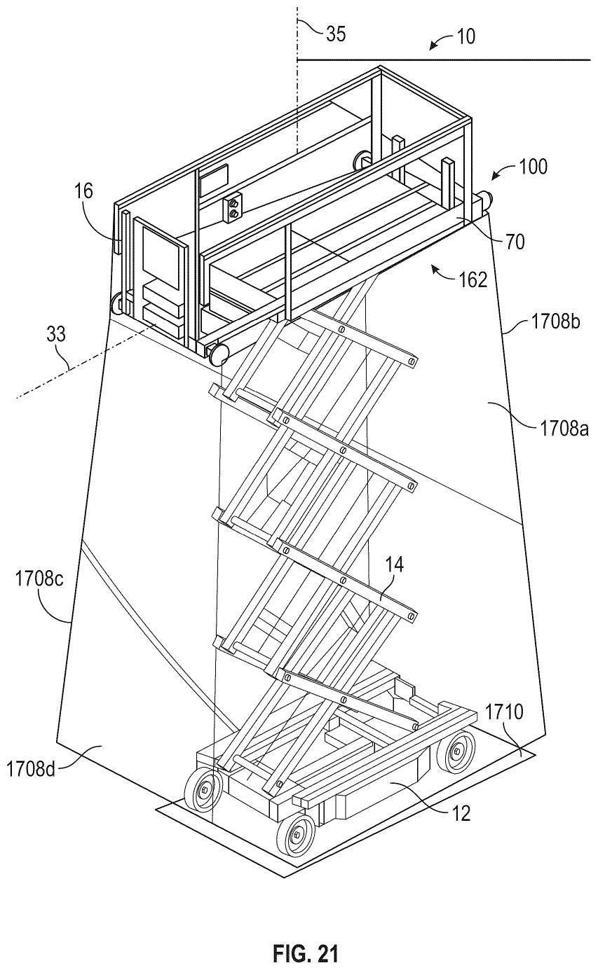

Referring to FIGS. 21-23, the lift device 10 and the obstacle detection system 100 are shown. The detection zones 1708 extend or project downwards from each of the four sides of the deck 70 and are configured to facilitate detection of obstacles below the deck 70. The embodiments of the detection system 100 as described herein with reference to FIGS. 17-23 may be used in combination with any portions or detectors of the obstacle detection system 100 as described in greater detail above with reference to FIGS. 1-16.

Advantageously, the configuration of the obstacle detection system 100 described with reference to FIGS. 17-23 can be used in aviation or aerospace industries that require scissor lifts to manufacture and maintain high end aircrafts. The lidar sensors 114a, 114b, 114c, and 114d are positioned on the corners of the deck 70 to facilitate reducing undesired collision of the lift device 10 with an obstacle. In particular, the obstacle detection system 100 facilitates reducing collision of protruding members of the lift device 10 such as the arm-stack (e.g., members of the lift assembly 14) or the deck 70.

In some embodiments, the obstacle detection system 100 described herein with reference to FIGS. 17-23 provides a sensing package that protects extruding members, has a variable sensing envelope that is dynamic and can adapt to movement of the lift device 10, and facilitates operating the lift device 10 to position an operator or worker within a distance of approximately six inches of a work area, while avoiding collisions between the lift device 10 and obstacles or objects in the environment. In some embodiments, the obstacle detection system 100 provides a thin sensing zone and does not detect a side of the lift assembly 14. The obstacle detection system 100 also provides long-range sensing zones that may detect objects with a minimum of 100 square inches of surface area and 10% reflectivity at a minimum of 26 feet away. The obstacle detection system 100 facilitates splitting sensing zones into sections and programming the sections individually which may be advantageous for unique features of an aircraft. In some embodiments, a height or width of the zones 1708, sections, or sub-sections of the zones 1708 are adjustable so that the controller 1500 does not detect a floor surface as an obstacle, thereby causing nuisance trips for the operator of the lift device 10.

Referring again to FIG. 15, the controller 1500 may obtain degree of extension data from the lift assembly sensor 115 and the object detection data from the lidar sensors 114 (e.g., the first lidar sensor 114a, the second lidar sensor 114b, the third lidar sensor 114c, and the fourth lidar sensor 114d). In embodiments or configurations of the obstacle detection system 100 where the obstacle detection system 100 does not include the ultrasonic sensors 104, the controller 1500 solely or primarily uses the object detection data provided by the lidar sensors 114. In some embodiments, the controller 1500 is configured to adjust the height 184 of any of the detection zones 1708 or warning zones 1709 based on the degree of extension data provided by the lift sensor assembly 115. In some embodiments, the controller 1500 is configured to perform any of the functionality or techniques described in greater detail above with reference to FIG. 15 to provide different levels of alert (or limit operation of the lift device 10) to reduce a likelihood of a collision occurring.

### Boom Lift

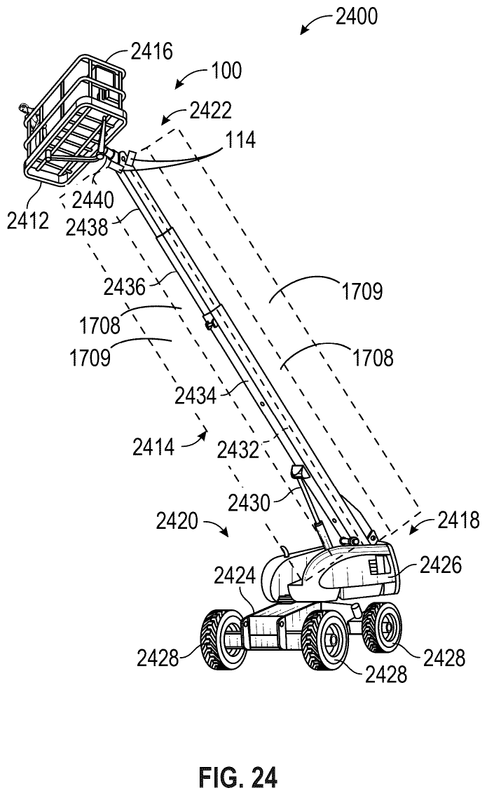

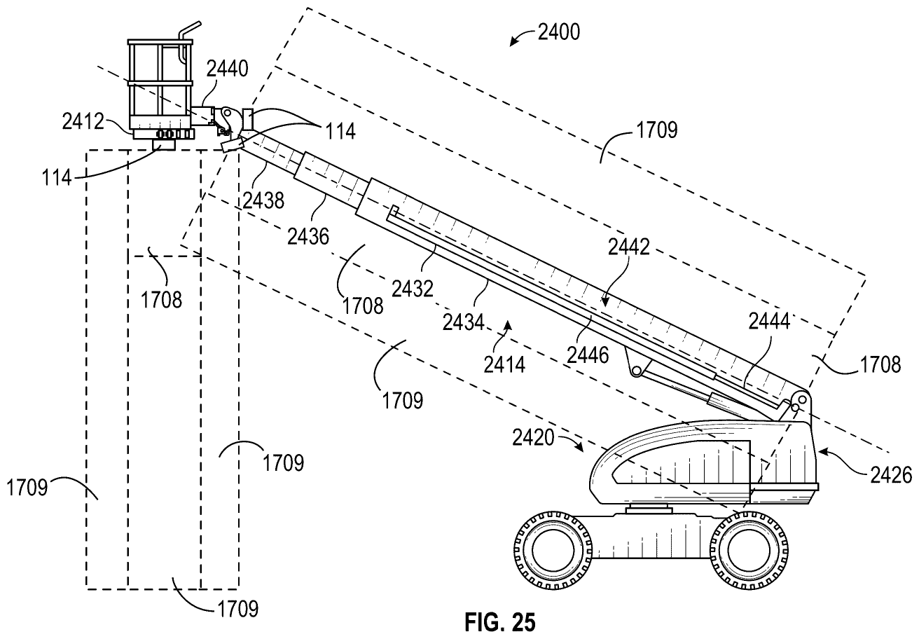

Referring to FIGS. 24-25, the obstacle detection system 100 may be installed on and used on a lift device (e.g., an aerial work platform, a telehandler, etc.), shown as lift device 2400. The lift device 2400 includes a chassis or ground console, shown as chassis 2420, and a work implement (e.g., a work platform, forks, a bucket, etc.), shown as platform 2412. The platform 2412 is coupled to the chassis 2420 by a boom assembly, shown as boom 2414. According to an exemplary embodiment, platform 2412 supports one or more workers. In some embodiments, the lift device 2400 includes an accessory or tool, shown as welder 2416, coupled to the platform 2412 for use by the worker. In other embodiments, the platform 2412 is equipped with other tools for use by a worker, including pneumatic tools (e.g., impact wrench airbrush, nail guns, ratchets, etc.), plasma cutters, and spotlights, among other alternatives. In other embodiments, the lift device 2400 includes a different work implement coupled to the boom 2414 (e.g., a saw, drill, jackhammer, lift forks, etc.) in place of or addition to the platform 2412. Accordingly, the lift device 2400 may be configured as a different type of lift device, such as a telehandler, a vertical lift, etc.

The boom 2414 has a first or proximal end 2418 pivotally coupled to the chassis 2420 and a second or distal end 2422 opposite the proximal end 2418. The distal end 2422 is pivotally coupled to the platform 2412. By pivoting the boom 2414 at the proximal end 2418, the platform 2412 may be elevated or lowered to a height above or below a portion of the chassis 2420. The boom 2414 has a plurality of telescoping segments that allow the distal end 2422 and the platform 2412 to be moved closer to or away from the proximal end 2418 and the chassis 2420.

As shown in FIG. 24, the chassis 2420 includes a chassis, base, or frame, shown as base frame 2424. The base frame 2424 is coupled to a turntable 2426. According to exemplary embodiment, the proximal end 2418 of the boom 2414 is pivotally coupled to the turntable 2426. According to an alternative embodiment, the chassis 2420 does not include a turntable 2426 and the boom 2414 is coupled directly to the base frame 2424 (e.g., the boom 2414 may be provided as part of a telehandler). According to still another alternative embodiment, the boom 2414 is incorporated as part of an articulating boom lift that includes multiple sections coupled to one another (e.g., a base section coupled to the chassis 2420, an upper section coupled to the platform 2412, and one or more intermediate sections coupling the base section to the upper section, etc.).

As shown in FIGS. 24 and 25, the lift device 2400 is mobile and the base frame 2424 includes tractive elements, shown as wheel and tire assemblies 2428. The wheel and tire assemblies 2428 may be driven using a prime mover and steered to maneuver the lift device 2400. In other embodiments, the base frame 2424 includes other devices to propel or steer the lift device 2400 (e.g., tracks). In still other embodiments, the lift device 2400 is a trailer that is towed by another vehicle, and the base frame 2424 includes one or more wheels or elements configured to support the lift device 2400. In still other embodiments, the lift device 2400 is a stationary device and the base frame 2424 lacks any wheels or other elements to facilitate the movement of the lift device 2400 and may instead include legs or other similar structures that facilitate stationary support of the lift device 2400.

The turntable 2426 is coupled to the base frame 2424 such that the turntable 2426 may be rotated relative to the base frame 2424 about a vertical axis of rotation (e.g., by a motor). According to an exemplary embodiment, the chassis 2420 houses one or more pumps and/or motors that power one or more functions of the lift device 2400 (e.g., extension and/or movement of the boom 2414 and the platform 2412, rotation of the turntable 2426, rotation of the wheel and tire assemblies 2428, etc.). The pumps and/or motors may drive the movement directly, or may provide electrical energy or pressurized hydraulic fluid to another actuator. The lift device 2400 may include an onboard engine (e.g., a gasoline or diesel engine), may receive electrical energy from an external source through a tether (e.g., a cable, a cord, etc.), may include an on-board generator set to provide electrical energy, may include a hydraulic pump coupled to a motor (e.g., an electric motor, an internal combustion engine, etc.), and/or may include an energy storage device (e.g., battery).

According to an exemplary embodiment, the turntable 2426 includes an internal structure (e.g., one or more bosses coupled to a pin, etc.) configured to support the boom 2414. The internal structure may interface with the proximal end 2418 of the boom 2414 to pivotally couple the boom 2414 to the chassis 2420. A lift actuator, shown as hydraulic cylinder 2430, is coupled between the turntable 2426 and the boom 2414. According to an exemplary embodiment, the hydraulic cylinder 2430 extends or retracts to raise or lower the boom 2414 (e.g., to rotate the distal end 2422 of the boom 2414 relative to the turntable 2426). In other embodiments, the hydraulic cylinder is replaced with or additionally includes another type of actuator (e.g., an electric motor, a lead screw, a ball screw, an electric linear actuator, a pneumatic cylinder, etc.).

According to an exemplary embodiment, the boom 2414 is a telescoping boom including a series of segments or sections that are configured to translate relative to one another along a longitudinal axis 2432. The longitudinal axis 2432 extends along the length of the boom 2414 between the proximal end 2418 and the distal end 2422. As shown in FIG. 1, the boom 2414 includes three sections: a first or base boom section 2434, a second, middle, or intermediate boom section 2436, and a third, upper, or fly boom section 2438. The base boom section 2434 is the most proximal section, and the fly boom section 2438 is the most distal section, with the intermediate boom section 2436 extending between and coupling the base boom section 2434 and fly boom section 2438. The base boom section 2434 is coupled to the turntable 2426 and the fly boom section 2438 is coupled to the platform 2412.

According to an exemplary embodiment, the base boom section 2434, the intermediate boom section 2436, and the fly boom section 2438 have tubular cross sectional shapes (e.g., to facilitate receiving boom sections within one another). The base boom section 2434, the intermediate boom section 2436, and the fly boom section 2438 may have a variety of cross sectional shapes (e.g., hexagonal, round, square, pentagonal, etc.). While the embodiment shown in FIGS. 24 and 25 has three boom segments, in other embodiments, the boom 2414 includes more or fewer segments. As shown in FIGS. 24 and 25, the boom 2414 further includes a linkage, shown as connecting linkage 2440, which couples the platform 2412 to the fly boom section 2438. According to an exemplary embodiment, the connecting linkage 2440 includes a rotator (e.g., a rotating joint or motor, a hydraulic cylinder, etc.) that drives relative rotation between the boom 2414 and the platform 2412. According to an exemplary embodiment, the connecting linkage 2440 includes a jib (e.g., a four bar linkage) that facilitates translation between the boom 2414 and the platform 2412. According to an exemplary embodiment, the connecting linkage 2440 includes both a rotator and a jib. Such connecting linkages 2440 may facilitate the platform 2412 remaining level as the boom 2414 is raised or lowered. The connecting linkage 2440 may be controlled by a self-leveling system including a slave cylinder (e.g., the slave cylinder may operate based on the position of the hydraulic cylinder 2430). In other embodiments, movement of the connecting linkage 2440 is otherwise controlled (e.g., by manual or computer control of a hydraulic or electric actuator (e.g., a cylinder, a motor, etc.).

Referring still to the exemplary embodiment shown in FIG. 25, the base boom section 2434, the intermediate boom section 2436, and the fly boom section 2438 move relative to each other along the longitudinal axis 2432 as the boom 2414 extends or retracts. In one embodiment, with the base boom section 2434 held stationary, the intermediate boom section 2436 moves at a constant rate relative to the base boom section 2434 and the fly boom section 2438 moves at a constant rate relative to the intermediate boom section 2436 (i.e. the relative movement occurs at a fixed ratio). The lift device 2400 includes an actuator, shown as cylinder 2442. In some embodiments, the cylinder 2442 is positioned within the boom 2414 to extend or retract the boom 2414. The cylinder 2442 may include a rod 2444 and an outer barrel 2446. The cylinder 2442 extends along the length of the boom 2414 and extends through the end of the intermediate boom section 2436. In other embodiments, one or more actuators are otherwise arranged to control relative movement of the sections of the boom 2414. One or more sections of the boom 2414 may be coupled to one another through one or more tensile members (e.g., cables) and/or pulleys to control relative motion between the sections. In other embodiments, the boom 2414 includes one or more boom sections that do not telescope relative to one another.

Referring particularly to FIGS. 24 and 25, the obstacle detection system 100 includes the lidar sensors 114 positioned such that the lidar sensors 114 define detection zones surrounding the boom 2414. In the case of a boom lift as shown in FIGS. 24 and 25, the protruding member to be monitored for proximate obstacle detection are is the boom 2414. In some embodiments, one or more lidar sensors 114 are positioned at a distal or free end of the fly boom section 2438 (e.g., proximate the connecting linkage 2440). In some embodiments, the lidar sensors 114 are positioned on the connecting linkage 2440 and are configured to define or establish the detection zones 1708 on one or more sides of the boom 2414, and the warning zones 1709. The obstacle detection system 100 can also include one or more lidar sensors 114 positioned on a bottom of the platform 2412 and configured to define or establish detection zone 1708 and warning zones 1709 below the platform 2412. In some embodiments, a height and/or width of the detection zones 1708 that extend along or proximate the boom 2414 or at the platform 2412 are adjustable (e.g., by the controller 1500) based on control decisions of the boom 2414 (e.g., angle or position of the boom 2414, extension of the boom 2414, etc.). Advantageously, the obstacle detection system 100 may be configured to detect areas surrounding the boom 2414 to limit or reduce a likelihood that the boom 2414 will collide with an obstacle (e.g., by warning the operator or limiting operation of the boom 2414).

### Door Arrangement

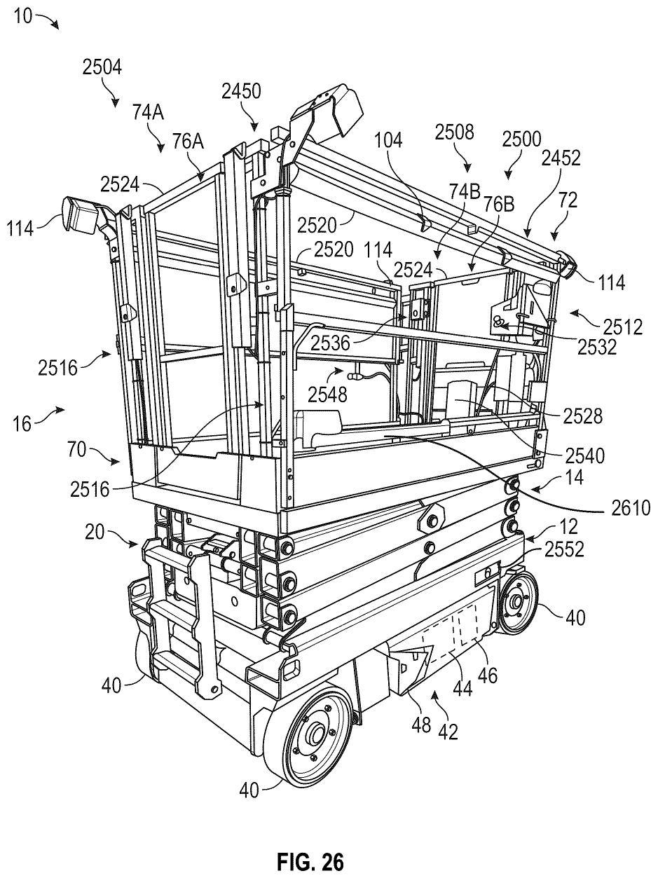

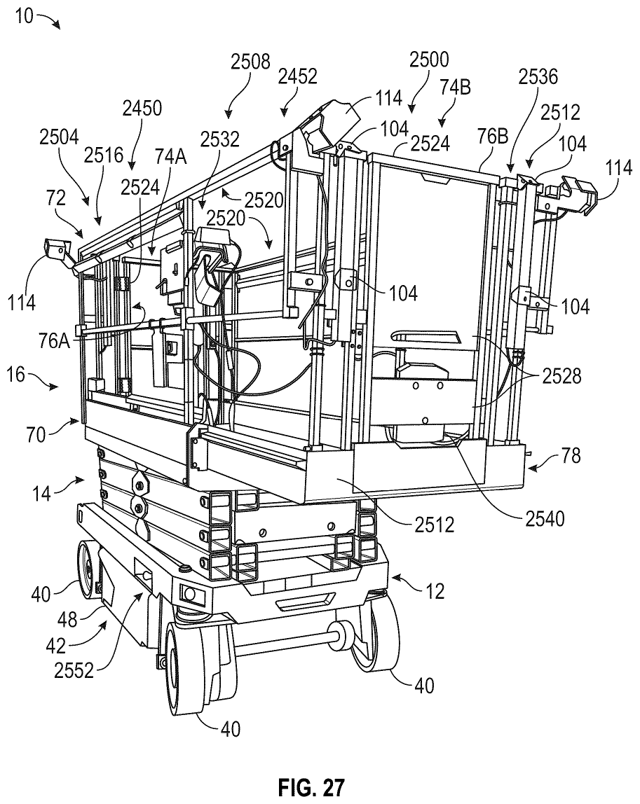

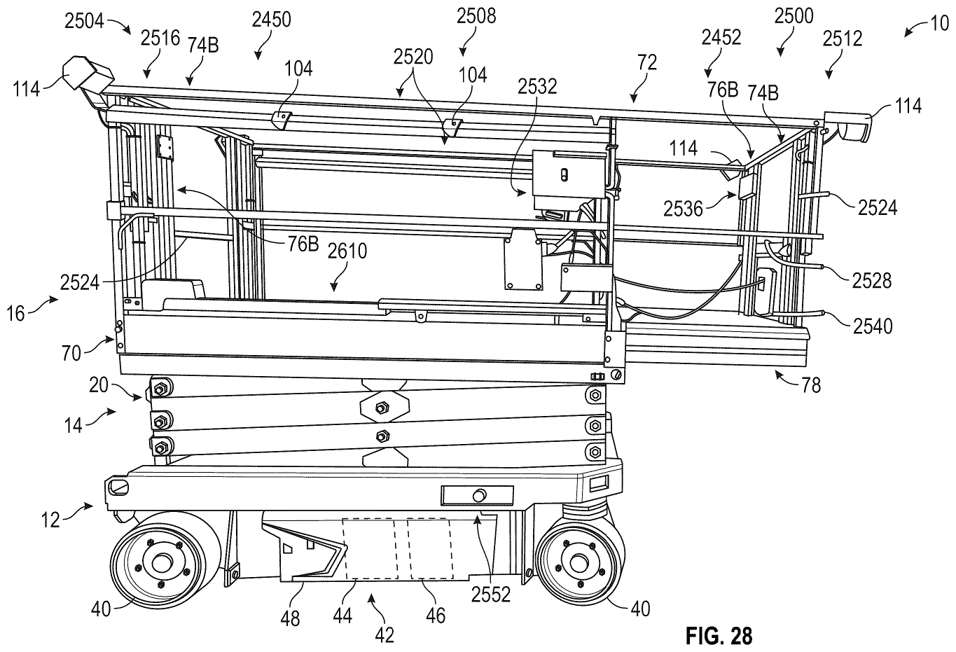

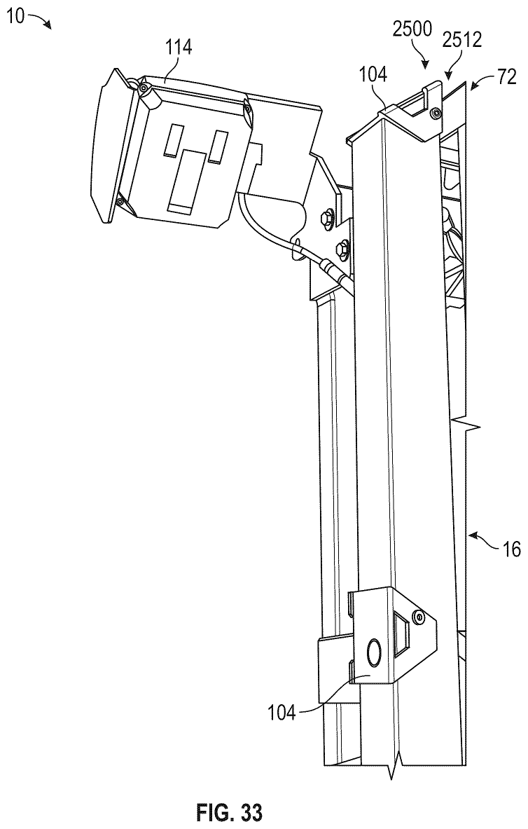

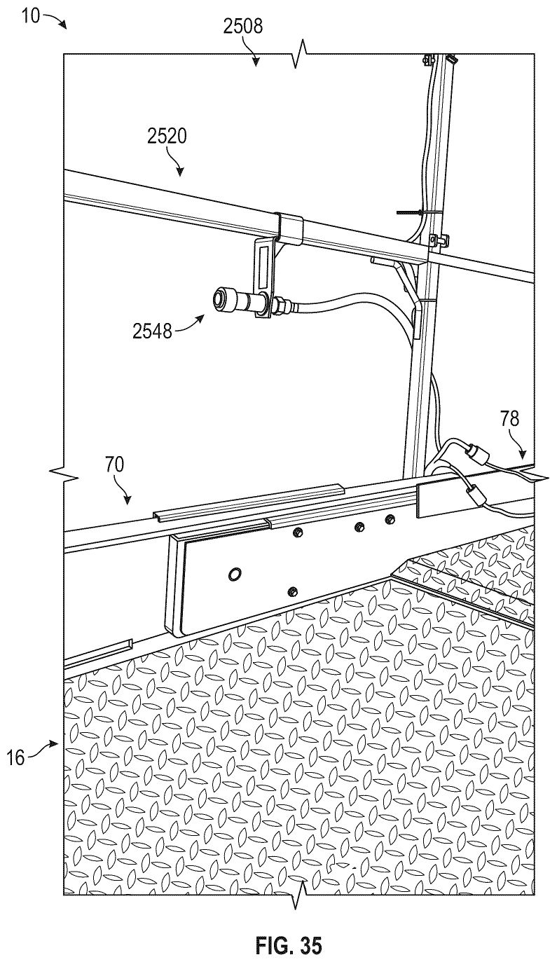

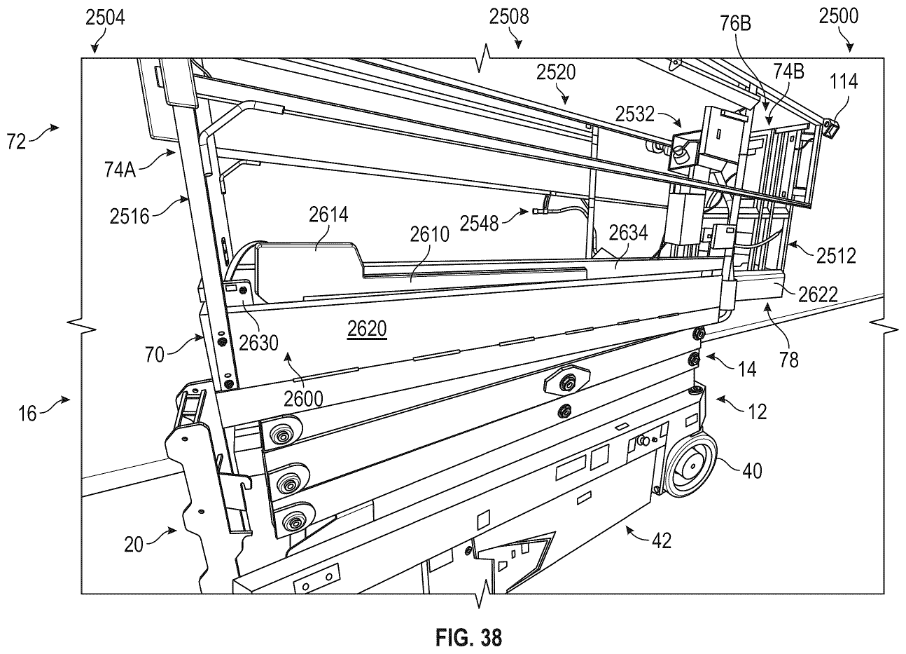

Referring generally to FIGS. 26-39, the lift device 10 is shown according to an exemplary embodiment. As shown, the lift device 10 of FIGS. 26-39 is a scissor lift. In other embodiments, the lift device 10 is another type of lift device (e.g., a scissor lift, an aerial work platform, a boom lift, a telehandler, ground service equipment including cargo loaders, food and beverage vehicles, deicers, etc.). The lift device 10 of FIGS. 26-39 may be substantially similar to the lift device 10 of FIGS. 1-10 and 17-23 except as otherwise specified herein.

As shown, the platform 16 of the lift device 10 includes an extendable deck 78 that is extendable longitudinally (e.g., longitudinally repositionable) relative to the deck 70. A first subset of the guard rails 72, shown as stationary rails 2450, are coupled to the deck 70, and a second subset of the guard rails 72, shown as extendable rails 2452, are coupled to the extendable deck 78. A first opening 74A is defined between the stationary rails 2450 and the deck 70. A first door 76A is coupled to the stationary rails 2450 and matches the height and width of the first opening 74A. A second opening 74B is defined between the extendable rails 2452 and the extendable deck 78. A second door 76B is coupled to the extendable rails 2452 and matches the height and width of the second opening 74B. In some embodiments, the first opening 74A and the second opening 74B have substantially similar dimensions such that the first door 76A and the second door 76B are a substantially similar height and width.

The deck 70, the stationary rails 2450, and the first door 76A may be considered a fixed or stationary portion of the platform 16. The extendable deck 78, the extendable rails 2452, and the second door 76B may be considered an extendable portion of the platform 16. The extendable portion is slidably coupled to the fixed portion, such that the extendable portion is configured to move longitudinally outward from the fixed portion to increase the size of the platform 16.

Referring to FIGS. 26-32, the platform 16 of the lift device 10 defines a first side 2500 (e.g., front portion or end), a second side 2504 (e.g., a rear portion or end) opposite the first side 2500, and a pair of lateral sides 2508 (e.g., first lateral or right side or portion, a second lateral or left side or portion) positioned opposite one another and extending between the first side 2500 and the second side 2504. The platform 16 further defines a longitudinal axis extending along the length of the lift device 10 through a center of the platform 16 (e.g., intersecting the first side 2500 and the second side 2504) and a lateral axis extending along the width of the lift device 10 through the center of the platform 16 (e.g., intersecting the lateral sides 2508). The longitudinal axis and the lateral axis intersect one another at a center point of the platform 16.

The guard rails 72 include various rail sections that, in combination with the doors 76, enclose or surround the supported area on the top surface of the deck 70. As shown, the guard rails 72 include two sets of rails (e.g., front rails, longitudinal rails, vertical rails), shown as front rail assemblies 2512, extending along the first side 2500. The front rail assemblies 2512 are substantially coplanar and extend vertically and laterally. The front rail assemblies 2512 make up a portion of the extendable rails 2452. Two sets of rails (e.g., rear rails, longitudinal rails, vertical rails), shown as rear rail assemblies 2516, extend along the second side 2504. The rear rail assemblies 2516 are substantially coplanar, extend substantially parallel (e.g., are offset from) to the front rails 2512, and extend vertically and laterally. The rear rail assemblies 2516 make up a portion of the stationary rails 2450. Two sets of rails (e.g., lateral rails, horizontal rails), shown as side rail assemblies 2520, extend along the lateral sides 2508 between the front rail assemblies 2512 and the rear rail assemblies 2516. The side rail assemblies 2520 extend substantially parallel to one another, are laterally offset from one another, extend substantially perpendicular to the front rail assemblies 2512 and the rear rail assemblies 2516, and extend longitudinally and vertically. Portions of the side rail assemblies 2520 make up the stationary rails 2450 and the extendable rails 2452. The side rail assemblies 2520 may have variable lengths to accommodate movement of the extendable deck 78. By way of example, the side rail assemblies 2520 may include nested or telescoping rail members that slide into or out of one another to vary the length of the side rail assemblies 2520. The front rail assemblies 2512, the rear rails assemblies 2516, and the side rail assemblies 2520 each include a bottom portion that defines a lower horizontal plane of the guard rails 72 (e.g., level with the deck 70) and top portion that defines an upper horizontal plane of the guard rails 72.

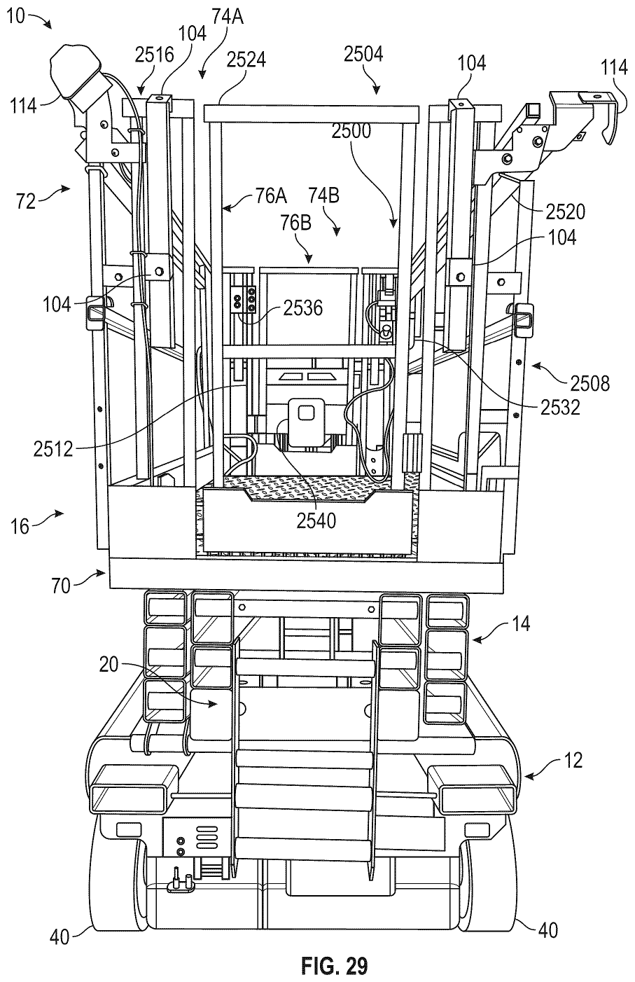

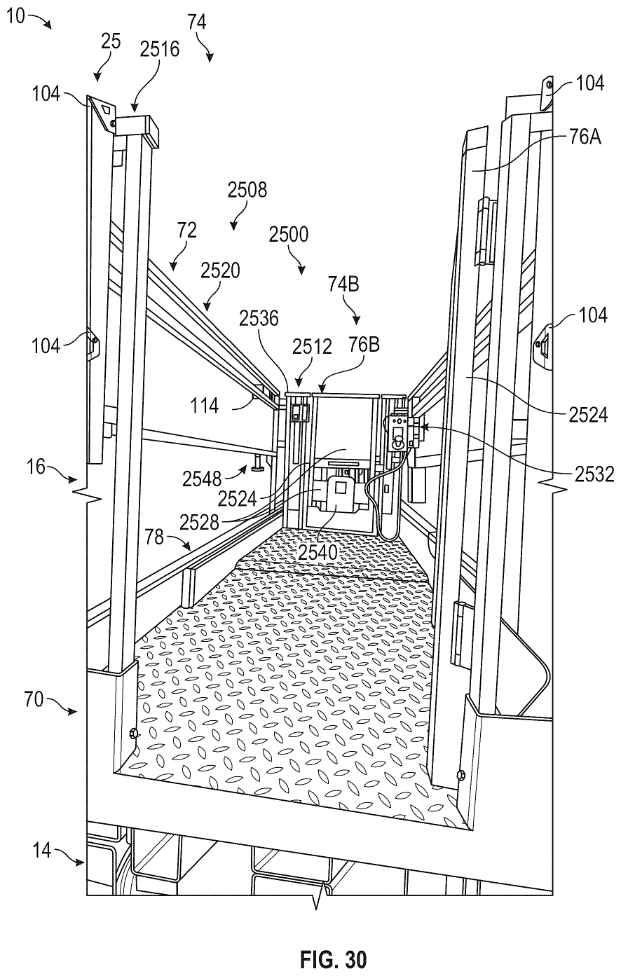

As shown in FIGS. 26-32, the doors 76 each include a frame 2524 that is positioned within (e.g., selectively extends across) one of the openings 74. Specifically, the first opening 74A is defined between the rear rail assemblies 2516 and a top surface of the deck 70. The first opening 74A opens upward, such that the first opening 74A is not enclosed along the top. This permits a user of any height to pass through the first opening 74A. The frame 2524 of the first door 76A is pivotally coupled to one of the rear rail assemblies 2516 (e.g., by hinges) and rotatable about a vertical axis between an open position (shown in FIG. 30) and a closed position (shown in FIG. 29). In the closed position, the frame 2524 of the first door 76A extends across the first opening 74A, from the bottom portion to the top portion of the guide rails 72. In the open position, the frame 2524 is moved out of the opening 74A to permit movement through the opening 74A.

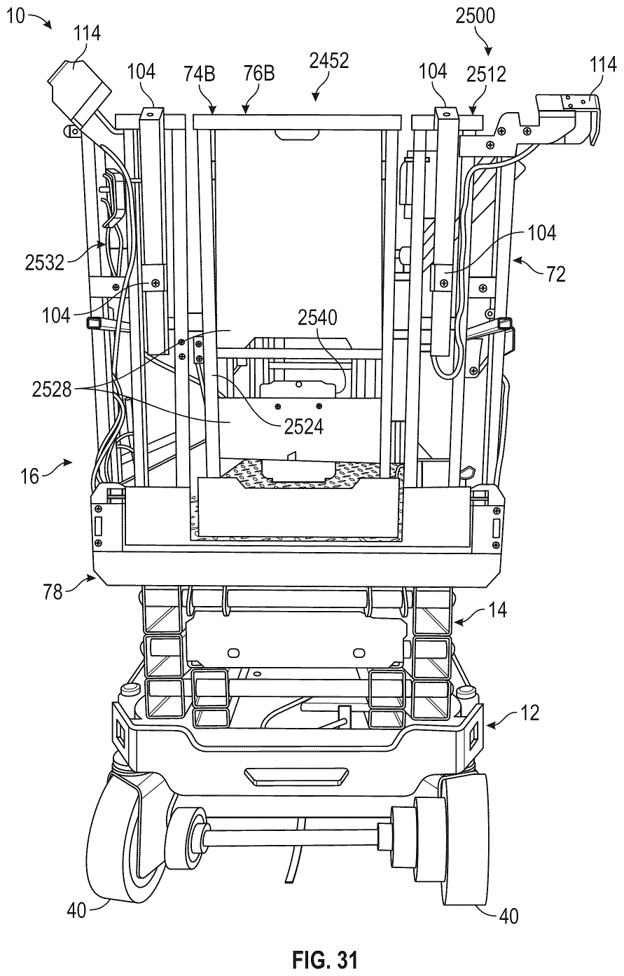

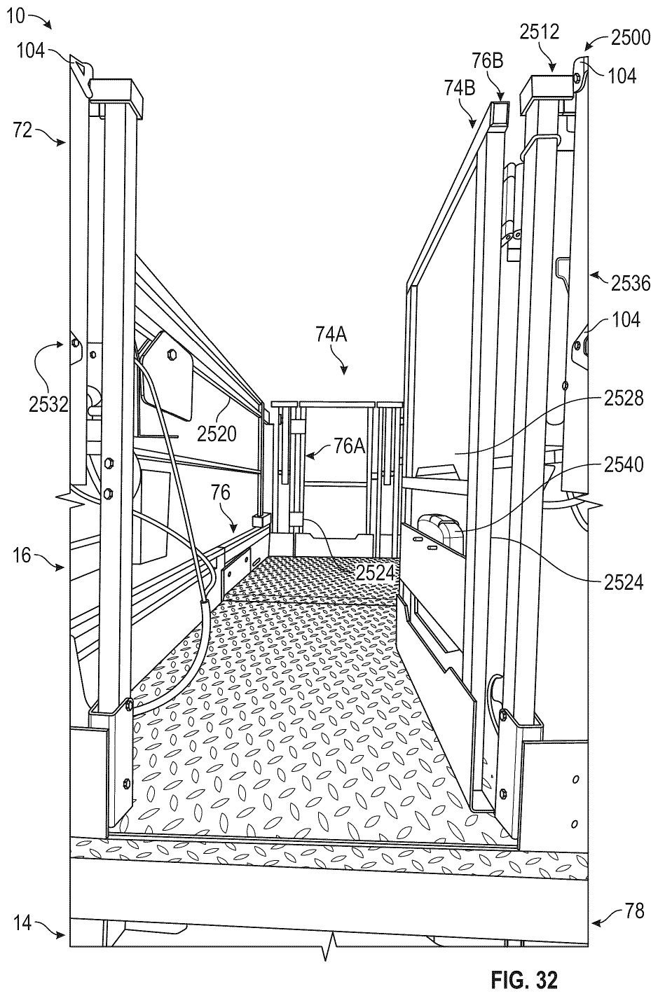

The second opening 74B is defined between the front rail assemblies 2512 and a top surface of the deck 70. The second opening 74B opens upward, such that the second opening 74B is not enclosed along the top. This permits a user of any height to pass through the second opening 74B. The frame 2524 of the second door 76B is pivotally coupled to one of the front rail assemblies 2512 (e.g., by hinges) and rotatable about a vertical axis between an open position (shown in FIG. 32) and a closed position (shown in FIG. 31). In the closed position, the frame 2524 of the second door 76B extends across the second opening 74B, from the bottom portion to the top portion of the guide rails 72. In the open position, the frame 2524 is moved out of the second opening 74B to permit movement through the second opening 74B.

As shown, the frame 2524 of each of the doors 76 is aligned such that a bottom end of each of the frames 2524 lies on the lower horizontal plane (e.g., the plane of the top surface of the deck 70) and a top end of each of the frame 2524 lies on the upper horizontal plane (e.g., the top plane of the guide rails 72). The second door 76B may include one or more panels or walls 2528 fixedly coupled (e.g., mounted) to the frame 2524 of the door 76B. The first door 76A omits the walls 2528, such that the frame 2524 of the door 76A is open to improve visibility. In other embodiments, the doors 76 are otherwise configured. For example, the door 76A coupled to the first set of rails 2512 and arranged on the extendable deck 78 may include the panels 2528.

Referring to FIGS. 26-39, the lift device 10 further includes a first user interface 2532 and a second user interface 2536 positioned along the first side 2500. The first user interface 2532 and the second user interface 2536 may provide similar functionality to the HMI 1520. In some embodiments, the user interface 2532 controls operation of the powertrain system 42 and the lift assembly 14, and the user interface 2536 controls extension and retraction of the extendable deck 78. The first user interface 2532 may include one or more screens to display information, buttons, levers, dials, or like controls to move or drive the lift device 10 and/or adjust (e.g., raise or lower) the lift assembly 14. The first user interface 2532 may be operatively coupled to the controller 1500. In some embodiments, the first user interface 2532 may receive inputs from a user and/or the controller 1500. In such embodiments, the first user interface 2532 may display or respond to the inputs to operate the lift device 10.

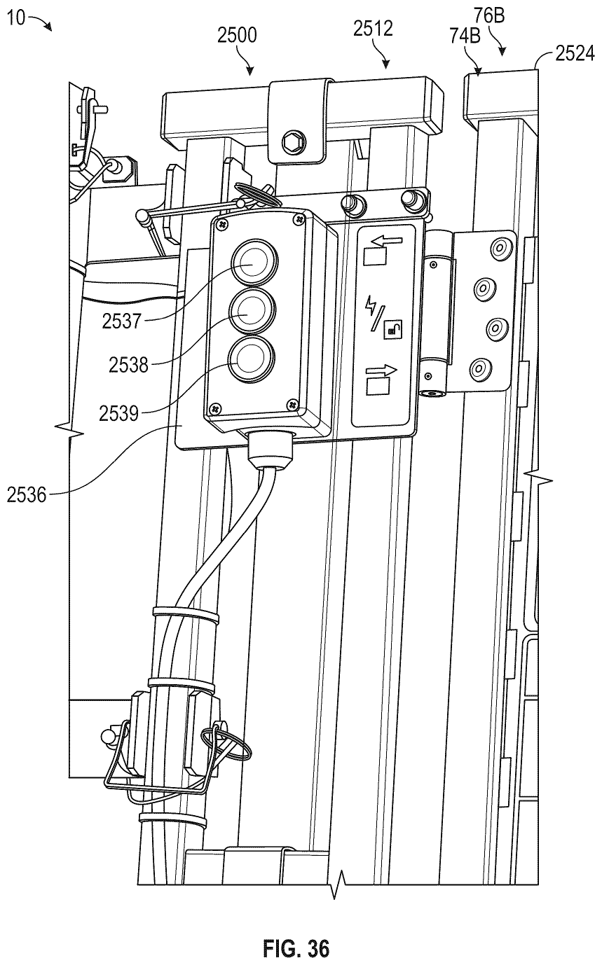

The second user interface 2536 may include one or more screens to display information, buttons, levers, dials, or like controls to adjust the extendable deck 78 of the platform 16. As shown in FIG. 36, the user interface 2536 includes a first input device or interface portion, shown as button 2537, a second input device or interface portion, shown as button 2538, and a third input device or interface portion, shown as button 2539. The button 2537 may cause the extendable deck 78 to extend when pressed, the button 2538 may cause the extendable deck 78 to lock in place when pressed, and the button 2539 may cause the extendable deck 78 to retract when pressed. The second user interface 2536 may be operatively coupled to the controller 1500. In some embodiments, the second user interface 2536 may receive inputs from a user and/or the controller 1500. In such embodiments, second user interface 2536 may display or respond to the inputs to operate the extendable deck 78.

The first user interface 2532 and the second user interface 2536 are positioned on opposing sides of the second opening 74B. The first user interface 2532 is fixedly coupled to one of the front railing assemblies 2512 and one of the side railing assemblies 2520. The second user interface 2536 is fixedly coupled to the other of the front railing assemblies 2512 and the other of the side railing assemblies 2520. Accordingly, the user interfaces 2532 and 2536 are movable with the extendable deck 78 relative to the deck 70. The user interfaces 2532 and 2536 are oriented to be operated by a user standing on the platform 16 and facing longitudinally forward, toward the opening 74B. The separation of the user interfaces 2532 and 2536 may facilitate placement of the door 76B along the first side 2500.

A housing 2540 (e.g., storage, container, etc.) is coupled along the first side 2500. Specifically, the housing 2540 is fixedly coupled to one of the panels 2528 of the door 76B. Accordingly, the housing 2540 moves with the extendable deck 78 relative to the deck 70. The housing 2540 may be configured to store safety manuals, operator equipment or aids, and/or other items for use with the lift device 10. By way of example, the housing 2540 may include a door that is repositionable to selectively permit access to a storage volume of the housing 2540.

An air access, shown as compressed air interface 2548, is positioned along one of the lateral sides 2508 of the platform 16 and fixedly coupled to one of the side rail assemblies 2520. The compressed air interface 2548 is fluidly coupled to a source of compressed air onboard the lift device 10 (e.g., a compressor, a pressurized air storage tank, etc.). The source may be positioned on the platform 16, on the frame assembly 12, or elsewhere on the lift device 12. The compressed air interface 2548 may include a hose and/or fitting (e.g., a quick disconnect fitting) configured to selectively fluidly couple the source of compressed air to an air-powered implement or air tool (e.g., a nail gun, an impact wrench, a sander, a grinder, an air nozzle, etc.). Accordingly, the compressed air interface 2548 may facilitate operation of air tools when the operator is at height (e.g., elevated by the platform 16).

Various ultrasonic sensors 104 and lidar sensors 114 are coupled to the guard rails 72 as described above. As shown, a pair of lidar sensors 114 are positioned on opposite sides of each opening 74. Similarly, multiple ultrasonic sensors 104 are positioned on opposite sides of each opening 74. The lidar sensors 114 and the ultrasonic sensors 104 may be coupled to the guard rails 72 such that the lidar sensors 114 and the ultrasonic sensors 104 remain stationary when the doors 76 are opened or closed.

As shown in FIGS. 26, 28, and 29, the lift device 10 includes an access assembly 20 positioned near the second side 2504 of the platform 16. In some embodiments, the access assembly 20 is coupled to the frame assembly 12 and extends upward from the frame assembly 12. The access assembly 20 is laterally aligned with the opening 76A. Accordingly, the a user may open the door 76 and step onto the deck 70 of the platform 16 from the access assembly 20 to board the platform 16. In some embodiments, the lift device 10 includes only one access assembly 20 (i.e., the lift device 10 does not include an access assembly 20 that facilitates direct access to the opening 74B from the ground). Accordingly, the only access assembly 20 may be positioned opposite the extendable deck 78. If an access assembly 20 were positioned to access the opening 74B, that access assembly 20 would be obstructed when the extendable deck 78 were extended. In contrast, the access assembly 20 positioned near the second side 2504 of the platform 16 permits the user to access the deck 70 of the platform 16 regardless of the extension of the extendable deck 78. In other embodiments, a second access assembly is added to permit direct access to the opening 74B.

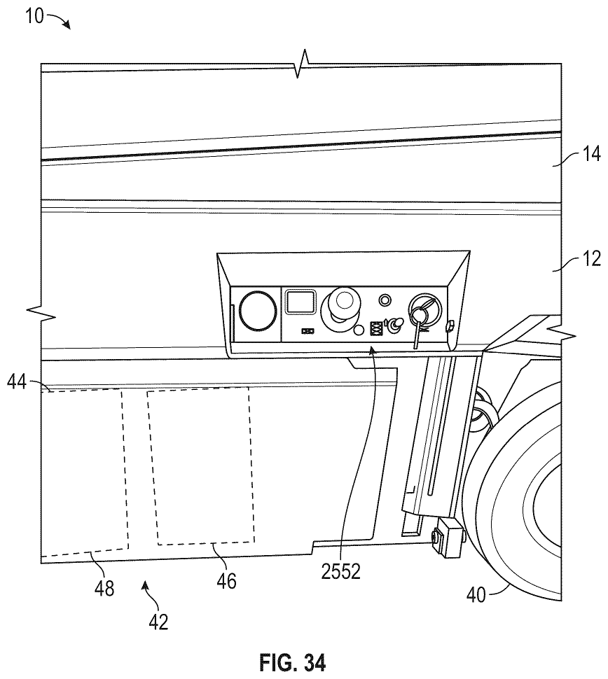

As shown in FIG. 34, the lift device 10 further includes a third user interface 2552. In the illustrated embodiment, the third user interface 2552 is positioned on the frame assembly 12 of the lift device 10. The third user interface 2552 may include one or more screens to display information, buttons, levers, dials, or like controls to enable or prohibit movement of the lift device 10 (e.g., start key, E-stop, etc.) and/or adjust (e.g., raise or lower) the lift assembly 14. The third user interface 2552 may provide a user positioned on the ground with similar functionality to the user interface 2532 and/or the user interface 2536. The third user interface 2552 may be operatively coupled to the controller 1500. In some embodiments, third user interface 2552 may receive inputs from a user and/or the controller 1500. In such embodiments, the first user interface 2532 may display or respond to the inputs to operate the lift device 10.

The arrangement of the openings 74 and the doors 76 may provide various benefits and advantages over other platform arrangements. As shown, the platform 16 includes both a door 76A on the second side 2504 and a door 76B on the first side 2504, along with the corresponding openings 74. The openings 74, the doors 76, and the access assembly 20 are laterally aligned (e.g., laterally centered on the platform, centered about the longitudinal central axis of the platform 16, etc.). Accordingly, a path for a user is defined from the access assembly 20, through the opening 74B, across the deck 70 and the extendable deck 78, and through the opening 74A. Due to the alignment of the doors 76, this path is straight, and a user can travel through both openings 74 without having to turn. This may also permit a long, straight object (e.g., a beam, pipe, conduit, piece of wood, etc.) to pass through both openings 74 unobstructed.

The height of the openings 74 may facilitate entering or exiting the platform 74. As shown, both of the openings 74 are full height openings with full height doors 76. Because no part of the guide rails 72 extends over the openings 74 when the doors 76 are opened, the user does not have to duck down to pass through an opening 74. However, when the doors 76 are closed, their full height provides maximum containment to the user.

The inclusion of the door 76 may provide a user with additional options for entering and exiting the platform 16. Other platforms may include only a single opening, forcing a user to enter and exit from the same location. Providing a second opening 74 permits a user to choose the most advantageous location to enter or exit. Additionally, the position of the opening 74B may be adjusted by extending or retracting the extendable deck 78, providing further options to the user. Having flexibility positioning the openings may be particularly advantageous in aviation applications. By way of example, a user may wish to enter the lift device 16 from one side (e.g., a rear side), then raise the platform 16 and extend the extendable deck 78 over the wing of an aircraft. The user may then exit through the opening 74B directly onto the wing of the aircraft (e.g., to perform a maintenance or cleaning operation).

### Platform Extension Actuator

Referring still to FIGS. 26-39, the platform further includes an actuator, shown as platform extension actuator 2600. The platform extension actuator 2600 is coupled to the deck 70 and the extendable deck 78 and configured to control (e.g., limit, prevent, cause, etc.) longitudinal movement of the extendable deck 78 relative to the deck 70. When the platform extension actuator 2600 is extended, the extendable deck 78 moves away from the deck 70 (i.e., extends). When the platform extension actuator 2600 is retracted, the extendable deck 78 moves toward the deck 70 (i.e., retracts). Accordingly, the platform extension actuator 2600 permits automated movement of the extendable deck 78 to a desired position (e.g., without a user having to manually push or pull the extendable deck 78). By way of example, a user may control the lift device 10 to raise the platform 10 along the side of an aircraft, then extend the extendable deck 78 to overhang the platform 16 over top of the aircraft.

The platform extension actuator 2600 may be one of the controllable elements 1518 controlled by the controller 1500. In some embodiments, the controller 1500 operates the platform extension actuator 2600 based on a user input through the user interface 2536. By way of example, the controller 1500 may command the platform extension actuator 2600 to extend in response to a user pressing the button 2537. By way of another example, the controller 1500 may command the platform extension actuator 2600 to maintain its current extension (e.g., length) to lock the extendable platform 78 in place in response to a user pressing the button 2538. By way of another example, the controller 1500 may command the platform extension actuator 2600 to retract in response to a user pressing the button 2539. In some embodiments, operation of the platform extension actuator 2600 is controlled autonomously or semiautonomously by the controller 1500. For example, the controller 1500 may limit further extension of the extendable platform 78 by the extension actuator if the controller 1500 determines the presence of an obstacle in a surrounding area (e.g., scan area) of the extendable platform 78.

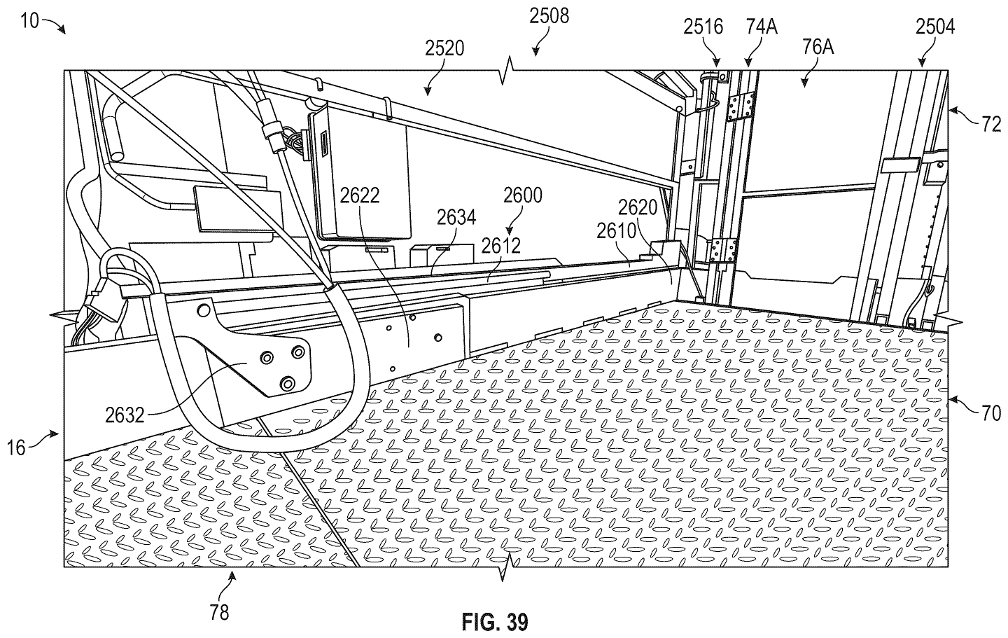

In some embodiments, the platform extension actuator 2600 is an electric actuator (e.g., an electric linear actuator). As shown in FIG. 39, the platform extension actuator 2600 includes a first member, shown as body 2610, and a second member, shown as rod 2612 slidably coupled to the body 2610. The rod 2612 is received within the body 2610 and may move out of or into the body 2610 to extend or retract the platform extension actuator 2600, respectively. The body 2610 is coupled to the deck 70, and the rod 2612 is coupled to the extendable deck 78. A motor (e.g., an electric motor, a hydraulic motor, a pneumatic motor, etc.), shown as electric motor 2614, is configured to drive the rod 2612 to extend or retract relative to the body 2610 to vary a length of the platform extension actuator 2600 as desired. By way of example, the rod 2612 may include a threaded portion (e.g., may be a lead screw) that engages a nut within the body 2610, and the electric motor 2614 may rotate the nut to extend or retract the rod 2612. In other embodiments, the electric motor 2614 is replaced with another type of actuator (e.g., a hydraulic cylinder, a pneumatic cylinder, etc.). In some embodiments, the platform extension actuator 2600 includes a length sensor that provides sensor data to the controller 1500 indicating a current extended length of the platform extension actuator 2600.

As shown, the platform 16 includes one platform extension actuator 2600. In other embodiments, the platform 16 includes additional platform extension actuators 2600 (e.g., in an arrangement symmetrical about the longitudinal centerline of the platform 16. As shown, the platform extension actuator 2600 is coplanar with one of the side rail assemblies 2520. This arrangement places the platform extension actuator 2600 in an area that is not normally travelled by the feet of users occupying the platform 16 (e.g., the platform extension actuator 2600 is offset above and laterally outward from the top surface of the deck 70). This positioning prevents contact between the users and the platform extension actuator 2600. Additionally, this placement of the platform extension actuator 2600 may permit the rails of the side rail assembly 2520 to protect the platform extension actuator 2600 from impact by objects in the surrounding environment.

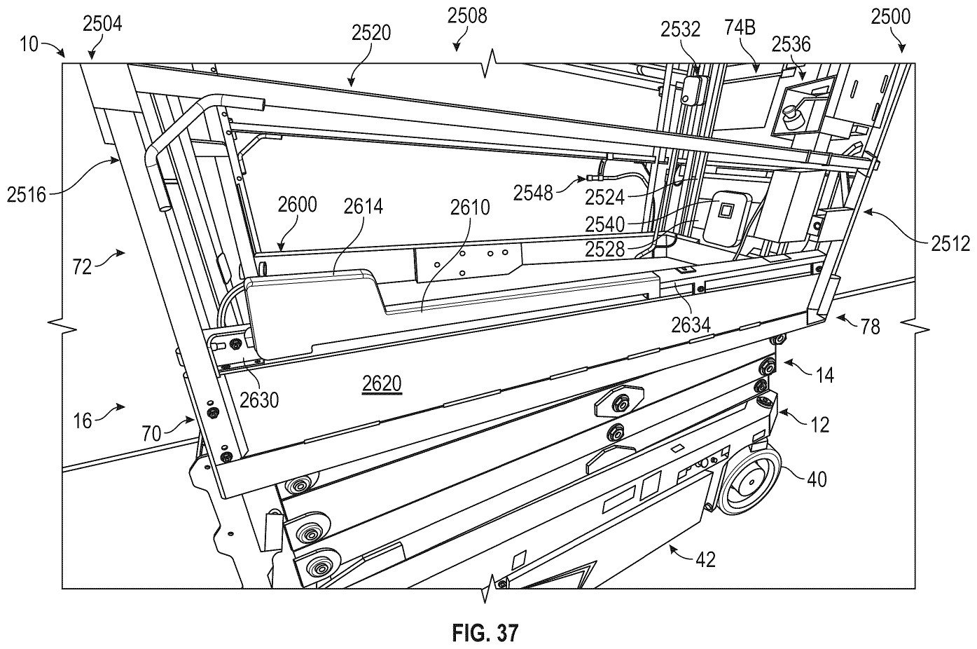

As shown in FIGS. 37-39, the side rail assembly 2520 includes a pair of base rails or frame members, shown as stationary rail 2620 and extending rail 2622. The stationary rail 2620 and the extending rail 2622 extend longitudinally and are positioned along one of the lateral sides 2508. The stationary rail 2620 is fixedly coupled to the deck 70 and extends along a top surface of the deck 70. The extending rail 2622 is fixedly coupled to the extendable deck 78 and extends along a top surface of the deck 70. The stationary rail 2620 and the extending rail 2622 are slidably coupled to one another (e.g., in a telescoping arrangement), such that the extending rail 2622 is movable longitudinally relative to the stationary rail 2620 as the extendable deck 78 extends or retracts. Engagement between the stationary rail 2620 and the extending rail 2622 may support the extendable deck 78 in a cantilevered arrangement when the extendable deck 78 is extended. The other side rail assembly 2520 may include a symmetrical arrangement of a stationary rail 2620 and an extending rail 2622.

The platform extension actuator 2600 is positioned directly above the stationary rail 2620 and the extending rail 2622. The body 2610 of the platform extension actuator 2600 is fixedly coupled to the stationary rail 2620 and one of the rear rail assemblies 2516 by a fixture or coupler, shown as bracket 2630. The rod 2612 of the platform extension actuator 2600 is fixedly coupled to the extendable rail 2622 by a fixture or coupler, shown as bracket 2632. Accordingly, to extend or retract the extendable deck 78, the platform extension actuator 2600 applies an attractive or repulsive longitudinal force on the stationary rail 2620 and the extendable rail 2622 through the brackets 2630 and 2632.

When the extendable deck 78 is extended, the rod 2612 is extending out of the body 2610 and a large portion of the rod 2612 is exposed. To protect the exposed portion of the rod 2612, the platform 16 includes a u-shaped bracket, shown as shield 2634, that extends over the top and outer sides of the rod 2612. The shield 2634 is fixedly coupled to the stationary rail 2620. During operation of the platform extension actuator 2600, that the rod 2612 and the bracket 2632 longitudinally underneath the cover of the shield 2634. Accordingly, the shield 2634 protects the rod 2612 from contact with falling debris and debris from outside of the platform 16.

### Additional Features for Obstacle Detection System

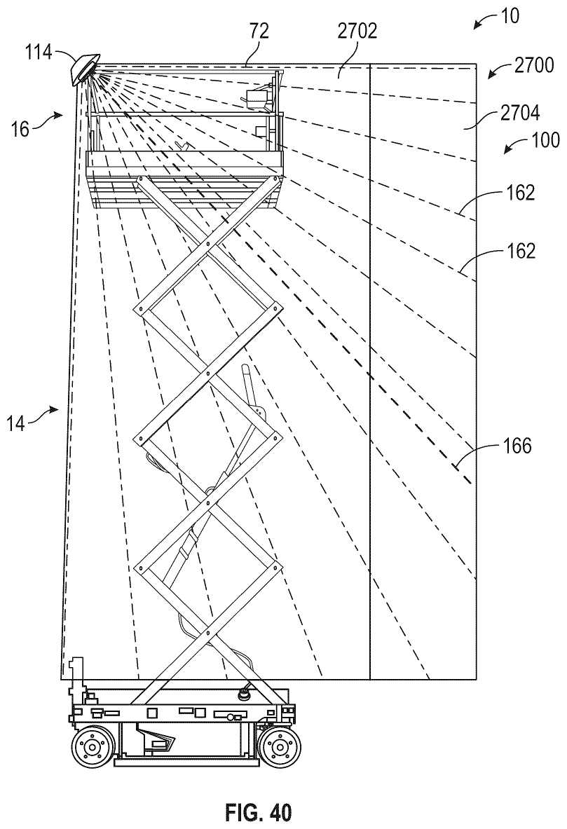

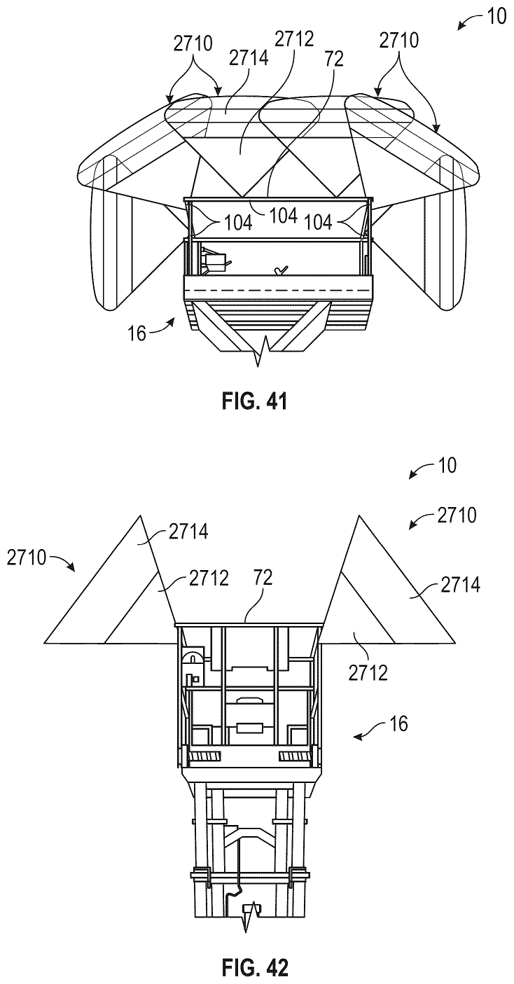

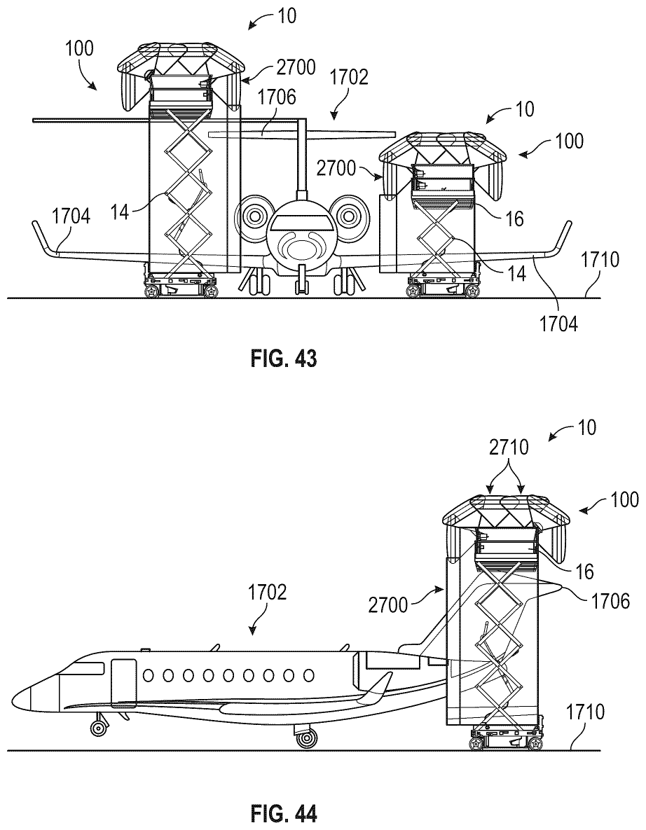

Referring now to FIGS. 40-44, an arrangement of the obstacle detection system 100 is shown according to another exemplary embodiment. The obstacle detection system 100 shown in FIGS. 40-44 may be substantially similar to the obstacle detection system 100 of FIGS. 17-23 except as otherwise specified herein.

As shown in FIG. 40, the lidar sensors 144 are raised relative to the lidar sensors 144 of FIG. 20. Specifically, the lidar sensors 144 are relocated to be positioned at the upper end portions (e.g., the upper plane) of the guide rails 72. Accordingly, a detection zone 2700 associated with each lidar sensor 144 includes both (a) a first area below the deck 70 and (b) a second area above the deck 70. This positioning may provide the lidar sensors 144 with additional resolution and the ability to detect obstacles above the deck 70. The detection zone 2700 includes a first area, shown as stop zone 2702, and a second area, shown as warning 2704, that have similar functions to the other warning zones and stop zones described herein. Similarly, the ultrasonic sensors 104 are coupled to various parts of the guard rails 72. Each ultrasonic sensor 104 has a corresponding detection zone 2710 that is oriented upward and/or laterally outward from the ultrasonic sensor 104. Exemplary positions of the lidar sensors 144 and the ultrasonic sensors 104 are shown in FIGS. 26-39.

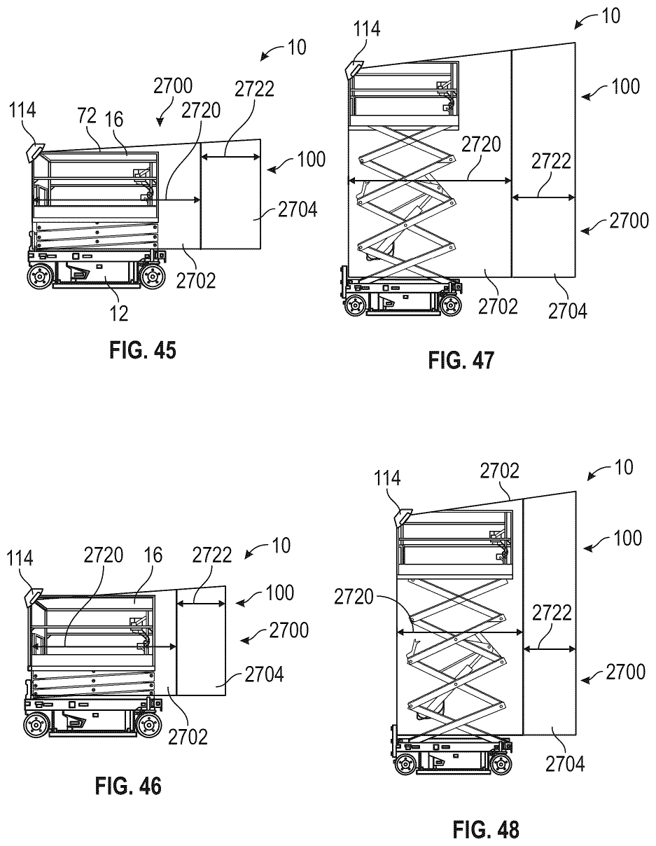

FIGS. 45 and 46 illustrate the stop zone 2702 and the warning zone 2702 while the platform 16 is in a lowered position. The stop zone 2702 has a width 2720, and the warning zone has a width 2722. The stop zone 2702 extends from a rear side of the platform 2700 to a position beyond the platform 16 on an opposing side and from the top of the guide rails 72 to the frame 12. In some embodiments, the controller 1500 selects the width 2720 and/or the width 2722 in response to a determination that the lift device 10 is traveling and/or a direction of travel of the lift device 10. By way of example, the controller 1500 may determine that the stop zone 2702 and the warning zone 2704 should extend beyond the platform 16 in the direction of travel.

In some embodiments, the controller 1500 permits a manual override function. Beneficially, the manual override function may permit a user to move closer to an obstacle than would be permitted during normal operation. By way of example, a user may provide an override command from a user through the HMI 1520 (e.g., by pressing and holding an override button). In response to receiving the override command, the controller 1500 changes from a normal operating configuration, shown in FIG. 46, to an override configuration, shown in FIG. 47. The controller 150 may reduce the width 2720 and/or the width 2722 in the override configuration as compared to the normal operating configuration. The smaller stop zone 2702 and/or warning zone 2704 may permit the user to navigate the lift device 10 closer to an obstacle than would be permitted in the normal operating configuration (e.g., when the user wishes to climb onto or otherwise interact with the obstacle). For example, the override configuration may allow for the extendable deck 78 to be extended (e.g., by the platform extension actuator 2600) closer to the obstacle than otherwise permitted by the controller 1500 during the normal operating configuration.

Additionally or alternatively, the controller 1500 may reduce the permitted (e.g., maximum allowed) operating speeds of one or more components of the lift device 10 while in the override configuration, such that the maximum permitted speed of the component is lower in the override configuration than in the normal operating configuration. By way of example, the controller 1500 may control the powertrain system 42 to set a maximum permitted travel speed of the lift device 10. By way of another example, the controller 1500 may control the lift assembly 14 to set a maximum permitted speed for raising and/or lowering the platform 16. By way of another example, the controller 1500 may control the platform extension actuator 2600 to set a maximum permitted speed for extending and/or retracting the extendable deck 78. By limiting the operating speeds of the lift device 10, the lift device 10 may be less prone to collisions with obstacles close by the lift device 10.

FIGS. 47 and 48 illustrate another example of the normal operating configuration and the override configuration, respectively. In FIGS. 47 and 48, the stop zone 2702 and the warning zone 2704 may be selected based on a determination that the lift device 10 is traveling to the right as shown in FIGS. 47 and 48 while the platform 16 is in a raised position. The width 2720 and/or the width 2722 may be smaller in the override configuration than in the normal operating configuration. Additionally or alternatively, the width 2720 and/or the width 2722 with the platform 16 in the raised position may be different from the width 2720 and/or the width 2722 in the lowered position. By way of example, the controller 1500 may reduce the width 2720 and/or the width 2722 in response to a determination that the platform 16 has been lowered (e.g., to permit the platform 1600 to get closer to obstacles when the platform 16 is lowered).

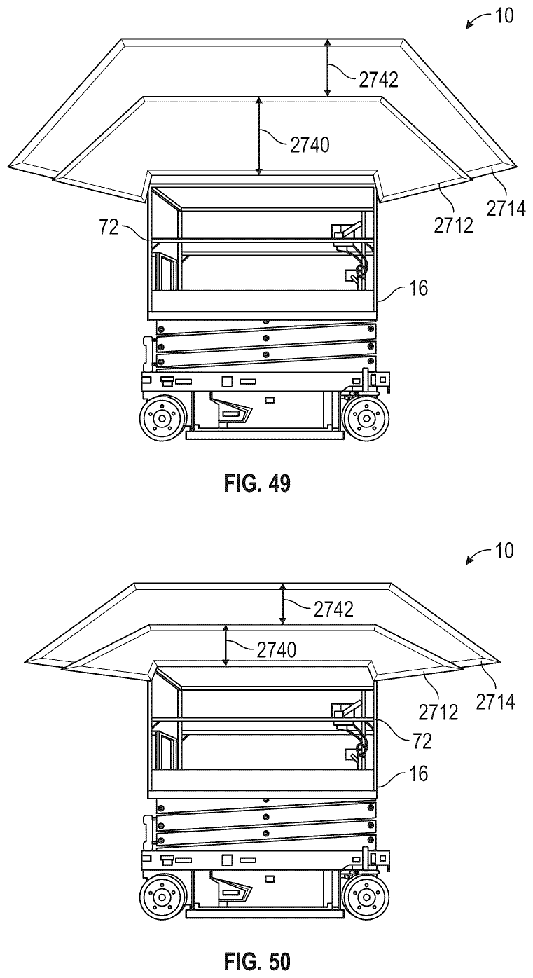

Referring to FIGS. 49 and 50, the stop zone 2712 has a thickness or width 2740, and the warning zone 2714 has a thickness or width 2742. The stop zone 2712 extends outward from the positions of the ultrasonic sensors 104 on the guardrails 72 to a position upward and/or outward from the platform 16. The warning zone 2714 extends further beyond the stop zone 2712. Accordingly, the stop zone 2712 and/or the warning zone 2714 may detect obstacles above the platform 16. The controller 1500 may limit movement of the lift assembly 14 in response to detecting an obstacle in the stop zone 2712.

FIGS. 49 and 50 illustrate another example of the normal operating configuration and the override configuration, respectively. In FIGS. 49 and 50, the stop zone 2712 and the warning zone 2714 may be selected by the controller 1500 based on a determination that the platform 16 is moving upward. The width 2740 and/or the width 2742 may be smaller in the override configuration than in the normal operating configuration.

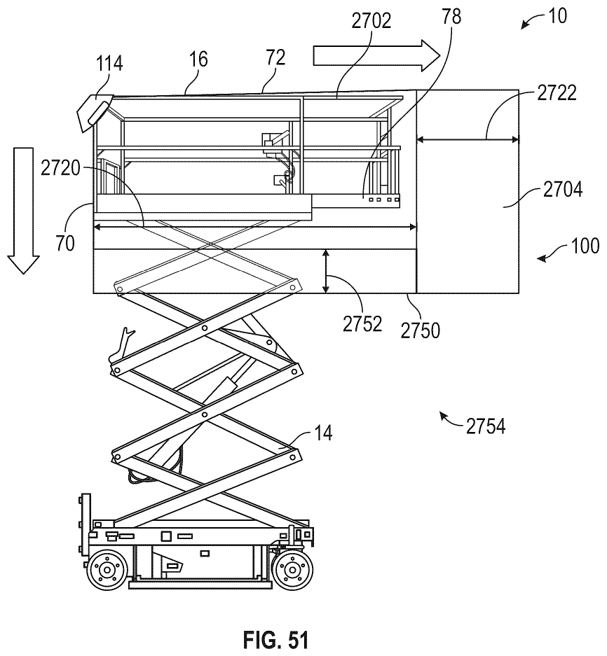

Referring to FIG. 51, the object detection system 100 is shown in an extension configuration according to an exemplary embodiment. The controller 1500 may enter the extension configuration in response to a determination that the extendable deck 78 is in a partially extended position or fully extended configuration (i.e., is not a fully retracted configuration). In some embodiments, the controller 1500 enters the extension configuration in response to a determination that (a) the extendable deck 78 is in a partially extended position or fully extended configuration and (b) the lift assembly 14 is lowering the platform 16.

In the extension configuration, the shape of the stop zone 2702 is modified. Instead of extending downward to the frame 12, the stop zone 2702 extends only a short distance below the platform 16, such that a gap is formed between the stop zone 2702 and the frame 12. The controller 1500 defines an additional warning zone, shown as warning zone 2750, extending along a bottom side of the stop zone 2702. A width of the warning zone 2750 is equal to the width 2720 of the stop zone 2702.

In the extension configuration, the shape of the warning zone 2704 is also modified. Instead of having the same height as the stop zone 2702, the height of the warning zone 2704 is the sum of the height of the stop zone 2702 and the height 2752 of the warning zone 2750. Accordingly, a free space 2754 is defined beneath the warning zone 2750 and the warning zone 2704. The free space 2754 is positioned to extend beneath the extendable deck 78. An obstacle may pass into the free space 2754 without the controller 1500 stopping movement of the lift device 10 or triggering an alert. In some embodiments, the width 2722 of the warning zone 2704 is smaller in the extension configuration than in the normal operating configuration.

The height 2752 of the warning zone 2750 may be constant (e.g., 18 inches). Accordingly, the warning zone 2750 may move down and the free space 2754 may reduce in size as the platform 16 is lowered. Similarly, the warning zone 2750 may move upward and the free space 2754 may increase in size as the platform 16 is raised. This action may prevent the platform 16 from being inadvertently lowered onto an obstacle.

The widths of the stop zone 2702, the warning zone 2704, and the stop zone 2750 may vary based on the current position of the extendable deck 78. By way of example, the controller 1500 may increase the widths of the stop zone 2702, the warning zone 2704, and/or the stop zone 2750 in response to an indication (e.g., from a sensor of the platform extension actuator 2600) that the extendable deck 78 is being extended. By way of another example, the controller 1500 may decrease the widths of the stop zone 2702, the warning zone 2704, and/or the stop zone 2750 in response to an indication (e.g., from a sensor of the platform extension actuator 2600) that the extendable deck 78 is being retracted. This action may prevent the platform 16 from inadvertently contacting an obstacle as the extendable deck 78 is extended.

In some embodiments, the controller 1500 limits driving of the lift device 10 in response to an indication that the extendable deck 78 has been extended. By way of example, the controller 1500 may prevent operation of the powertrain system 42 in response to an indication that the lift device 10 has entered the extension configuration. This action may prevent a user from inadvertently driving the lift device 10 while the extendable deck 78 is extended.

In operation, the extension configuration permits a user to extend the extendable deck 78 over top of an obstacle. By way of example, when performing maintenance or cleaning an aircraft, it may be advantageous for a user to access an area above a portion of the aircraft (e.g., the top of a wing or fuselage). To accomplish this, the user may control the lift device 10 to navigate adjacent to the aircraft, raise the platform 16, extend the extendable deck 78, and then lower the platform 16 toward a top surface of the aircraft. The free space 2754 may permit the platform 16 to execute this downward movement, permitting the user to access the top surface of the aircraft (e.g., by stepping out through the opening 74B). Without the functionality of the extension configuration, the stop zone would potentially prevent such a downward movement of the platform 16 and limit the user's ability to access the top of the aircraft.

### Configuration of Exemplary Embodiments

The present disclosure contemplates methods, systems, and program products on any machine-readable media for accomplishing various operations. The embodiments of the present disclosure may be implemented using existing computer processors, or by a special purpose computer processor for an appropriate system, incorporated for this or another purpose, or by a hardwired system. Embodiments within the scope of the present disclosure include program products comprising machine-readable media for carrying or having machine-executable instructions or data structures stored thereon. Such machine-readable media can be any available media that can be accessed by a general purpose or special purpose computer or other machine with a processor. By way of example, such machine-readable media can comprise RAM, ROM, EPROM, EEPROM, CD-ROM or other optical disk storage, magnetic disk storage or other magnetic storage devices, or any other medium which can be used to carry or store desired program code in the form of machine-executable instructions or data structures and which can be accessed by a general purpose or special purpose computer or other machine with a processor. When information is transferred or provided over a network or another communications connection (either hardwired, wireless, or a combination of hardwired or wireless) to a machine, the machine properly views the connection as a machine-readable medium. Thus, any such connection is properly termed a machine-readable medium. Combinations of the above are also included within the scope of machine-readable media. Machine-executable instructions include, for example, instructions and data which cause a general purpose computer, special purpose computer, or special purpose processing machines to perform a certain function or group of functions.

As utilized herein, the terms “approximately”, “about”, “substantially”, and similar terms are intended to have a broad meaning in harmony with the common and accepted usage by those of ordinary skill in the art to which the subject matter of this disclosure pertains. It should be understood by those of skill in the art who review this disclosure that these terms are intended to allow a description of certain features described and claimed without restricting the scope of these features to the precise numerical ranges provided. Accordingly, these terms should be interpreted as indicating that insubstantial or inconsequential modifications or alterations of the subject matter described and claimed are considered to be within the scope of the invention as recited in the appended claims.

It should be noted that the terms “exemplary” and “example” as used herein to describe various embodiments is intended to indicate that such embodiments are possible examples, representations, and/or illustrations of possible embodiments (and such term is not intended to connote that such embodiments are necessarily extraordinary or superlative examples).

The terms “coupled,” “connected,” and the like, as used herein, mean the joining of two members directly or indirectly to one another. Such joining may be stationary (e.g., permanent, etc.) or moveable (e.g., removable, releasable, etc.). Such joining may be achieved with the two members or the two members and any additional intermediate members being integrally formed as a single unitary body with one another or with the two members or the two members and any additional intermediate members being attached to one another.

References herein to the positions of elements (e.g., “top,” “bottom,” “above,” “below,” “between,” etc.) are merely used to describe the orientation of various elements in the figures. It should be noted that the orientation of various elements may differ according to other exemplary embodiments, and that such variations are intended to be encompassed by the present disclosure.

Also, the term “or” is used in its inclusive sense (and not in its exclusive sense) so that when used, for example, to connect a list of elements, the term “or” means one, some, or all of the elements in the list. Conjunctive language such as the phrase “at least one of X, Y, and Z,” unless specifically stated otherwise, is otherwise understood with the context as used in general to convey that an item, term, etc. may be either X, Y, Z, X and Y, X and Z, Y and Z, or X, Y, and Z (i.e., any combination of X, Y, and Z). Thus, such conjunctive language is not generally intended to imply that certain embodiments require at least one of X, at least one of Y, and at least one of Z to each be present, unless otherwise indicated.

It is important to note that the construction and arrangement of the systems as shown in the exemplary embodiments is illustrative only. Although only a few embodiments of the present disclosure have been described in detail, those skilled in the art who review this disclosure will readily appreciate that many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter recited. For example, elements shown as integrally formed may be constructed of multiple parts or elements. It should be noted that the elements and/or assemblies of the components described herein may be constructed from any of a wide variety of materials that provide sufficient strength or durability, in any of a wide variety of colors, textures, and combinations. Accordingly, all such modifications are intended to be included within the scope of the present inventions. Other substitutions, modifications, changes, and omissions may be made in the design, operating conditions, and arrangement of the preferred and other exemplary embodiments without departing from scope of the present disclosure or from the spirit of the appended claim.

What is claimed is:

1. A lift device, comprising:
a frame assembly;
a platform configured to support an operator;
a lift assembly coupling the platform to the frame assembly and configured to raise or lower the platform,
wherein the platform includes:
a deck coupled to the lift assembly;
an extendable deck movable relative to the deck in a longitudinal direction; and
a sensor configured to detect an obstacle below the platform; and
a controller operatively coupled to the sensor, the controller configured to:
limit operation of the lift device to lower the platform in response to the sensor detecting the obstacle within a stop zone, the stop zone extending a predetermined distance beneath the platform; and
permit operation of the lift device to lower the platform towards the obstacle in response to the sensor detecting the obstacle beneath the stop zone.

2. The lift device of claim 1, wherein the stop zone is defined by a longitudinal width greater than or substantially equal to a longitudinal width of the platform extending from a first longitudinal end of the platform to a second longitudinal end of the platform, and wherein the stop zone is defined by a lateral width greater than or substantially equal to a lateral width extending from a first lateral end of the platform to a second lateral end of the platform.

3. The lift device of claim 2, wherein the controller is configured to extend the stop zone by a longitudinal distance from the first longitudinal end or the second longitudinal end based on a direction of travel of the lift device.

4. The lift device of claim 1, wherein the stop zone is a first portion of a scan area of the sensor, wherein the scan area further comprises at least one of a first warning zone extending from a longitudinal end of the platform to detect an obstacle adjacent to the platform or a second warning zone extending a greater distance beneath the platform than the predetermined distance.

5. The lift device of claim 4, wherein responsive to the sensor detecting the obstacle within the first warning zone or the second warning zone, the controller is configured to operate an alert device to provide an alert to the operator indicating a presence of an obstacle within the first warning zone or the second warning zone.

6. The lift device of claim 1, wherein responsive to detecting the obstacle within the stop zone, the controller is configured to:
restrict the lift device from transporting in a direction towards the obstacle; or
restrict the lift assembly from lowering the platform.

7. The lift device of claim 1, wherein the controller is configured to restrict driving of the lift device if the extendable deck is not in a fully retracted position.

8. The lift device of claim 1, wherein responsive to the extendable deck moving relative to the deck in the longitudinal direction, the controller is configured to adjust a longitudinal width of the stop zone such that the longitudinal width of the stop zone is greater than or substantially equal to a longitudinal width extending from a first longitudinal end of the platform to a second longitudinal end of the platform.

9. The lift device of claim 1, wherein a free space is defined below the predetermined distance beneath the extendable deck, wherein responsive to the obstacle being detected within the free space, the controller is configured to permit operation, thereby allowing the extendable deck to be extended or lowered to access a surface of the obstacle.

10. The lift device of claim 1, wherein the controller is configured to switch between a normal operating configuration and an override configuration, wherein under the normal operating configuration, a size of the stop zone is selected by the controller, and wherein under the override configuration, the controller is configured to adjust a size of the stop zone responsive to a user input.

11. The lift device of claim 1, wherein the predetermined distance of the stop zone is 18 inches below the platform.

12. A scissor lift, comprising:
a frame assembly;
a platform configured to support an operator;
a lift assembly coupling the platform to the frame assembly and configured to raise or lower the platform,
wherein the platform includes:
a deck coupled to the lift assembly;
an extendable deck movable relative to the deck in a longitudinal direction; and
a sensor configured to detect an obstacle below the platform; and
a controller operatively coupled to the sensor, the controller configured to:
limit operation of the scissor lift in response to the sensor detecting the obstacle within a stop zone, the stop zone extending a predetermined distance beneath the platform; and
permit operation of the scissor lift to lower the platform towards the obstacle in response to the sensor detecting the obstacle beneath the stop zone.

13. The scissor lift of claim 12, wherein the stop zone is defined by a longitudinal width greater than or substantially equal to a longitudinal width extending from a first longitudinal end of the platform to a second longitudinal end of the platform, and wherein the stop zone is defined by a lateral width greater than or substantially equal to a lateral width extending from a first lateral end of the platform to a second lateral end of the platform.

14. The scissor lift of claim 13, wherein the controller is configured to extend the stop zone by a longitudinal distance from the first longitudinal end or the second longitudinal end based on a direction of travel of the scissor lift.

15. The scissor lift of claim 12, wherein responsive to detecting the obstacle within the stop zone, the controller is configured to:
restrict the scissor lift from transporting in a direction towards the obstacle; or
restrict the lift assembly from lowering the platform.

16. The scissor lift of claim 12, wherein responsive to the extendable deck moving relative to the deck in the longitudinal direction, the controller is configured to adjust a longitudinal width of the stop zone, such that the longitudinal width of the stop zone is greater than or substantially equal to a longitudinal width extending from a first longitudinal end of the platform to a second longitudinal end of the platform.

17. A control system for a lift device, comprising:
a sensor configured to detect an obstacle below a platform of the lift device; and
a controller operatively coupled to the sensor, the controller configured to:
limit operation of the lift device to lower the platform in response to the sensor detecting the obstacle within a stop zone, the stop zone extending a predetermined distance beneath the platform; and
permit operation of the lift device to lower the platform in response to the sensor detecting the obstacle beneath the stop zone.

18. The control system of claim 17, wherein the stop zone is defined by a longitudinal width greater than or substantially equal to a longitudinal width of the platform extending from a first longitudinal end of the platform to a second longitudinal end of the platform, and wherein the stop zone is defined by a lateral width greater than or substantially equal to a lateral width extending from a first lateral end of the platform to a second lateral end of the platform.

19. The control system of claim 17, wherein responsive to detecting the obstacle within the stop zone, the controller is configured to:
restrict the lift device from transporting in a direction towards the obstacle; or
restrict a lift assembly of the lift device from lowering the platform.

20. The control system of claim 17, wherein responsive to an extendable deck of the platform moving relative to a deck of the platform in a longitudinal direction, the controller is configured to adjust a longitudinal width of the stop zone, such that the longitudinal width of the stop zone greater than or substantially equal to a longitudinal width extending from a first longitudinal end of the platform to a second longitudinal end of the platform.
